(19) United States
(12) Patent Application Publication
(10) Pub. No.: US 2012/0284637 A1
(43) Pub. Date: Nov. 8, 2012

(54) Unified Virtual Group Calendar System

(76) Inventors: John Edward Boyer, Seattle, WA (US); Cynthia Smith Boyer, Seattle, WA (US)

(21) Appl. No.: 13/460,757

(22) Filed: Apr. 30, 2012

Related U.S. Application Data
(60) Provisional application No. 61/481,517, filed on May 2, 2011.

(51) Int. Cl. G06F 3/048

(52) U.S. Cl. 715/751

(57) ABSTRACT

A computer implemented method and system for managing events scheduled by multiple users in a group, provides an event management platform (EMP) in communication with a client application on each user's computing device via a network. The EMP acquires characteristic information on each computing device and each user's third party calendar applications (TPCAs), and event information on the events. The EMP, in communication with the client application, generates and stores the events based on the event information. The EMP stores the events across a data store residing on each computing device external to the client application and/or the data stores of the TPCAs, using the acquired characteristic information and event information. The stored events are accessible to each user associated with the events for performing one or more actions that are tracked and automatically updated by the EMP. The EMP also notifies the availability of the users in the group.

### CROSS REFERENCE TO RELATED APPLICATIONS

This application claims the benefit of provisional patent application No. 61/481,517 titled “Interoperable Calendaring System And Method For Multiple-user Groups, Heterogeneous Platforms, And Disparate Electronic Calendar Vendors”, filed on May 2, 2011 in the United States Patent and Trademark Office.

The specification of the above referenced patent application is incorporated herein by reference in its entirety.

### BACKGROUND

Conventional electronic calendaring systems are often configured to schedule events, perform timekeeping, etc., by operating on a particular type of a computing device and a particular type of an operating system. These electronic calendaring systems are often limited in their capability to handle newer computing devices and operating systems. Moreover, these electronic calendaring systems are not easily equipped to be scalable to handle an increase in the number of events being scheduled. Furthermore, conventional electronic calendaring systems are often customized for specific applications, thereby limiting their capability of forming partnerships with third party calendar vendors or independent software publishers.

Furthermore, conventional electronic calendaring systems are often restricted to processing and presentation of calendar data separately. Consider an example of a group of members collaborating on an official activity such as a meeting, an interview, an appointment, etc. A group member's availability for the meeting, the interview or the appointment depends on his/her schedules at work, school, home, etc. Conventional electronic calendaring systems allow a group member to schedule an event as an organizer and invite other group members to the event. However, these electronic calendaring systems often mandate a requirement that all the group members exclusively use the same enterprise calendaring software custom made for businesses, for example, IBM® Lotus Notes® of International Business Machines (IBM) Corporation, Microsoft® Office Outlook™ Calendar of Microsoft Corporation, etc., for all their personal and work related events, in order to allow the organizer to accurately check each group member's availability. This problem is compounded by the increasing use of separate and distinct electronic calendars at work, school, and home on different computing devices, platforms, and calendar services by users. Therefore, the organizer is unable to accurately assess a group member's availability since these electronic calendaring systems are non-integrated with one another and the information available on the occupation of each group member in other activities is insufficient. Furthermore, when a group member adds a new event to an electronic calendar that is unreachable to other group members, the actual availability of the group member is unknown to the other group members.

Furthermore, conventional calendar services and electronic calendaring systems designed for personal information management may not provide support for event delegation to other members of the group. For example, a group such as a family typically finds these electronic calendaring systems unusable in many situations, since families require event delegation from one member of the group to another, typically, from one parent to another parent. In an example, a mother may need her child to be picked up from sports practice on a certain day and time, but may be unable to pick up her child personally. Consequently, the mother may need to delegate the event “pick-up” to another person, for example, a parent, a friend or a guardian. Conventional enterprise calendaring systems support event delegation only if all the concerned members share the same software application on compatible devices which is often impractical and not cost effective to the users.

Furthermore, conventional consumer electronic software and calendar services are often not equipped with the capability of checking the availability of a resource, for example, an inanimate object such as a car, a meeting room, etc., and automatically booking the resource for persons such as children who may not be provided with electronic calendars.

Furthermore, conventional electronic calendaring systems often employ calendar user agents. As used herein, a “calendar user agent” (CUA) refers to a software application using which a user of an electronic calendar can communicate with an external calendar service or a data store of a local calendar service to access calendar information. However, conventional CUAs are often restricted to scheduling of events or accepting invitations only on the computing device of the user. Therefore, conventional CUAs allow access for viewing the progress of an event and the availability of the user for the event to only the owner of the computing device and block access of the user's event schedule and busy time periods to other members of the group.

Hence, there is a long felt but unresolved need for a computer implemented method and a computer implemented unified virtual group calendar system that integrates disparate calendar systems of multiple groups of users, aggregates disparate calendar data of the users in each group, manages and synchronizes events across multiple heterogeneous devices, calendar applications and device platforms of the users in each group, provides access to an availability status of multiple users and resources, and allows delegation of events across the users in each group. Furthermore, there is a long felt but unresolved need for a computer implemented method and a computer implemented unified virtual group calendar system that creates a context group of users based on potential interest in contextual events and manages the contextual events for the users within the context group.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and the computer implemented unified virtual group calendar system disclosed herein address the above stated need for integrating disparate calendar systems of multiple groups of users, aggregating disparate calendar data of the users in each group, managing and synchronizing events across multiple heterogeneous devices, calendar applications and device platforms of the users in each group, providing access to an availability status of multiple users and resources, and allowing delegation of events across the users in each group. The unified virtual group calendar system disclosed herein combines multiple calendars from multiple calendar vendors for multiple users in a group. The computer implemented method and the computer implemented unified virtual group calendar system disclosed herein also create a context group of users based on potential interest in contextual events and manages contextual events for the users within the context group.

The computer implemented method and the unified virtual group calendar system disclosed herein merge a group's dispersed calendar data from disparate devices, electronic calendars, and calendar services; so that its members or users can view the entire group's schedule, manage events, and query member availability. Therefore, the computer implemented method and the unified virtual group calendar system disclosed herein enables a group to view and manage electronic calendar data stored on each group member's heterogeneous devices and calendar services. Furthermore, the computer implemented method and the unified virtual group calendar system disclosed herein enable users or members of a group to delegate events to other group members even if their electronic software does not support delegation. The computer implemented method and the unified virtual group calendar system disclosed herein also allow group members to check the availability of resources, for example, inanimate objects such as cars or meeting rooms, services of professionals such as doctors, technicians, etc. The computer implemented method and the unified virtual group calendar system disclosed herein also enables group members to supervise persons such as children who do not possess electronic calendars or to automatically book inanimate objects, for example, resources such as cars, for persons such as children who do not possess electronic calendars.

The computer implemented method and the unified virtual group calendar system disclosed herein are configured to operate irrespective of a group member's device or the capabilities of each group member's electronic calendar software and calendar services. Therefore, the computer implemented method and the unified virtual group calendar system disclosed herein provide access to the availability of other group members. That is, the computer implemented method and the unified virtual group calendar system disclosed herein publishes free-busy information so that other members in the group may more reliably assess a member's availability. The computer implemented method and the unified virtual group calendar system disclosed herein enable each group member to view heterogeneous calendar data of the other group members.

The computer implemented method and the unified virtual group calendar system disclosed herein is flexible, allowing development and execution of different client applications on different types of computing devices and operating systems such as Microsoft® Windows® of Microsoft Corporation, Mac OS of Apple, Inc., Linux, mobile operating systems, for example, iOS of Apple, Inc., Android™ operating system of Google, Inc., etc. Furthermore, the unified virtual group calendar system disclosed herein is scalable vertically and horizontally to handle increased capacity of users and associated calendaring applications. The unified virtual group calendar system disclosed herein allows partnerships to be formed with third party calendar vendors or independent software publishers who can utilize the capabilities of the unified virtual group calendar system.

The computer implemented method and the unified virtual group calendar system disclosed herein manages one or more events scheduled by one or more of multiple users in a group. The computer implemented method and the unified virtual group calendar system disclosed herein provides an event management platform comprising at least one processor configured to coordinate one or more events scheduled by each of the users in the group. The event management platform is configured to enable creation, updating, and deletion of one or more events scheduled by the users in the group and copies of the events. The computer implemented method and the unified virtual group calendar system disclosed herein provides a client application executable by at least one processor on each of one or more computing devices of each of the users in the group. The client application is, for example, a software component downloadable on each of the computing devices of each of the users in the group, a web application such as a browser application in communication with the event management platform over a network, etc. The event management platform is in communication with the client application deployed on each of the computing devices of each of the users in the group via the network.

The event management platform acquires characteristic information on each of the computing devices and one or more third party calendar applications of each of the users in the group, from each of the users in the group via a graphical user interface (GUI) provided by the event management platform. As used herein, the term “third party calendar application” refers to an application or a service provided by a third party source that provides access to a number of data stores, each of which comprises a number of calendars. The third party calendar applications may be installed on a particular computing device of the user or across multiple computing devices of the user. Furthermore, the third party calendar applications are remotely accessible via the network. The characteristic information comprises, for example, account credentials such as a login account identifier and a password for each of the third party calendar applications, identification information such as a vendor identifier, a calendar identifier, etc., of each of the third party calendar applications, electronic addresses of each of the users in the group, device identification information such as a version of an operating system implemented on each of the computing devices of each of the users in the group, etc. The device identification information allows the event management platform to access each of the computing devices of the users in the group, store events, and make updates to the events across different heterogeneous computing devices of each of the users in the group. The characteristic information further comprises information on multiple users constituting a group, that is, the members of the group, the type of the group, that is, whether the group of users is an organizational group, a family group, etc., the individual roles of the members in the group, a group identifier, etc. The event management platform stores and maintains the information on the group in an information database.

The event management platform also acquires event information on the events from each of the users in the group via the GUI. The event information acquired from each of the users in the group comprises, for example, a number of users in the group associated with each of the events, an identity of each of the users in the group associated with the events, a date of each of the events, a time for each of the events, a geographical location for each of the events, a duration of each of the events, a default storage location in a data store resident on each of the computing devices external to the client application or a data store of each of the third party calendar applications for storing the events. In an embodiment, the event management platform acquires a default storage location for storing the events from each of the users in the group via the GUI.

The event management platform, in communication with the client application over the network, generates and stores one or more events based on the acquired event information. As used herein, the term “event” refers to an electronic representation of a physical occurrence of an activity. In an embodiment, the event management platform, in communication with the client application over the network, generates the events by validating a request associated with the generation of each of the events, received from the client application on each of the computing devices of each of the users in the group. The event management platform generates an event identification key for each of the events for uniquely identifying each of the events on successful validation of the request. The event management platform transmits the generated event identification key to the client application and/or each of the third part calendar applications over the network for storage of each of the events in a data store of the client application, the data store residing on each of the computing devices external to the client application herein referred to as a “native local data store”, and/or the data store of each of the third party calendar applications. Furthermore, the generated event identification key received by the client application, the native local data store, and/or the third party calendar applications is mapped to a unique event identifier generated by the native local data store and/or the data store of each of the third party calendar applications for storing the generated events in the native local data store and/or the data store of each of the third party calendar applications respectively.

The event management platform stores the generated events across the native local data store and/or the data store of each of the third party calendar applications, of each of the users in the group who are associated with the events, over the network using the acquired characteristic information and the event information. The event management platform stores the generated events across the data stores over the network, for example, by transmitting a copy of each of the generated events to each of the data stores via the network. Furthermore, in an embodiment, the event management platform stores the generated events in a data store local to the client application configured as a downloadable software component on each of the computing devices of each of the users in the group via the network. That is, the generated events can be stored in the native local data store external to the client application and/or in the data store local to the client application. The computer implemented method and the unified virtual group calendar system disclosed herein thereby combines information from each of the computing devices and the third party calendar applications of a user that typically would be unavailable to other users in the group, for managing one or more events scheduled by one or more users in the group.

In an embodiment, the event management platform transmits an event invitation for each of the events triggered by one of the users in the group to other users in the group via the network. The event management platform generates the events and transmits a copy of the generated events to the default storage location of each of the other users in the group via the network on receiving an acceptance message for the events from each of the other users in the group. The default storage location is, for example, the native local data store and/or the data store of each of the third party calendar applications of each of the users in the group associated with the events. The event management platform can access the generated events stored in the default storage location, for example, for retrieval, transmission, and manipulation.

The stored events, for example, in the default storage location are accessible to each of the users in the group associated with the events over the network for performing one or more actions on the stored events. The actions performed on the stored events by the users in the group comprise, for example, viewing the events, deleting the events, updating the event information for updating the events scheduled by each of the users in the group, accepting an event invitation, cancelling an event invitation, etc. In an embodiment, the event management platform, in communication with the client application over the network, determines delegation of the events from one of the users in the group to another one of the users in the group for performing one or more actions on the stored events.

In an embodiment, prior to storage of the events, the event management platform first determines absence of the events generated for one of the users in the group, in the data store of the client application of each of the other users in the group, the native local data store of each of the other users in the group, and/or the data store of each of the third party calendar applications of each of the other users in the group via the network. The event management platform then stores the events generated for one of the users across the data store of the client application on each of the computing devices of each of the other users in the group, the native local data store of each of the other users in the group, and/or the data store of each of the third party calendar applications of each of the other users in the group over the network, based on the determination of the absence and a receipt of an acceptance message for the events from each of the other users in the group.

In an embodiment, the event management platform deletes the generated events and transmits a notification to the client application on each of the computing devices of each of the other users in the group for performing deletion of the copy of the generated events from the default storage location of each of the other users in the group via the network, on receiving a cancellation message from each of the other users in the group.

In an embodiment, the event management platform publishes the generated events stored in the native local data store to other users in the group via the network. In an embodiment, the event management platform selectively publishes the events retrieved from the data store of the client application, the information database of the event management platform, the native local data store, and the data store of each of the third party calendar applications, to the users in the group via the network based on selection criteria. The selection criteria comprise, for example, a profile of each of the users. In an embodiment, each of the computing devices of each of the users in the group is provided with a local event management database for storage of the generated events to ensure uninterrupted performance of the actions on the stored events, independent of the network in the client application.

The event management platform, in communication with the client application on each of the computing devices of each of the users in the group over the network, tracks the actions performed on the stored events by one or more of the users in the group. In an embodiment, the event management platform, in communication with the client application over the network, tracks the actions performed on the stored events by one of the users in the group by determining whether a result of each of the actions performed on the stored events by a user in the group is updated in the data store of the client application, the native local data store, or the data store of each of the third party calendar applications, of each of the other users in the group, via the network.

The event management platform automatically updates the stored events across the native local data store and/or the data store of each of the third party calendar applications, of each of the users in the group associated with the generated events, over the network using the acquired characteristic information and event information. In an embodiment, the event management platform automatically updates the result of each of the actions performed on the stored events by a user in the group, in the data store of each of the third party calendar applications of each of the other users, and transmits a notification to the client application of each of the other users in the group via the network for updating the result of each of the actions performed on the stored events by the user in the group in the data store of the client application and/or the native local data store of each of the other users in the group based on the determination of the updating of the result of each of the actions and a receipt of an acceptance message for the result of each of the actions by each of the other users in the group.

In an embodiment, the client application on each of the computing devices of a user in the group, in communication with the event management platform over the network, retrieves the events associated with each of the other users in the group, stored across the native local data store and/or the data store of each of the third party calendar applications, of each of the other users in the group over the network via the information database of the event management platform. The client application on the computing device of the user sorts the retrieved events based on predetermined sorting criteria defined by the user in the group. The client application then displays the sorted events on a graphical user interface (GUI) of the client application. In an embodiment, the event management platform determines the events retrieved across the native local data store and/or the data store of each of the third party calendar applications of each of the other users in the group that are duplicated. The event management platform transmits a single copy of the events from among the duplicated events to the client application of the user in the group via the network.

Furthermore, in an embodiment, the client application on each of the computing devices of each of the users in the group determines one or more busy time periods of each of the users in the group using private event information of the events stored in the native local data store. As used herein, the term “busy time period” refers to a time period between a start time and an end time of an event associated with a user in the group. The client application transmits a notification of the determined busy time periods to the event management platform via the network. In an embodiment, the event management platform, in communication with the client application over the network, generates one or more private events for each of the users in the group based on the determined busy time periods of each of the users in the group received from the client application over the network. As used herein, the term “private event” refers to an event that is marked as a personal event by a user in the group and whose complete event information is not available for viewing by the other users in the group. The event management platform then transmits a notification of the generated private events of each of the users in the group to the client application of each of the other users in the group via the network for accessing the generated private events of each of the users in the group by the other users in the group.

In an embodiment, the event management platform, in communication with the client application of each of the users via the network, analyzes an availability status of each of the users in the group using the event information and transmits a notification to the client application of each of the other users in the group via the network for tracking the availability of each of the users in the group for the scheduled events. For example, the client application of each of the users in the group transmits a request message triggered by each of one or more of the users in the group to the event management platform via the network. The request message defines a predetermined duration of time to determine availability of each of the other users in the group. The event management platform transmits a notification of one or more busy time periods of each of the other users in the group retrieved from the native local data store of each of the other users in the group, the data store of each of the third party calendar applications of each of the other users in the group associated with the events, and/or the information database of the event management platform, to the client application of each of the users in the group via the network. The client application of each of the users in the group determines an availability status of each of the other users in the group for the predetermined duration of time based on the transmitted notification of one or more busy time periods for notifying each of the users in the group whether one or more of the other users in the group are busy during the predetermined duration of time. By notifying the availability of each of the users in the group, the computer implemented method and the unified virtual group calendar system disclosed herein enables each of the users of the client application to be aware when other users in the group are busy based on their availability information, for example, their busy time periods stored in their native local data stores, the third party calendar applications, and the event management platform.

In an embodiment, the event management platform is configured to coordinate and manage one or more contextual events scheduled by an event organizer among the users in the group. As used herein, the term “contextual event” refers to a non-private event associated with a theme or a context. Also, as used herein the term “event organizer” refers to one of the users in the group who schedules an event. In addition to acquiring the characteristic information, the event management platform acquires event information on contextual events from the event organizer in the group via the GUI of the event management platform. The event management platform analyzes the event information acquired for the contextual events from the event organizer and compares the event information with profiles of other users in the group and external users registered with the event management platform to determine potential interest of the other users in the group and the external users in the contextual events.

The event management platform generates a list of one or more other users in the group and the external users with potential interest in the contextual events. The event management platform transmits the generated list to the client application on each of the computing devices of the event organizer via the network. The event management platform acquires an indication of one or more other users in the group and external users selected by the event organizer from the generated list for participating in the contextual events via the GUI of the event management platform. The event management platform creates a context group of the selected users in the group and the external users for participation in the contextual events. The event management platform, in communication with the client application over the network, generates and stores the contextual events based on the acquired event information. Furthermore, the event management platform stores the generated contextual events across the native local data store and/or the data store of each of the third party calendar applications of each of the users in the context group associated with the contextual events over the network, using the acquired characteristic information and event information. The stored contextual events are accessible to each of the users in the context group associated with the contextual events over the network for performing one or more actions on the stored contextual events.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing one or more events scheduled by multiple users in a group.

FIG. 2 exemplarily illustrates an embodiment of the computer implemented method for managing one or more events scheduled by multiple users in a group.

FIGS. 3A-3B exemplarily illustrate a flowchart comprising the steps for triggering generation of an event by a client application in communication with an event management platform via a network.

FIG. 4 exemplarily illustrates a flowchart comprising the steps for generating an event by the event management platform.

FIG. 5 exemplarily illustrates a flowchart comprising the steps for generating an event for publishing to a third party calendar application by the event management platform.

FIGS. 6A-6B exemplarily illustrate a flowchart comprising the steps for publishing a generated event to a third party calendar application by the event management platform.

FIG. 7 exemplarily illustrates a flowchart comprising the steps for updating a generated event in a client application of a user on receiving a notification from the event management platform.

FIG. 8 exemplarily illustrates a flowchart comprising the steps for processing a reply to an event invitation request received by an attendee, by the client application.

FIG. 9 exemplarily illustrates a flowchart comprising the steps for processing a reply received from an attendee to a request for participation in an event, by the event management platform.

FIG. 10 exemplarily illustrates a flowchart comprising the steps for processing an acceptance reply message to a request for delegation of an event, received from a delegate by the event management platform.

FIG. 11 exemplarily illustrates a flowchart comprising the steps for processing a declined reply message to a request for delegation of an event, received from a user by the event management platform.

FIGS. 12A-12B exemplarily illustrate a flowchart comprising the steps for updating an event in a local data store of the client application and a native local data store on a computing device of a user.

FIG. 13 exemplarily illustrates a flowchart comprising the steps for updating an event by the event management platform.

FIGS. 14A-14B exemplarily illustrate a flowchart comprising the steps for automatically updating an event in each of the third party calendar applications of a user by the event management platform.

FIG. 15 exemplarily illustrates a flowchart comprising the steps for processing a request for delegation during updating of an event in a third party calendar application.

FIGS. 16A-16B exemplarily illustrate automatic updating of an event by the event management platform in each of the third party calendar applications of one or more users in a group.

FIG. 17 exemplarily illustrates a flowchart comprising the steps for retrieving events for a user within a date range by the client application in communication with the event management platform via the network.

FIG. 18 exemplarily illustrates a flowchart comprising the steps for retrieving user events within the native local data store by the client application.

FIGS. 19A-19B exemplarily illustrate a flowchart comprising the steps for retrieving group events from the event management platform by the client application via the network.

FIGS. 20A-20B exemplarily illustrate a flowchart comprising the steps for retrieving private events of a group of users within a predetermined date range.

FIG. 21 exemplarily illustrates a flowchart comprising the steps for retrieving events based on filter criteria from the event management platform.

FIG. 22 exemplarily illustrates a flowchart comprising the steps for retrieving events matching filter criteria defined by a user.

FIGS. 23A-23B exemplarily illustrate a flowchart comprising the steps for retrieving events from the third party calendar applications by the event management platform.

FIG. 24 exemplarily illustrates a computer implemented method for notifying availability of each of multiple users in a group.

FIG. 25 exemplarily illustrates a flowchart comprising the steps for retrieving free-busy events of the users in a group from the event management platform.

FIG. 26 exemplarily illustrates a flowchart comprising the steps for generating a dictionary of free-busy times of each of the users in a group by the event management platform.

FIG. 27 exemplarily illustrates a flowchart comprising the steps for publishing free-busy data by the client application.

FIG. 28 exemplarily illustrates a flowchart comprising the steps for storing free-busy data in the event management platform.

FIG. 29 exemplarily illustrates a flowchart comprising the steps for displaying the availability of a user in a group during creation of an event or updating of an event in the client application.

FIGS. 30A-30B exemplarily illustrate screenshots of a graphical user interface provided by the client application on a computing device of a user for displaying the availability of the users in a group for an event.

FIGS. 31A-31B exemplarily illustrate a flowchart comprising the steps for triggering deletion of an event by the client application.

FIG. 32 exemplarily illustrates a flowchart comprising the steps for deleting an event by the event management platform.

FIG. 33 exemplarily illustrates a flowchart comprising the steps for triggering deletion of an event in a third party calendar application by the event management platform.

FIGS. 34A-34B exemplarily illustrate a flowchart comprising the steps for deleting an event in a third party calendar application by the event management platform.

FIG. 35 exemplarily illustrates a flowchart comprising the steps for processing a request for cancellation of an event in the client application.

FIGS. 36A-36B exemplarily illustrate a computer implemented method for managing one or more contextual events scheduled by an event organizer in a group.

FIGS. 37A-37C exemplarily illustrate components of a computer implemented system for managing one or more events scheduled by multiple users in a group.

FIGS. 38A-38B exemplarily illustrate an entity relationship diagram indicating relationships between individual database entities storing event information in the information database of the event management platform.

FIG. 39 exemplarily illustrates an operational structure of a message database of the event management platform.

FIG. 40 exemplarily illustrates the architecture of a computer system employed by each of the client application and the event management platform for managing one or more events scheduled by multiple users in a group.

FIGS. 41A-41D exemplarily illustrate screenshots of a graphical user interface displaying events according to the computer implemented method disclosed herein.

### DETAILED DESCRIPTION OF THE INVENTION

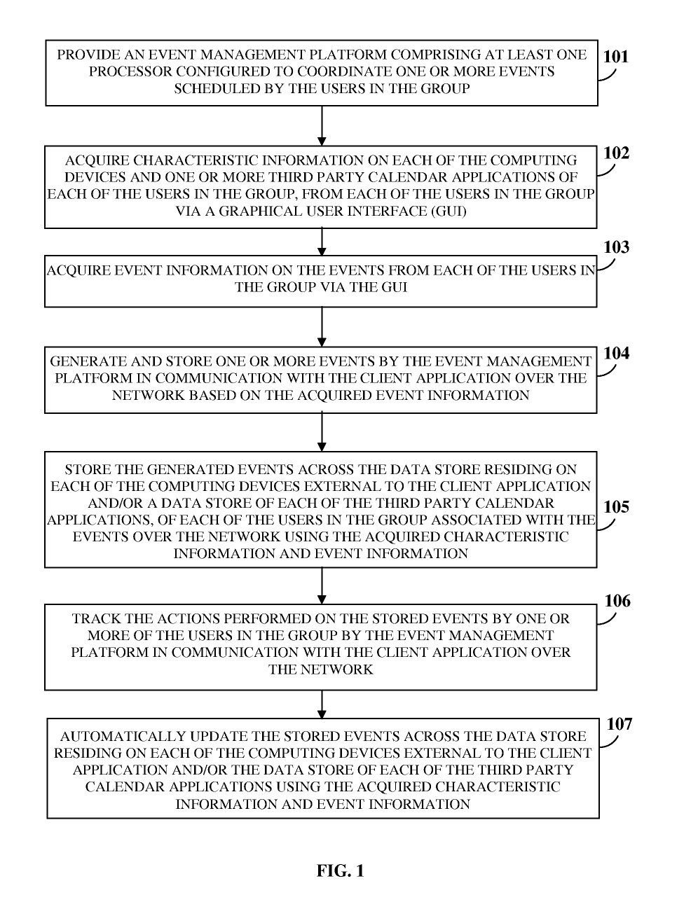

FIG. 1 illustrates a computer implemented method for managing one or more events scheduled by multiple users in a group. As used herein, the term “event” refers to an electronic representation of a physical occurrence of an activity. A user is an entity who adds, accesses, updates, and deletes information on one or more events. A user is, for example, a human being, a software agent configured to operate on behalf of a human being, etc.

The computer implemented method disclosed herein provides 101 an event management platform comprising at least one processor configured to coordinate the events scheduled by the users in the group. The event management platform is in communication with a client application deployed on each of one or more computing devices of each of the users in the group via a network. The computing devices are, for example, personal computers, laptops, mobile phones, mobile computers, smart phones, tablet computers, personal digital assistants, etc. The network is, for example, the internet, an intranet, a local area network, a wide area network, a communication network implementing Wi-Fi® of the Wireless Ethernet Compatibility Alliance, Inc., a cellular network, a mobile communication network, etc. The mobile communication network is, for example, a global system for mobile communications (GSM) network, a general packet radio service (GPRS) network, etc. The event management platform provides a software framework that allows access to a number of data stores, where each data store comprises multiple different calendars configured with different properties. For example, a data store defined for employees of an organization comprises different calendars configured for storing events marking interactions between an employee and other employees at different levels of the organization. The event management platform is, for example, hosted on a server and accessible to each of the users in the group, for example, through a wide spectrum of technologies and devices such as computers with connection to the internet, internet-enabled cellular phones, tablets computing devices, etc.

In an embodiment, the computer implemented method disclosed herein provides the client application executable by at least one processor on each of one or more computing devices of each of the users in the group. The client application is, for example, a software component downloadable on each of the computing devices of each of the users in the group, a web application such as a browser application in communication with the event management platform over the network, a plug-in software component, etc. In an embodiment, the client application is downloaded from the event management platform via the network and installed on each user's computing device, for example, a personal computer, a laptop, a mobile phone, a mobile computer, a smart phone, a tablet computer, a personal digital assistant, etc. The client application enables a user to communicate with the event management platform or with a native local data store on the user's computing device. In an example, a user may use a desktop or mobile web browser to access the event management platform via the network and generate events in a web based third party calendar application, for example, Google Calendar of Google, Inc.

The event management platform acquires 102 characteristic information on each of the computing devices and one or more third party calendar applications of each of the users in the group, from each of the users via a graphical user interface (GUI) provided by the event management platform. As used herein, the term “third party calendar application” refers to an application or a service provided by a third party source that provides access to a number of data stores, each of which comprises a number of calendars. The third party calendar application is, for example, Google Calendar of Google, Inc., Microsoft® Office Outlook™ Calendar of Microsoft Corporation, the iCal® application of Apple®, Inc., etc. The third party calendar applications of a user may be installed on a particular computing device or may be distributed across multiple computing devices of the user. Furthermore, the third party calendar applications may be accessed by the user externally from different computing devices, over the network such as the internet, a local area network, etc. The GUI is provided by the event management platform, for example, on a web page of a website hosted by the event management platform. The GUI displays, for example, a registration interface for enabling the user to register with the event management platform and enter the characteristic information and event information.

The characteristic information of the computing device comprises, for example, device identification information of each of the computing devices of each of the users in the group. The device information comprises, for example a machine address such as an internet protocol (IP) address, a media access control (MAC) address of the computing device, the type of an operating system on the computing device, the version of a particular operating system on the computing device, etc. The device identification information allows the event management platform to access each of the different heterogeneous computing devices of the users in the group, store events, and make updates to the events across the different heterogeneous computing devices of each of the users in the group. Furthermore, the characteristic information on each of the third party calendar applications of each of the users in the group comprises, for example, identification information of each of the third party calendar applications, vendor information such as a vendor identifier associated with each of the third party calendar applications, a calendar identifier for uniquely identifying a calendar in each of the third party calendar applications, etc., account credentials such as a login account identifier and a password for each of the third party calendar applications, electronic addresses of each of the users in the group defined by a user, etc. Furthermore, the characteristic information comprises, for example, information on multiple users constituting a group, that is, members of the group, the type of group, for example, whether the group of users is an organizational group, a family group, etc., individual roles of the members in the group, a group identifier, etc. The event management platform stores and maintains the information on the group in an information database.

Furthermore, the event management platform acquires 103 event information on the events from each of the users in the group via the GUI. The event information acquired from each of the users in the group comprises, for example, a number of users in the group associated with each of the events, an identity of each of the users in the group associated with the events, a date of each of the events, a time for each of the events, a geographical location for each of the events, a duration of each of the events, a default storage location, for example, in a data store residing on each of the computing devices external to the client application herein referred to as a “native local data store”, a data store of each of the third party calendar applications for storing the events, etc. In an example, a default storage location for storing events in a data store is a default calendar into which the event management platform writes, whenever the user creates, updates, or deletes an event using the client application. The event management platform receives a unique calendar identifier as part of the event information to uniquely identify the particular calendar where the events are to be stored. Therefore, the default storage location for storing the events of the user may be the native local data store external to the client application or a data store of the third party calendar application.

Furthermore, the event management platform stores a copy of all the events triggered by the client applications of the users registered with the event management platform, in the information database of the event management platform. In an embodiment, a client application on each of the computing devices of the users, configured as a downloadable software component, comprises a local data store for storing the events generated by the event management platform.

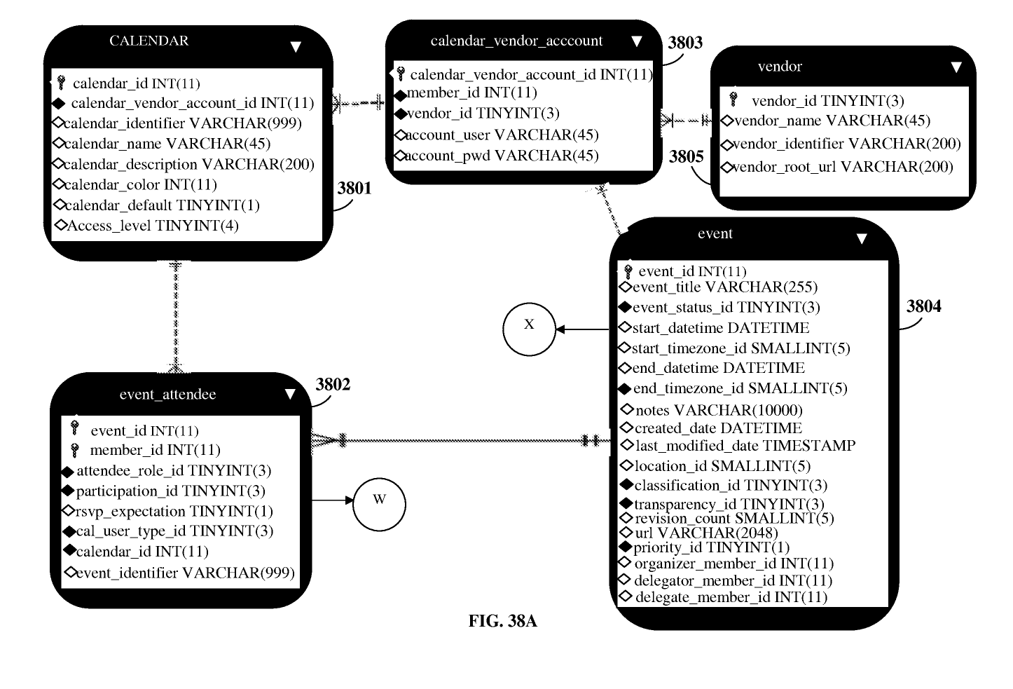

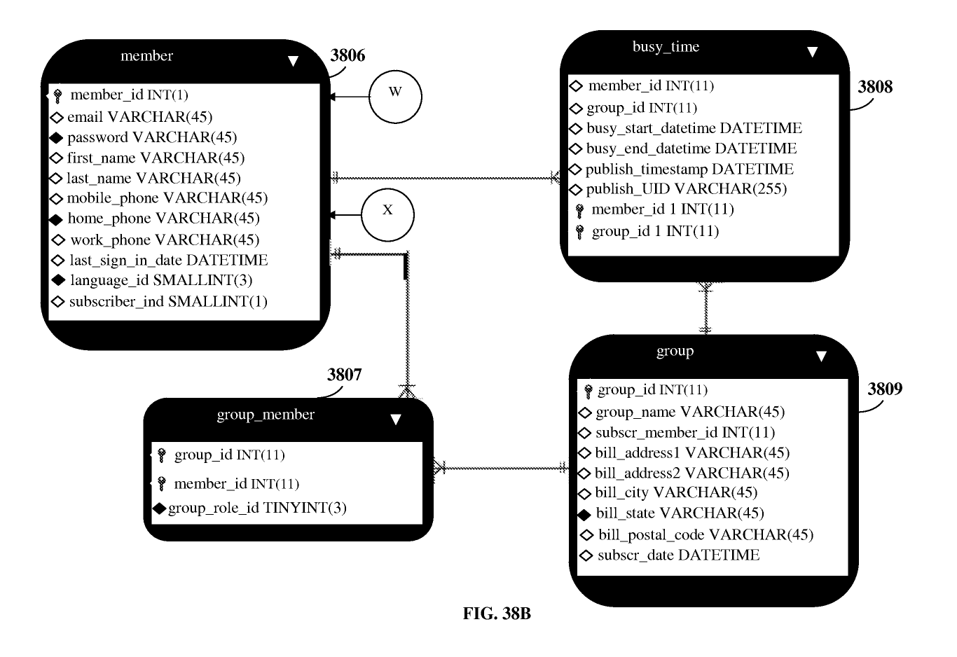

The event management platform enables users to register with the event management platform for generation of events, storage of events, tracking and updating of events, etc. The event management platform creates an account for each of the users who register with the event management platform. Furthermore, during registration, the event management platforms enables users to add members to their groups, select an identity in the group, for example, as a parent, a child, etc., select resources usable by the group such as a car, the electronic mail (email) addresses of each of the users, etc. The event management platform links the characteristic information acquired from the users, such as the account credentials of each of the third party calendar applications, for example, external electronic calendars, to the created user account, and sets the default storage location, for example, using a unique calendar identifier that identifies the electronic calendar where all events associated with the user are to be stored by default. This default storage location, for example, the electronic calendar is the calendar to which the event management platform writes each time the user creates, updates, or deletes an event using the client application. The electronic calendar may exist in a data store on the computing device, external to the client application, that is, the native local data store, or in a data store in the third party calendar application. Each new group member can link their electronic calendars and set their respective default calendars for their own accounts. The registration process populates database tables in the information database of the event management platform as disclosed in the detailed description of FIGS. 38A-38B.

The event management platform therefore constructs a network that links the client applications and third party calendar applications of multiple users in the group associated with one or more events, thereby enabling the event management platform to synchronize events and the actions performed on the events by one or more of the users in the group throughout the client applications and the third party calendar applications of each of the users in the group.

In an embodiment, the client application on each user's computing device provides a graphical user interface (GUI) to the user to enter in the characteristic information and the event information. The client application then transmits the characteristic information and the event information to the event management platform over the network for completing the registration of the user with the event management platform. Therefore, the event management platform acquires the characteristic information and the event information from the client application over the network. Furthermore, the registration process also enables the client application to identify possible member metadata, for example, a member identifier number, an electronic mail (email) address, etc., that aids the client application when communicating with a web services application programming interface (API) of the event management platform.

The event management platform, in communication with the client application over the network, generates 104 one or more events based on the acquired event information and stores 104 the generated events, for example, in the information database. In an embodiment, the client application on the user's computing device triggers generation of the event. In an embodiment, the event management platform is accessible to a user over a network connection, for example, an internet connection established by the user with the event management platform, for example, through a mobile web browser or a desktop computer. In an embodiment, the event management platform allows the user to trigger the generation of the event in a web based calendar application, for example, Google Calendar of Google, Inc., hosted on the event management platform. Furthermore, the event management platform is accessible for triggering the generation of an event via third party partners collaborating with the event management platform, or external calendar applications with access to the event management platform. In order to trigger the generation of an event, the user may define the event and set a start time and an end time for the event. Furthermore, the user may select other group members as attendees, delegate the event to another user, add a location, or notes on the event, etc. The event may be associated with zero or more attendees and zero or more delegates.

The event management platform, in communication with the client application over the network, generates the events, for example, by validating a request associated with the generation of each of the events, received from the client application on each of the computing devices of the users in the group. The event management platform generates an event identification key for each of the events for uniquely identifying each of the events on successful validation of the request. The event management platform transmits the generated event identification key to the client application and/or each of the third party calendar applications over the network for storage of the events, for example, in a data store of the client application herein referred to as a “local data store”, a data store residing on each of the computing devices of the users external to the client application herein referred to as a “native local data store”, and/or a data store of each of the third party calendar applications.

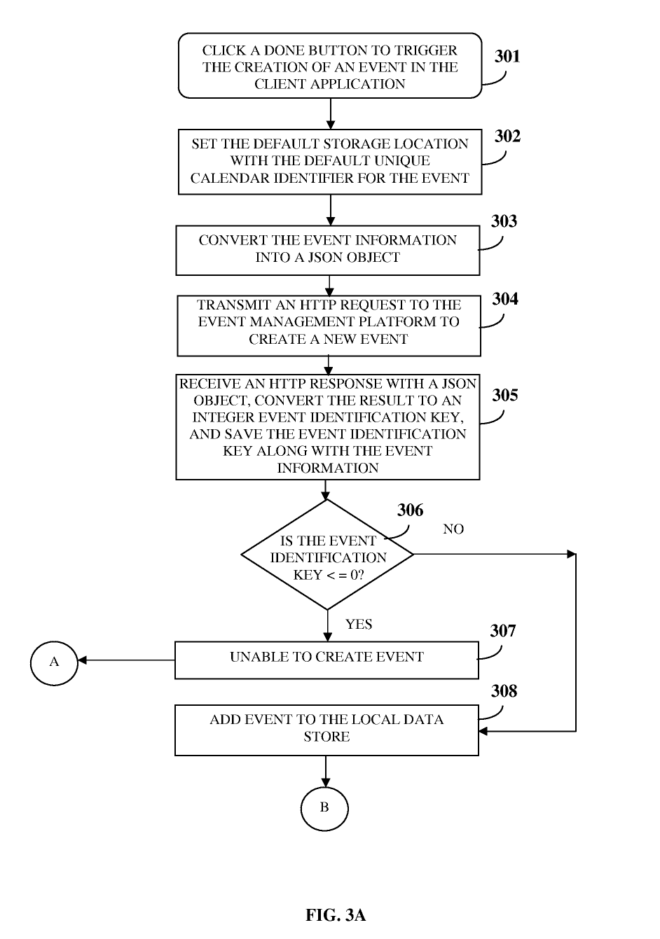

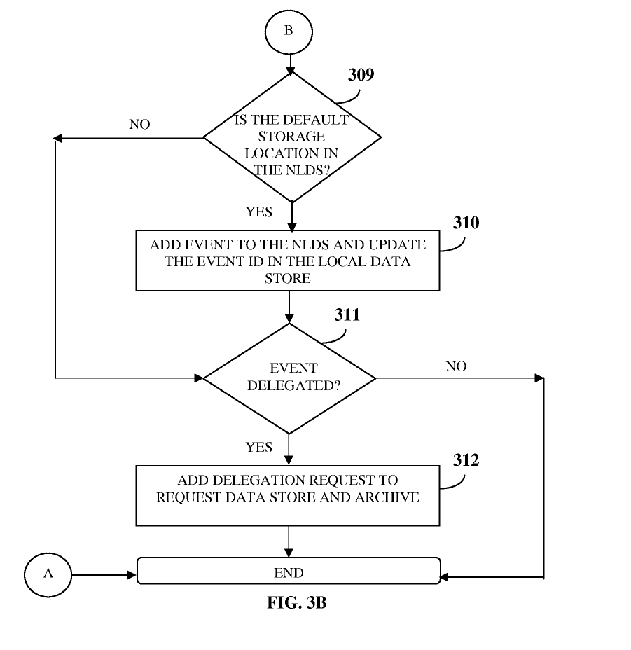

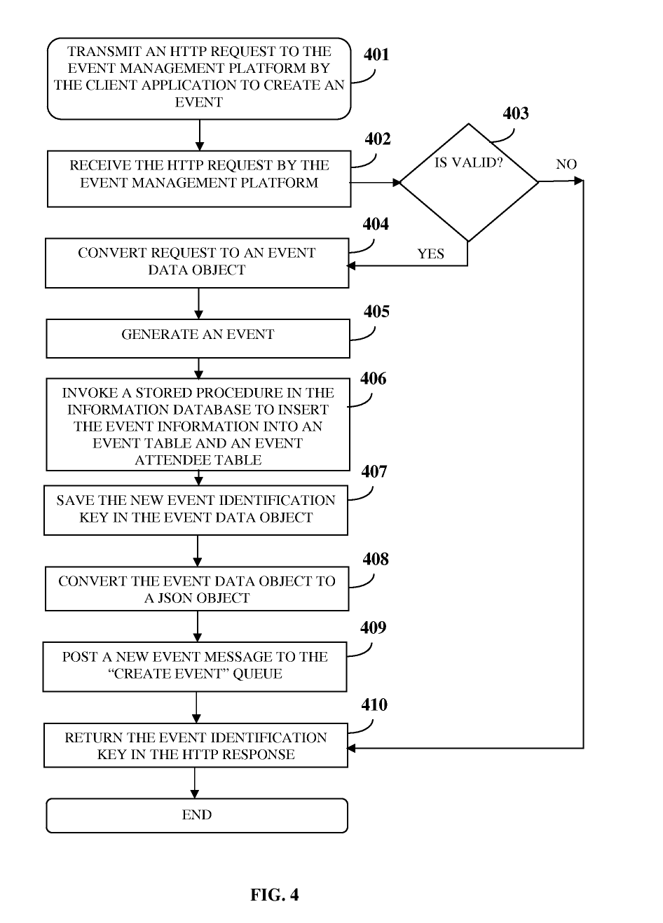

Furthermore, the generated event identification key received by the client application and/or each of the third party calendar applications is mapped to a unique event identifier generated by the native local data store and/or the data store of each of the third party calendar applications respectively for storing the generated events in the native local data store and/or the data store of each of the third party calendar applications respectively. That is, each user who has accepted to participate in an event has a unique event identifier, for example, a globally unique identifier (GUID) string generated by the default storage location defined by the user, mapped to the event identification key associated with the event. This enables storage and manipulation of the events in the default storage location, for example, the native local data store or the data store of a third party calendar application. In an example, when an organizer of an event, herein referred to as an “event organizer”, who is also an attendee of the event, triggers the generation of the event, the event management platform generates an event identification key that is automatically mapped to the unique event identifier associated with the event generated by the default storage location. This is based on the assumption that since the event organizer organized the event, the event organizer has implicitly accepted the event unless the event was delegated to another attendee of the event. Furthermore, when an attendee accepts a given event with an existing event identification key, the unique event identifier of the attendee's default storage location is mapped to the event identification key. The mapping of the event identification key generated by the event management platform with the unique event identifier associated with the event generated by a user's default storage location allows management of events over disparate calendar systems. The steps for triggering the generation of an event by the client application are disclosed in the detailed descriptions of FIGS. 3A-3B and FIG. 4.

The event management platform stores 105 the generated events across the data store residing on each of the computing devices external to the client application also referred to as the native local data store, and/or the data store of each of the third party calendar applications, of each of the users in the group associated with the generated events, over the network using the acquired characteristic information and event information. The event management platform stores the generated events across the data stores over the network, for example, by transmitting a copy of each of the generated events to each of the data stores via the network. In an example, the client application stores the generated events in a local data store internal to the client application and then to the native local data store on the user's computing device, on receiving a notification from the event management platform, as disclosed in the detailed description of FIGS. 3A-3B. The client application stores the generated events in one or more calendars of the native local data store installed locally on the computing device of the user, on receiving a notification from the event management platform via the network. For example, prior to completing the storage of the event, the event management platform determines whether a copy of the event is already maintained in a native local data store associated with the client application or in a data store associated with a third party calendar application. The event management platform stores the event only on confirming that the event does not exist in the data store of the client application or the data store of the third party calendar application, or on determining that the copy of the event is a chronologically older version of the current event. In an example, the event management platform determines presence or absence of an event in the third party calendar application of a member of a group independent of usage of a client application on a computing device by the group member. The event management platform retrieves the account credentials of the group member for accessing the third party calendar application, logs into the third party calendar application, and checks whether a calendar in the third party calendar application has already stored a copy of the event.

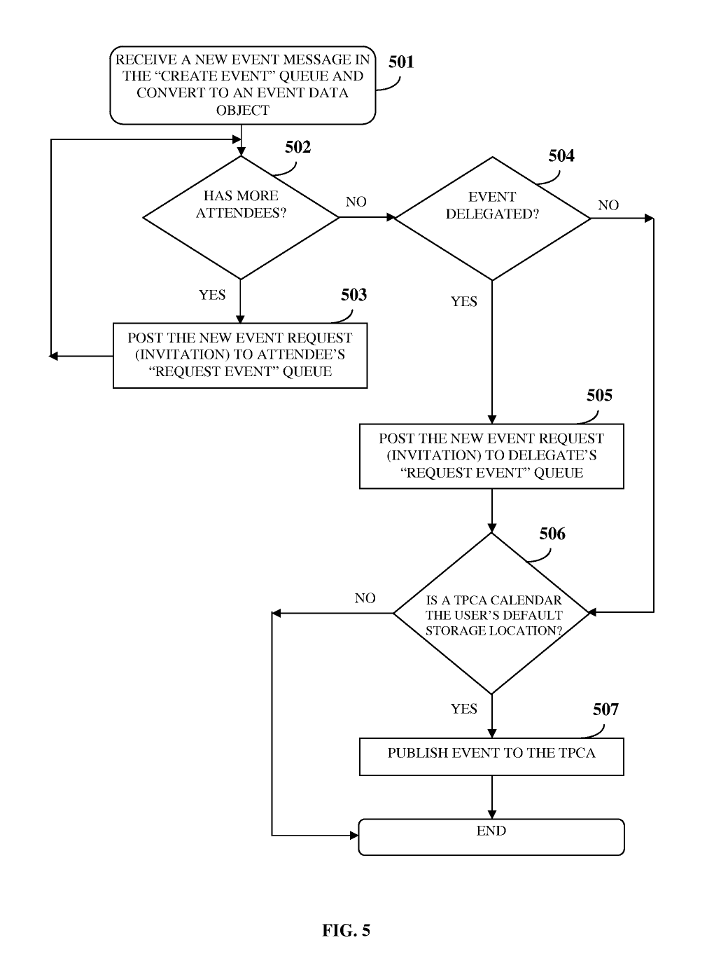

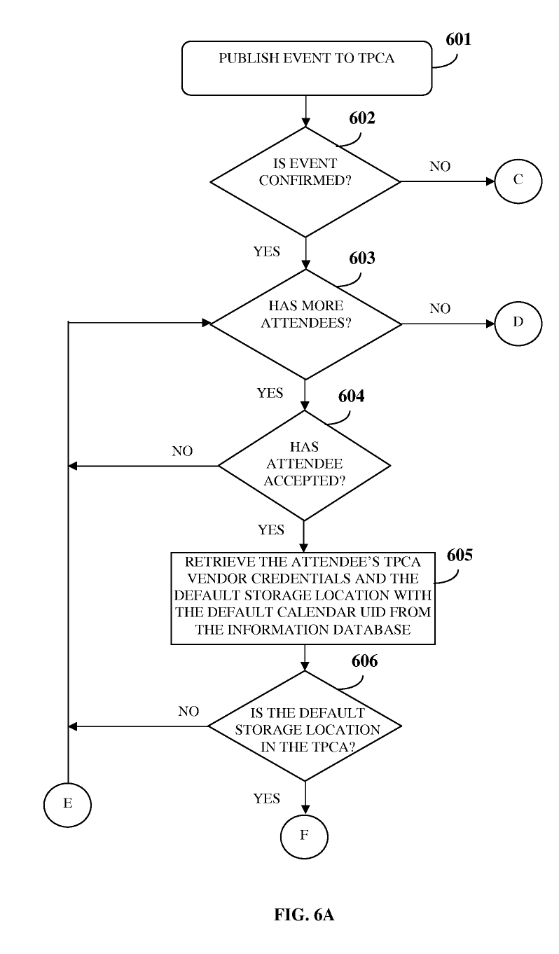

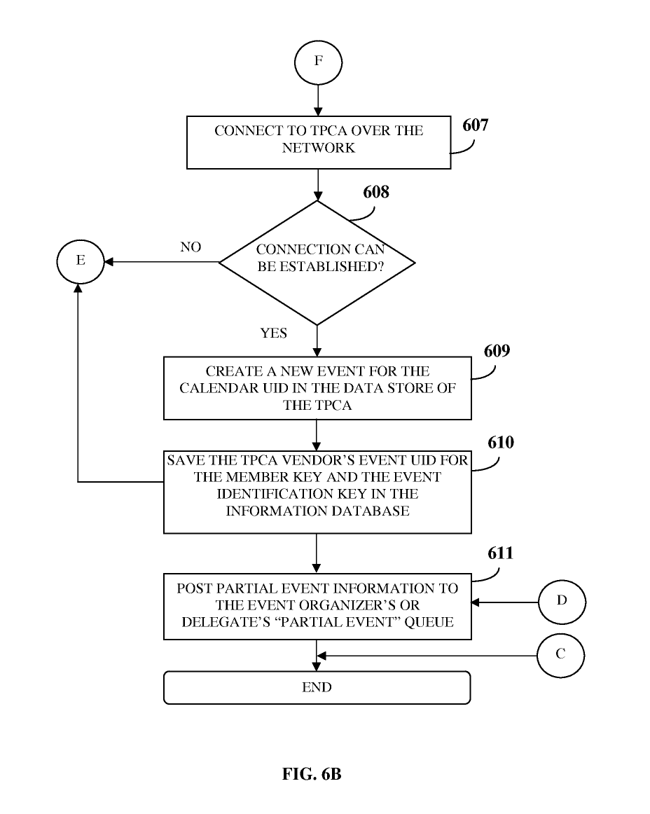

Furthermore, in order to store the generated events in the data stores associated with the users, the event management platform determines absence of the events generated for a user in the local data store of the client application of each of the other users in the group, the native local data store of each of the other users in the group, and/or the data store of each of the third party calendar applications of each of the other users in the group over the network. The event management platform stores the events generated for that user across the local data store, the native local data store, and/or the data stores of the third party calendar applications of each of the other users over the network, based on the determination of the absence, and a receipt of an acceptance message for the events from each of the other users in the group. The steps for storing and publishing the generated events are disclosed in the detailed descriptions of FIG. 5, FIGS. 6A-6B, and FIGS. 7-9. In an embodiment, the event management platform stores copies of the events across all the calendar applications running on a single computing device of a user.

The stored events are accessible to each of the users in the group associated with the generated events over the network for performing one or more actions on the stored events. The actions performed on the stored events by the users in the group comprise, for example, triggering a request for viewing the events of a particular user as well as each of the members of a group including the user, deleting the stored events, updating the event information for updating the stored events scheduled by each of the users in the group, accepting an event invitation, cancelling an event invitation, etc.

In an embodiment, the computing devices of each of the users in the group are provided with a local event management database for storing the generated events to ensure uninterrupted performance of actions on the stored events independent of the network, in the client application. For example, when a client application of a user is disconnected from the network, the client application may create, read, update and delete events by accessing a local version of the information database of the event management platform, herein referred to as “local event management database” on the computing device. When the client application connects to the network, the client application initiates a synchronization process to resolve differences in the event information between the local event management database on the user's computing device and the information database in the event management platform. In another embodiment, in the absence of connectivity to the network, the client application stores a queue of notification messages, for example, event invitation replies provided by the attendees of an event in response to an event invitation request sent by an event organizer of the event to attend the event. As used herein the term “event organizer” refers to one of the users in the group who schedules an event. The client application queues the invitation replies in a predetermined storage location on the computing device, and transmits the queued notification messages to the event management platform on establishing connectivity with the network.

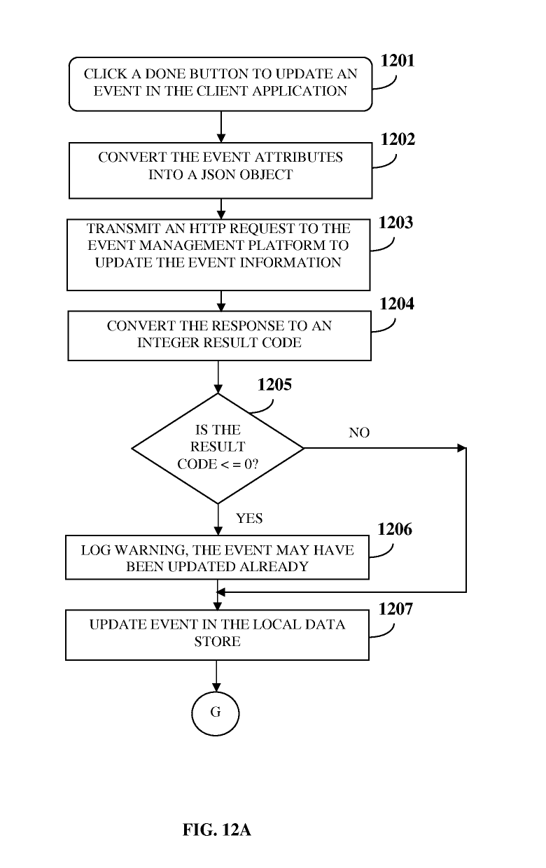

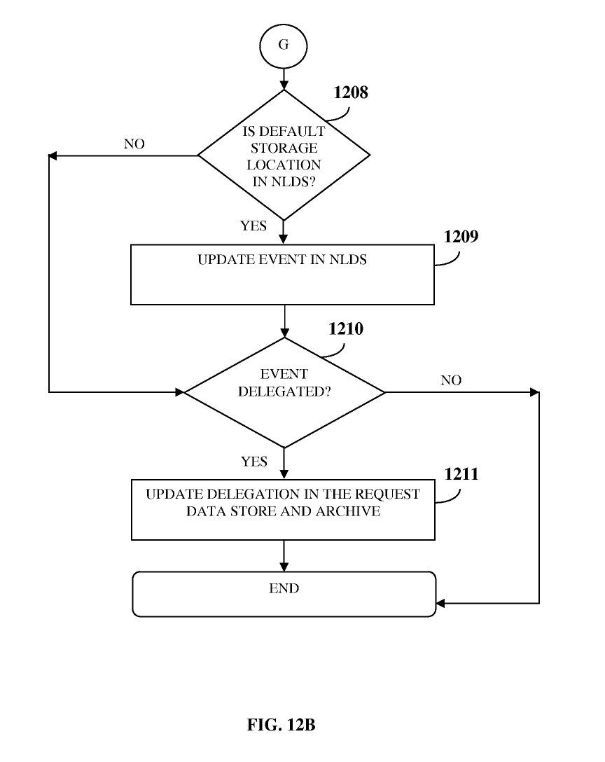

The event management platform, in communication with the client application on each of the computing devices of each of the users in the group, tracks 106 the actions performed on the stored events by the users in the group. In an embodiment, the event management platform, in communication with the client application over the network, tracks the actions performed on the stored events by one of the users in the group by determining whether a result of each of the actions performed on the stored events by one of the users in the group is updated in the local data store of the client application, the native local data store, and/or the data store of each of the third party calendar applications of each of the other users in the group. The event management platform automatically updates 107 the stored events across the native local data store on each of the computing devices of each of the users in the group and/or the data store of each of the third party calendar applications of each of the users in the group associated with the generated events, over the network using the acquired characteristic information and event information. In an embodiment, the client application may update the event in the data store of a third party calendar application and notify the event management platform. The actions performed on the stored events, the tracking of the actions performed on the stored events, and the automatic updating of the results of the actions across the client applications of each of the individual users, the event management platform, and the third party calendar applications, the functioning of the event management platform and the client application for tracking and updating the results of the actions, etc., are disclosed in the detailed descriptions of FIGS. 12A-12B to FIG. 35.

In an embodiment, the event management platform automatically updates the result of each of the actions performed on the stored events by one of users in the group, in the data store of each of the third party calendar applications of each of the other users in the group, and transmits a notification to the client application of each of the other users in the group via the network for updating the result of each of the actions performed on the stored events by one of the users in the group in the local data store of the client application and/or the native local data store of each of the other users in the group, based on determination of the result of each of the actions and a receipt of an acceptance message for the result of each of actions by each of the other users in the group. In an example, consider a user X who needs to view all events involving another user Y in the group within a predetermined duration of time. The event management platform waits for an acceptance message from the user Y affirming that the user Y has no objection to user X viewing of user Y's events. In another example, consider a user X who has updated the location of an event. The user Y may have manually updated the event in a third party calendar application. In order to avoid duplication of the action of updating the event, the event management platform queries the user Y to confirm whether the event should be updated in the user Y's third party calendar application. In an embodiment, when a user has configured settings in the event management platform such that no approval is needed for updating the result of each of the actions, the event management platform tracks the actions performed on the events by each of the users in the group and automatically updates all the third party calendar applications that are installed on that user's computing device or distributed across multiple computing devices of the same user.

In an embodiment, a user's client application, in communication with the event management platform over the network, retrieves the events associated with each of the other users in the group, stored across the local data store of the client application, the native local data store on the computing device, and the data store of each of the third party calendar applications of each of the other users in the group over the network via the information database of the event management platform. In an embodiment, the event management platform determines events retrieved across the native local data store on each of the computing devices, the local data store of the client application, and/or the data store of each of the third party calendar application of each of the other users in the group, that are duplicated, and transmits a single copy of the events from among the duplicated events to the client application of the requesting user via the network.

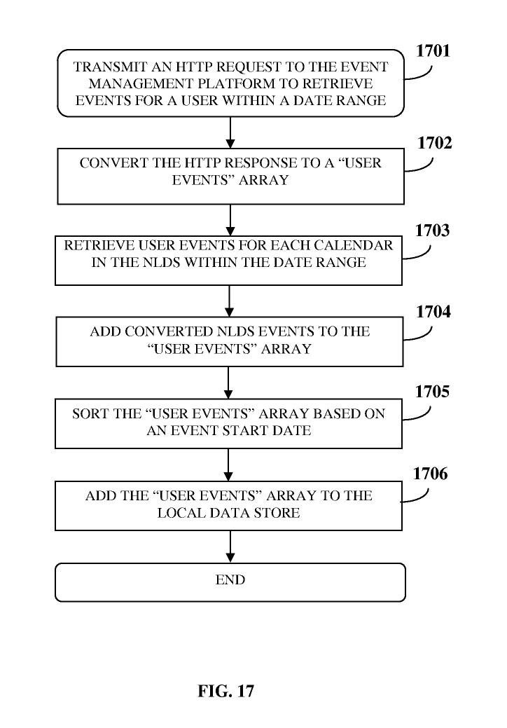

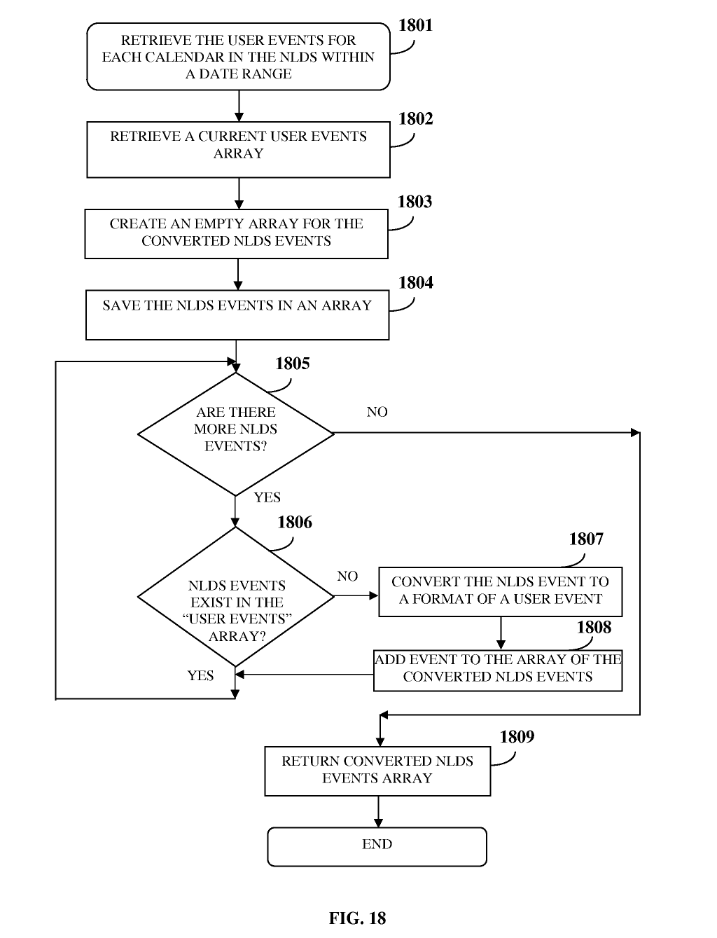

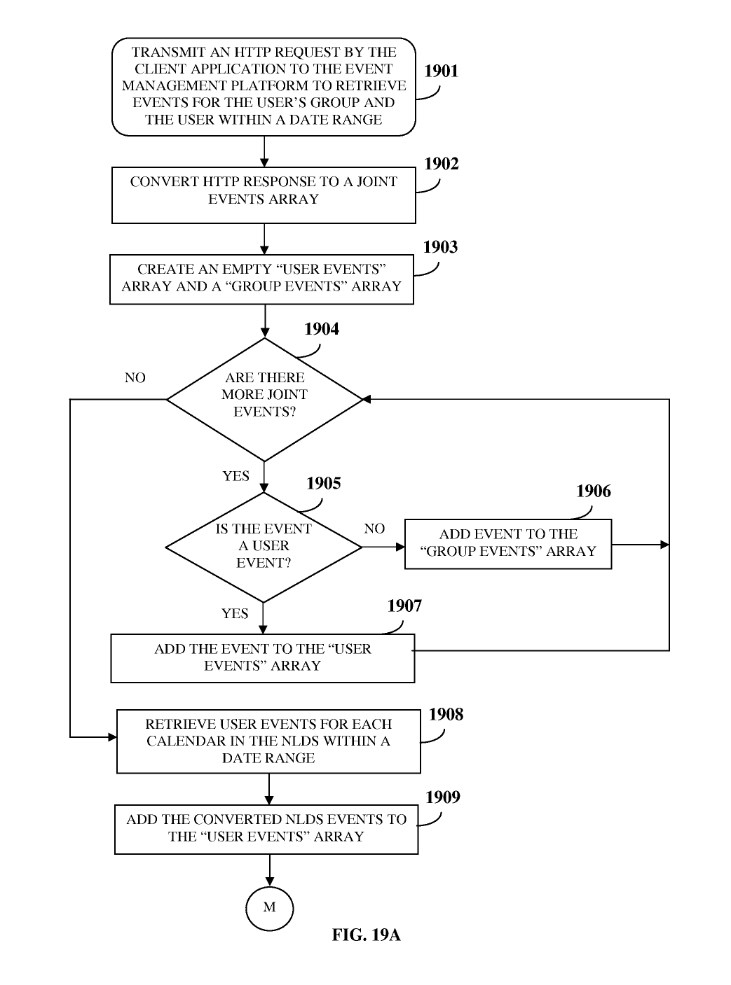

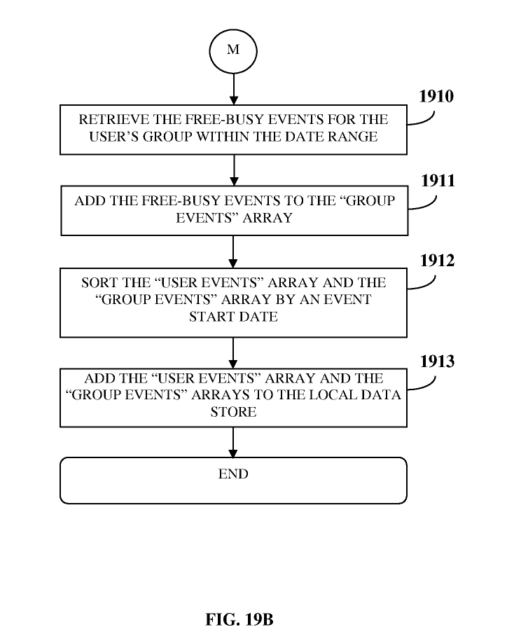

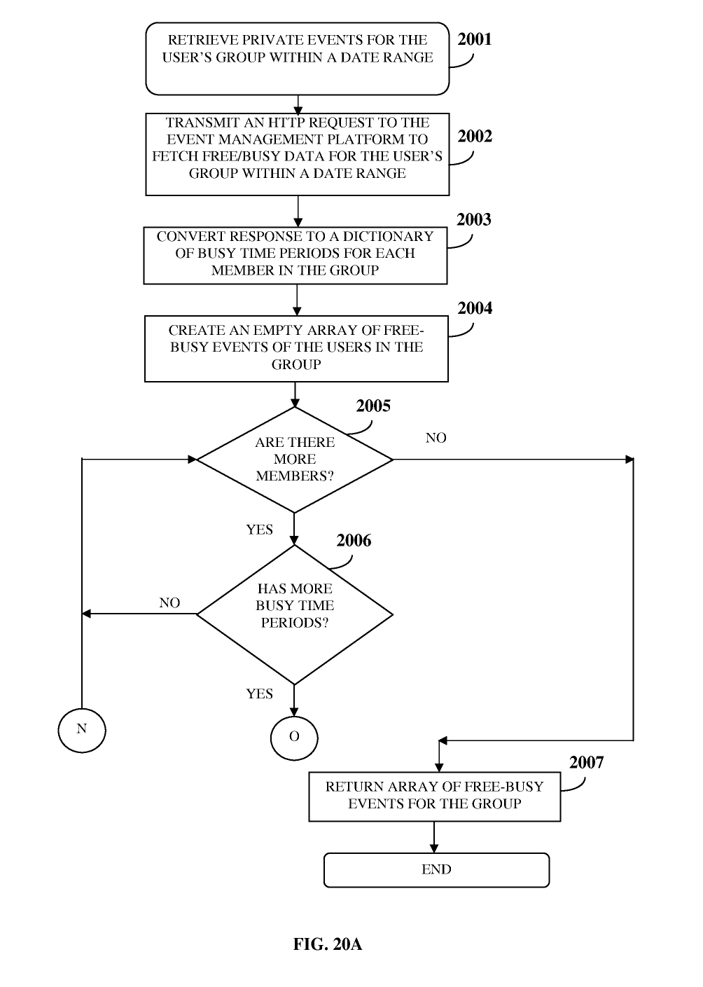

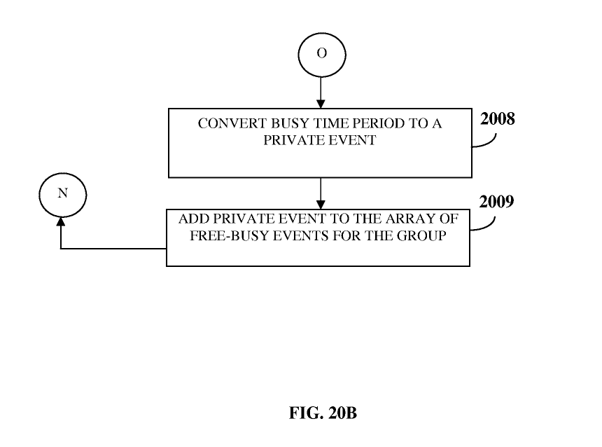

In an example, the event management platform buffers all the events retrieved from the local data store, the native local data store, and the data store of the third party calendar applications of each of the users in the group. The event management platform then retrieves the copies of the generated events stored internally in the information database of the event management platform, and determines whether there is a duplication of the events stored internally in the information database and the retrieved events. The event management platform stores a single copy of all the events in the information database and transmits these events to the client application. The client application thereby retrieves the events associated with the other users via the information database of the event management platform. The client application retrieves the events, for example, based on viewing criteria acquired from the user, such as retrieving all events within a particular date range, as disclosed in the detailed description of FIG. 17, FIG. 18, FIGS. 19A-19B, and FIGS. 20A-20B. The client application on each user's computing device sorts the retrieved events based on predetermined sorting criteria defined by the user. The predetermined sorting criteria comprise, for example, the earliest scheduled events, the duration of the events, etc. The client application then displays the sorted events on its GUI.

In an embodiment, the event management platform selectively publishes the events retrieved from the local data store of the client application, the information database of the event management platform, the native local data store, and the data store of each of the third party calendar applications, to the users in the group via the network based on selection criteria. The selection criteria comprise, for example, access rights configuration for the group, the type of group, etc. Consider an example where users in an organization are part of an “Employee” group and/or a “Manager” group in the organization. If a user in the “Employee” group transmits a request message to the event management platform to access the events of a manager, that is, a user in the “Manager” group, the event management platform determines whether the events are to be selectively published according to the selection criteria. If the manager has restricted the access rights to employees who are not a part of the “Manager” group, the event management platform selectively publishes only events that are common to the “Employee” group to the default storage location of the user.

In an embodiment, the client application on each of the computing devices of each of the users in the group determines one or more busy time periods of each of the users in the group using private event information on the events stored in the native local data store and transmits a notification of the determined busy time periods to the event management platform via the network. As used herein, a “busy time period” refers to a time period between a start time and an end time of an event associated with a user in the group. The event management platform, in communication with the client application over the network, generates one or more private events for each of the users in the group based on the determined busy time periods of each of the users in the group received from the client application over the network. As used herein, the term “private event” refers to an event that is marked as a personal event by a user in the group and whose complete event information is not available for viewing by the other users in the group. The private event information defines the private event. The private event information, for example, only defines the start time and end time of the event without completely defining the nature of the event, the type of the event, a location of the event, etc. That is, the extent of access to the details of the private event is configured by the user owning the private event. The event management platform then transmits a notification of the generated private events of each of the users in the group to the client application of each of the other users in the group via the network for accessing the generated private events of each of the users in the group by the other users in the group. The event management platform enables a user to view the availability of other users in the user's group for a particular event scheduled on a particular date and time.

In an embodiment, the event management platform, in communication with the client application over the network, determines delegation of the events from one of the users in the group to another one of the users in the group for performing actions on the stored events.

In an embodiment, the event management platform, in communication with the client application of each of the users via the network, analyzes an availability status of each of the users in the group using the event information. The event management platform transmits a notification to the client application of each of the other users in the group via the network for tracking availability of each of the users in the group for the events scheduled by each of the users in the group. The event management platform analyzes the user's availability for a particular time period based on whether the events involving the user events occur at the same time, or in the middle of the particular time period, or partly overlap with the particular time period. The storage locations of these events may be in linked calendars, a default calendar, the information database of the event management platform, etc.

Furthermore, in an embodiment, the event management platform tracks the availability of one or more resources utilized by each of the users in the group within a predetermined time duration. For example, the event management platform extracts information on resources employed by a group of users such as a car, a meeting room, etc., from the event information. The event management platform tracks the time durations when the resource is in usage by one of the users in the group and transmits a notification message to the other users in the group, indicating that the resource is “busy” within the time duration of usage. On receiving a notification message from the user of the resource or on expiry of the allotted predetermined duration of time, the event management platform notifies the other users in the group that the resource has been released and may be used by another user in the group.

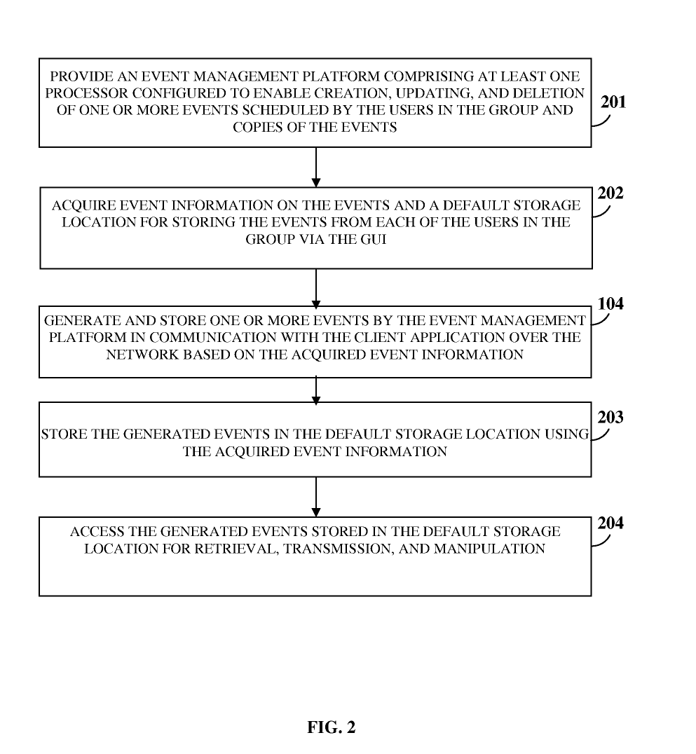

FIG. 2 exemplarily illustrates an embodiment of the computer implemented method for managing one or more events scheduled by multiple users in a group. The computer implemented method disclosed herein provides 201 the event management platform comprising at least one processor configured to enable creation, updating, and deletion of the events scheduled by the users in the group and the copies of the events.

The event management platform acquires 202 event information on the events and a default storage location for storing the events from each of the users in the group, via the graphical user interface (GUI) of the event management platform. The default storage location is, for example, a data store residing on each of the computing devices external to the client application, herein referred to as a “native local data store” of each of the users in the group associated with the events and a data store of each of the third party calendar applications of each of the users in the group associated with the events. For example, the event management platform acquires the calendar vendor identifiers and the unique calendar identifiers for identifying the default storage locations as part of a sign-up registration procedure. This is because there may be multiple calendars associated with a single calendar vendor and a user may use a single calendar or multiple calendars within the third party calendar application of the particular calendar vendor. A user can link to one calendar or many calendars and set a particular calendar as the default storage location. The user can configure storage to one or many storage locations, that is, one to many calendars in the native local data store or the third party calendar applications and the associated calendars in each.

The event management platform, in communication with the client application over the network, generates and stores 104 events based on the acquired event information as disclosed in the detailed description of FIG. 1. In an embodiment, the event management platform first transmits an event invitation for each of the events triggered by a user in the group to other users in the group via the network. The event management platform then generates the events and transmits a copy of the generated events to the default storage location of each of the other users in the group via the network on receiving an acceptance message for the events from each of the other users in the group.

The event management platform stores the identification information of the default storage location that stores all the events associated with a particular user. For example, the event management platform stores the unique calendar identifier of the calendar in the default storage location where the events associated with the user are automatically stored. Furthermore, the event management platform stores a unique event identifier to which the event identification key is mapped as disclosed in the detailed description of FIGS. 3A-3B. An event identification key, for example, is a unique integer value generated internally by the event management platform that allows all the users in a group associated with the event to identify the event. An event identifier, for example, is a unique string value, generated by the default storage location associated with each of the individual client applications or third party calendar applications of the users in the group, that uniquely identifies a particular copy of the event maintained in the default storage location for each of the users in the group.

The event management platform stores 203 the generated events in the default storage location associated with each of the users in the group for each of the events over the network using the acquired event information and identification information of the default storage location. The stored events are accessible to each of the users in the group associated with the generated events over the network for performing one or more actions on the stored events. The event management platform accesses 204 events in the default storage location via the network for retrieval, transmission, and manipulation. For example, based on the mapping between the event identification key and the unique event identifier, and the information on the default storage locations for each of the users in the group, the event management platform accesses the copies of the events maintained for each of the users in the group, and manipulates, for example, updates the events. Each of the users in the group may also have a backup copy of the events stored in a respective default storage location. The users can view their events when they do not have access to the client application on their computing devices or to the event management platform. The event management platform publishes the generated events stored in the native location data store residing on each of the computing devices of each of the users in the group external to the client application, to other users in the group via the network. Therefore, the users in a group can view the disparate calendar data of all the users in the group using a client application connected to the event management platform via a network.

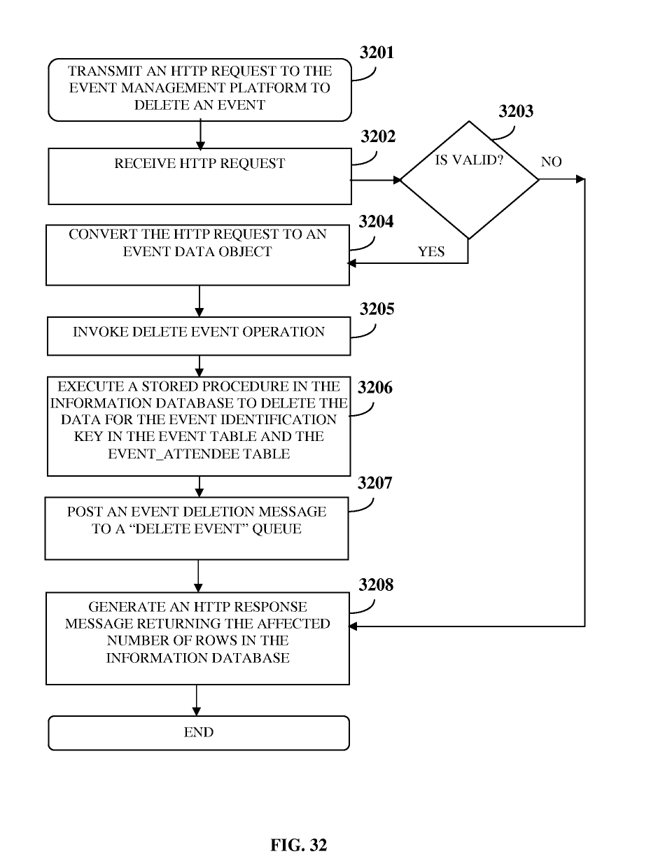

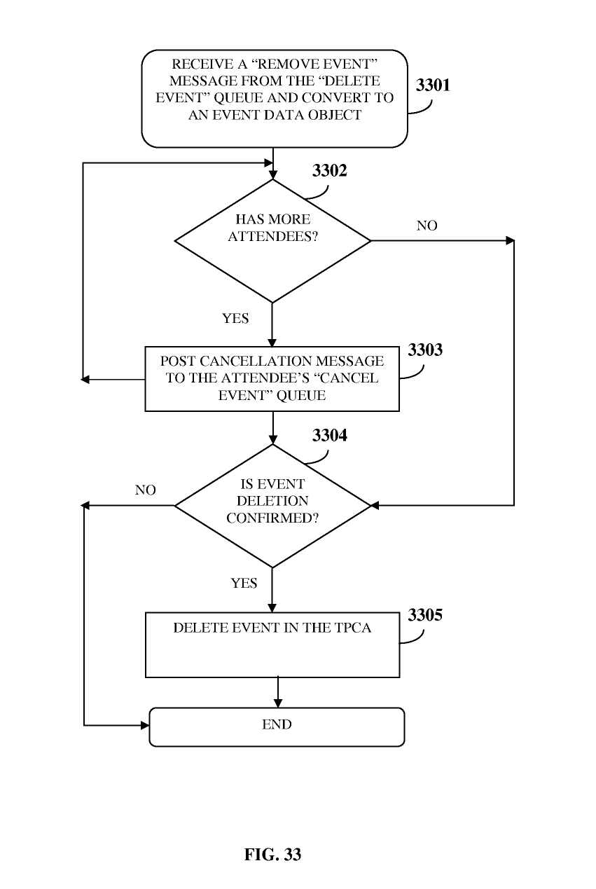

In an embodiment, the event management platform deletes the generated events and transmits a notification to the client application on each of the computing devices of each of the other users in the group for performing deletion of the copy of the generated events from the default storage location of each of the other users in the group via the network, on receiving a cancellation message from each of the other users in the group, as disclosed in the detailed description of FIGS. 32-33. The event management platform allows the users in the group to cancel an event invitation and remove the copy of the associated event from their respective default storage locations.

The computer implemented method disclosed herein enables a group of users to view and manage electronic calendar data stored on each group member's heterogeneous computing devices and calendar services. A few practical applications of the computer implemented method and the computer implemented system herein referred to as a “unified virtual group calendar system” disclosed herein are provided herein. A member of a family group comprising, for example, parents, children, friends, guardians, babysitters, relatives, etc., may use the computer implemented method and system disclosed herein to schedule an event such as scheduling a medical checkup, delegate the events, check the availability of the family members for a family gathering, etc. A member of a work group comprising colleagues, business partners, freelancers, contractors, employees, customers, etc., may use the computer implemented method and system disclosed herein to schedule meetings, delegate meetings, or check the availability of the members of the group for a meeting. In another example, a member of a group of friends may use the computer implemented method and system disclosed herein to schedule events such as outings, games, etc., delegate the events and check the availability of all the members of the group for the events.

A member of a study group comprising, for example, students, teachers, subject matter experts, etc., may use the computer implemented method and system disclosed herein to schedule a group study session, delegate the supervision of the group study session to a different teacher, check availability of each of the members of the study group, etc. In another example, the computer implemented method and system disclosed herein may be used by clients to book appointments with professionals, for example, doctors, lawyers, dentists, teachers, trade professionals such as plumbers, electricians, carpenters, etc., sales professionals such as real estate agents, insurance agents, etc., based on the availability of the clients or the availability of the professionals. A customer service desk at a company may schedule meetings with customers based on the availability of the customer and the customer service desk using the unified virtual group calendar system disclosed herein. A human resources department of an organization may arrange interviews with candidates based on their availability and vice versa using the unified virtual group calendar system disclosed herein. In another example, in order to eliminate long queues at a local governmental office, a state governmental office, or a national governmental office, administrators can arrange appointments with citizens based on their availability and vice versa using the unified virtual group calendar system disclosed herein. In another example, senior citizens and their caregivers, for example, physical therapists, nurse aids, home health care workers, family members, etc., can employ the computer implemented method and the unified virtual group calendar system disclosed herein to schedule visits, delegate the responsibility of supervision to another individual, check the availability of the group of caregivers, etc.

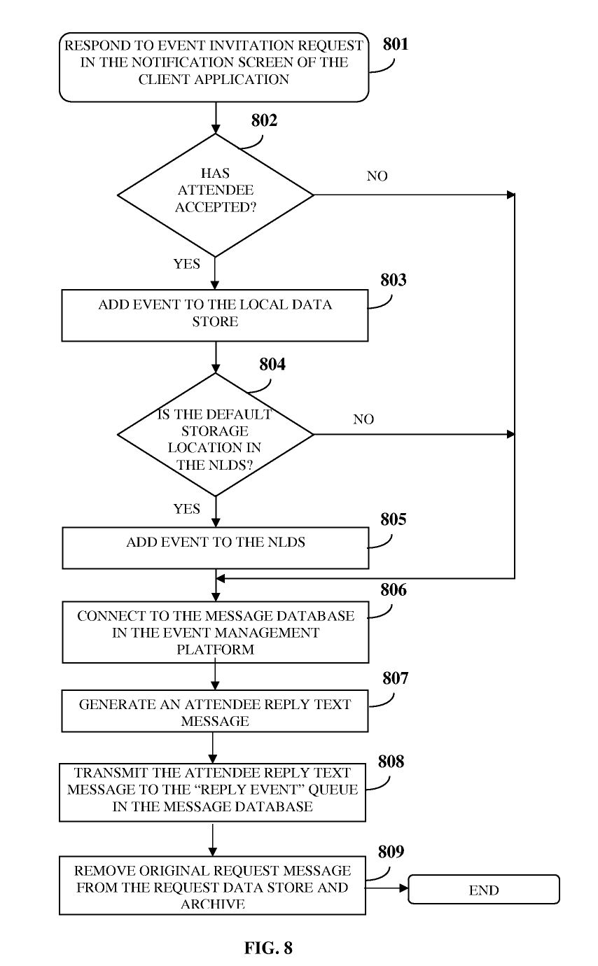

Therefore, the members of a group can use the computer implemented method and the unified virtual group calendar system disclosed herein to keep track of events in their calendars and events of other group members. The client application provides a graphical user interface (GUI) through which a member can create, read, update or delete events in communication with the event management platform via the network. A member can view the member's own events as well as the events of other group members, via the GUI of the client application. The client application can check availability of members while creating or updating an event or display the availability of all the members in a “group view” on the GUI of the client application. Members can respond to event invitations or delegations or receive event cancellations through the GUI of the client application as disclosed in the detailed descriptions of FIGS. 8-11.

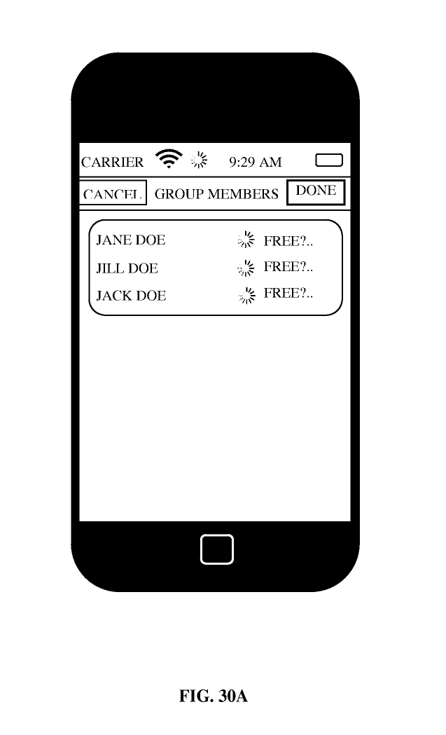

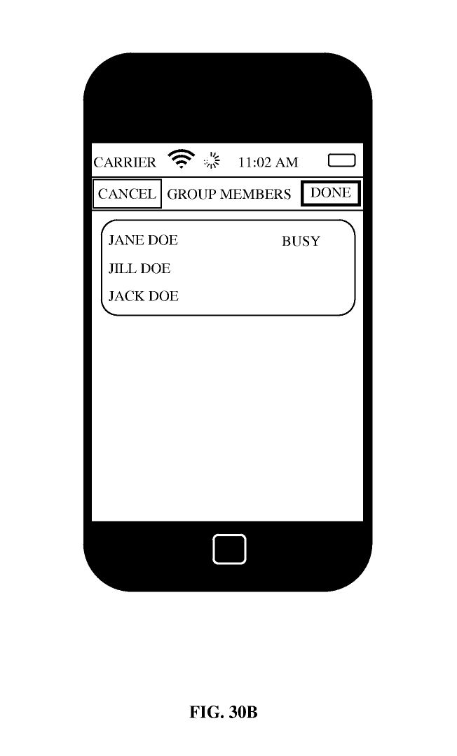

FIGS. 3A-3B exemplarily illustrate a flowchart comprising the steps for triggering generation of an event by a client application in communication with the event management platform via the network. The client application provides a graphical user interface (GUI), as exemplarily illustrated in FIG. 30A, for entering inputs for performing one or more actions by the user. A user clicks 301a done button on a “create event” window of the GUI of the client application after providing the event information to trigger the creation of an event. The client application sets 302 the user's default storage location with the default unique calendar identifier for storing the event. For example, the client application sets a unique identifier (UID) identifying a particular calendar, referred to as default unique calendar identifier for storing events, that is prestored in the data store of the client application, for the event. The client application converts 303 the event information comprising specific event attributes to a data object, for example, a JavaScript Object Notation (JSON) object for transmission to the event management platform via the network. JSON is a data interchange format used for representing the converted event information. In other examples, the data objects for carrying payloads of the notification messages are of formats such as a plain text format, an extensible markup language (XML) format, a binary data format, a property list format, proprietary formats, etc. The client application transmits 304 a request message in the form of, for example, a hypertext transfer protocol (HTTP) request message to the event management platform, via a web services API in the event management platform over the network to trigger the creation of a new event, with the JSON object in the body of the request message. The event management platform then generates and transmits a HTTP response, enclosing a JSON object that comprises a new event identification key, for example, as “result:42”. The steps for generation of an event in the event management platform are disclosed in the detailed descriptions of FIGS. 4-5. The event management platform stores a copy of the event identification key in an “event table” database entity in the information database of the event management platform that stores the event attributes associated with the event. The event identification key is, for example, a unique integer, that is stored as a primary key in the event table.

The client application receives 305 the HTTP response enclosing the JSON object from the event management platform via the network and converts the result in the text format to an integer event identification key and saves the integer event identification key along with the event information in the local data store of the client application. The client application then determines 306 whether the event identification key is lesser than or equal to 0. If the event identification key is lesser than or equal to 0, the client application determines that the event management platform was unable 307 to create the event and ends the process. If the event identification key is greater than 0, the event management platform proceeds to store the event in the local data store of the client application via the network. The client application adds 308 the event to the local data store that is part of the client application. The local data store is a storage location in the client application that stores a snapshot of the events associated with the user and the events associated with the members of a group including the user, retrieved from the event management platform via the network. For example, the local data store stores the events of a user such as a mother and the events associated with her husband and children. The client application updates the events of the user in the local data store to ensure that the events in the client application are synchronized with the event management platform when the user interacts with the client application.

The client application then determines 309 whether the user's default storage location for storing events is a calendar in the native local data store (NLDS), which is the data store external to the client application and on the computing device. The NLDS is the external data store on the computing device hosting the client application. If the user's default storage location is set to the NLDS, the client application adds 310 the event to the NLDS on the computing device, external to the client application, and updates an event identifier (ID) for the event in the local data store in the client application. That is, when the user's default storage location is set to the NLDS, the client application creates and/or updates a copy of the event from the local data store to the NLDS. The event ID is a globally unique identifier (GUID) generated by the data store associated with the client application or a data store associated with a third party calendar application. In an embodiment, the event ID is generated by the client application or the event management platform. Since the event identifier is a GUID, the event identifier is used by the client application or the event management platform to search and update an event for a particular user, in the NLDS or in the third party calendar application. Furthermore, an event identification key representing a particular event generated by the event management platform maps to one or more event identifiers corresponding to each of the users who are attending the event. Therefore, each user has a unique event ID corresponding to an event identification key, to enable copy of events to the NLDS or the data store of the third party calendar application depending on the default storage location of the event. Furthermore, the event management platform stores the mapping between the event identification key and the event ID in an event_attendee table, and the event information in the event table of the information database of the event management platform.

After the client application determines that the user's default storage location is not the native local data store or after the adds the event to the NLDS, the client application determines 311 whether the event needs to be delegated. For example, the client application checks whether a request for generation of the event is tagged with a request for delegation. The client application determines that the event has been delegated to a user when a delegator, that is, a person delegating an event, assigns the event to the user in the group, that is, the delegate. The delegator assigns his/her participation in a scheduled event to another user, referred to as the delegate. Therefore, the delegate is assigned to participate in an event in the place of the delegator. For example, a mother may assign or delegate a dentist appointment for the children to the father, so that the father can take the children for the dentist appointment. In another example, a subordinate attends a meeting delegated to him on behalf of the manager. Therefore, the delegator will not attend the event if the delegate accepts the event. If the client application determines that the event is not to be delegated to the user of the client application, the client application ends the process. If the client application determines that the event needs to be delegated to the user of the client application, the client application adds 312 a delegation request to a request data store in the client application and archives the request data store, that is, stores the request data store to a persistent file or a persistent database. The request data store is a data store maintained by each client application that stores all the request notifications received by the user from the event management platform for participating in an event, updating an event, etc.

FIG. 4 exemplarily illustrates a flowchart comprising the steps for generating an event by the event management platform. As disclosed in the detailed description of FIGS. 3A-3B, the client application transmits 401a hypertext transfer protocol (HTTP) request message with the JavaScript Object Notation (JSON) object in the body of the request message to the event management platform to create a new event. The event management platform receives 402 the HTTP request message in a web services application programming interface (API). The event management platform checks 403 the validity of the request message. For example, the event management platform first determines whether the JSON object is malformed. If the JSON object is malformed, the event management platform does not process the event information further. The event management platform then determines the correctness of the event information such as the validity of a start date and an end date of the event, the validity of a start time and an end time of the event, the contact information and identity of the users, that is, the attendees and the delegates, etc., added to the event. If the request message is valid, the event management platform converts 404 the JSON object request in the body of the HTTP request message to an event data object in a format defined by the event management platform and proceeds to generate the event. The event management platform then invokes an internal “create event” operation in the information database of the event management platform to generate 405 an event along with an event identification key. The event management platform invokes 406 a stored procedure in the information database to insert the event information into the event table and the event_attendee table in the information database of the event management platform. The event table stores the individual attributes of the event such as the date, time, location, etc., extracted from the event information and the event_attendee table stores details on the users associated with the event, that is, the attendees of the event such as the role of the attendee, a member identifier, etc. The event management platform saves 407 the new event identification key, that is, the primary key of the event table in the event data object. The event management platform converts 408 the event data object to a JSON object. The event management platform posts 409 the new event JSON object text message to an internal “create event” queue in the event management platform for further processing and publishing to third party calendar applications as disclosed in the detailed description of FIG. 5 and FIGS. 6A-6B. The “create event” queue stores the notification messages for review by the event management platform to store events in the third party calendar applications by the event management platform. The event management platform returns 410 the event identification key in the HTTP response message. The event management platform then ends the process. If the event management platform determines that the HTTP request message is invalid, the event management platform returns 410 an invalid event identification key during the transmission of an HTTP response message to the client application via the network.

FIG. 5 exemplarily illustrates a flowchart comprising the steps for generating an event for publishing to a third party calendar application by the event management platform. The event management platform receives 501a new event message in the “create event” queue, and converts the JavaScript Object Notation (JSON) object in the body of the new event message to a format of an event data object in the event management platform for processing of the event information. The event management platform determines 502 whether the generated event is associated with any more users. Each user associated with the event is herein referred to as an “attendee”. An attendee is a recipient of an invitation to participate in a calendar event. If there are no more attendees, the event management platform proceeds to determining 504 whether the event needs to be delegated to another attendee. If there are more attendees, the event management platform posts 503 a new event request message or invitation, formatted as a JSON object, to each attendee's “request event” queue. The “request event” queue is a separate queue maintained for each of the attendees for storing the event request messages to be notified to the particular attendee. In another example, for notifying the attendee, the event management platform transmits an electronic mail to the attendee with links to a web page that is, for example, hosted on the event management platform where the attendee could accept or decline the event request or invitation. The event management platform then determines whether the event has been delegated to the attendee. If there are more attendees and the event has been delegated to the attendee, the event management platform, for example, posts 505 a new event request message or invitation notifying the request for delegation of the event to the delegate's “request event” queue. The request for delegation of the event, herein referred to as “delegation request” comprises a member identifier indicating the identity of the delegate. In another example, the event management platform notifies the delegation request message to the attendee in an electronic mail. If the event is not delegated or after the event management platform posts the new event request message to the delegate's “request event” queue, the event management platform determines 506 from the event information whether the user's default storage location for storing events is a calendar associated with a third party calendar application (TPCA). The default storage location is defined, for example, by a unique identifier marking a particular calendar. If the default storage location defined by an attendee is associated with a third party calendar application, the event management platform publishes 507 the event to the third party calendar application as disclosed in the detailed description of FIGS. 6A-6B. That is, the event management platform creates an entry for the event in a calendar of the third party calendar application for storing the generated event in the third party calendar application. If the default storage location is not associated with a third party calendar application, the event management platform ends the process.

FIGS. 6A-6B exemplarily illustrate a flowchart comprising the steps for publishing a generated event to a third party calendar application by the event management platform. In order to publish 601 the generated event to a third party calendar application (TPCA), the event management platform determines 602 whether the event has been confirmed by the user who schedules and initiates the event, herein referred to as the “event organizer”. The event management platform verifies whether the status of the event is set to “Confirmed” in the event data object or the event table of the information database. If the event has not been confirmed, the event management platform ends the process. If the event has been confirmed, the event management platform determines 603 whether the event has more attendees. If the event has any more attendees, the event management platform determines 604 whether an acceptance message in response to the event request message has been received from each of the attendees, that is, whether each of the attendees has accepted the request for participating in the event.

If the event has no more attendees, the event management platform proceeds to the step of posting 611a notification message comprising partial event information as a JavaScript Object Notation (JSON) object to a “partial event” queue of the event organizer or the delegate and ends the process. The “partial event” queue stores notification messages indicating storage or updating of an event in a third party calendar application. If an attendee has not yet accepted the event request, or has declined the event request, the event management platform returns to determining 603 whether there are any more attendees for whom the events need to be stored. If an attendee among the invited attendees has accepted the request for participating in the event, the event management platform retrieves 605 the attendee's third party calendar application vendor credentials and the details of the default storage location for storing the events, for example, a default calendar unique identifier (UID) identifying the calendar where the events are stored, from the information database of the event management platform.

Furthermore, the event management platform checks 606 from the retrieved details of the default storage location, whether the attendee's default storage location for storing the events is in the third party calendar application. If the attendee's default storage location for storing the events is in the third party calendar application, the event management platform determines the vendor of the third party calendar application, for example, Google Calendar of Google, Inc., and the account credentials such as the account identifier and the password extracted from the characteristic information, for connecting 607 to the particular third party calendar application over the network. The event management platform determines 608 whether the connection can be established, that is, whether the account credentials and parameters required for establishing the connection are valid. If the account credentials and parameters required for establishing the connection are valid, the event management platform creates 609 a new event in the default storage location, that is, the calendar identified by the default calendar UID, in the data store of the third party calendar application. If the account credentials and parameters required for establishing the connection are not valid, the event management platform returns to check 603 for the next attendee.

The event management platform saves 610 the third party calendar application vendor's event identifier for the member key and the event identification key in the information database of the event management platform and returns to check 603 for the next attendee. The event management platform posts 611 the partial event information in the form of a JSON object notification message to the event organizer's or the delegate's “partial event” queue for communicating partial event information on the storage of the event in the third party calendar application. The information is considered to be partial since each notification message indicates event synchronization information for one of multiple attendees of the event. The partial event synchronization information comprises, for example, a creation date, the event identifier, the event identification key, that is, the primary key generated for the event, the last modified date, a revision count, etc. The event management platform then ends the process.

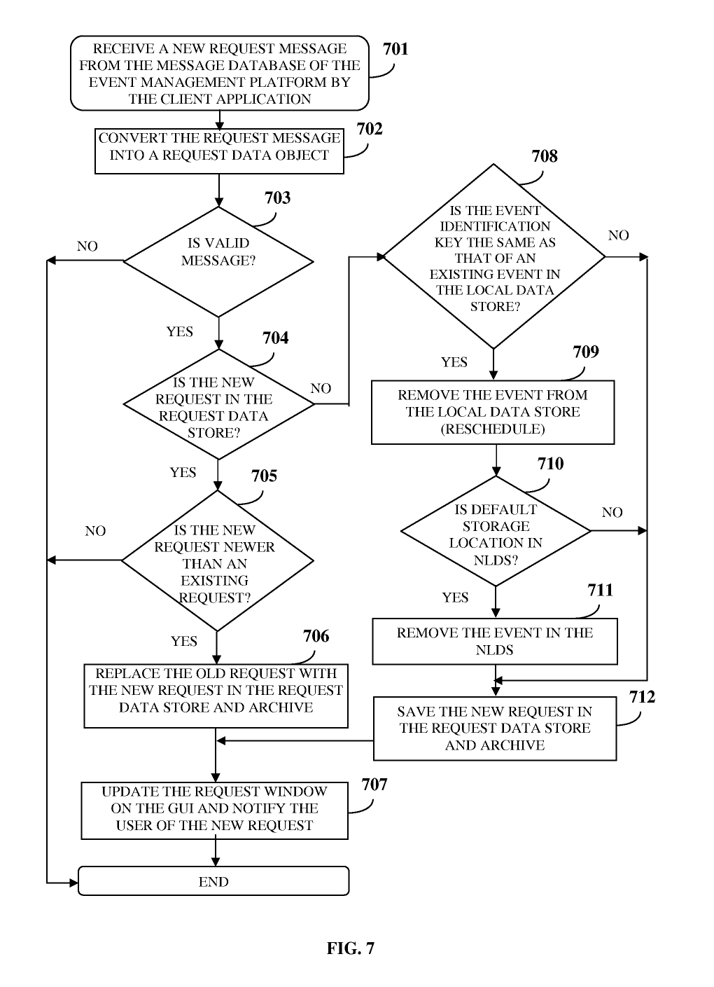

FIG. 7 exemplarily illustrates a flowchart comprising the steps for updating a generated event in a client application on receiving a notification from the event management platform. The client application on the computing device of an attendee receives 701a new event request message JavaScript Object Notation (JSON) object inviting the attendee to participate in a event, from the message database of the event management platform via the network. The client application of the attendee initiates storage of the generated event. The client application converts 702 the JSON event request message into a request data object. That is, the client application converts the received request message to the format of a data object in the request data store of the client application. The request data store, for example, stores all the event requests received from the event management platform. The client application determines 703 from the request data object whether the information in the request data object, herein referred to as “request message information”, for example, the event date, whether the attendee is associated with the event, etc., is valid. If the request message information is not valid, the client application ends the process.

If the request message information is valid, the client application determines 704 whether a new event request message is already stored in the request data store of the client application. If the new event request message already exists in the request data store of the client application, the client application determines 705 whether the new request message is newer than the existing request message in the request data store by comparing timestamps. If the received request message is chronologically newer than an existing request message in the request data store, the client application replaces 706 the old request message by the new request message in the request data store and archives the request data store, that is, stores the request data store in a persistent file or a persistent database. The client application then updates 707 a request window on the graphical user interface (GUI) of the client application, notifies the user of the new request, and ends the process. If the received request message is chronologically older than the existing request message in the request data store, the client application ends the process.

Furthermore, if the received request message was not already stored in the request data store in the client application, the client application then determines 708 whether the event identification key defined in the event request message is the same as the event identification key of an existing event stored in the local data store in the client application. If the event identification key is the same as the event identification key of an existing event, the client application removes 709 the event from the local data store residing within the client application because the event has been rescheduled. The client application determines 710 whether the user's default storage location is in a native local data store (NLDS) associated with the client application. If the default storage location is the native local data store, the client application checks and removes 711 the event with the same event identifier in the native local data store. If the default storage location is not in the native local data store, the client application determines that the default storage location is in a third party calendar application and proceeds to save the request message information. The client application saves 712 the new request message information in the request data store. Furthermore, the client application saves the request data store to a persistent file or a persistent database for obtaining a persistent version of the request data store. The persistent file can be referred by a user to check outstanding event requests between consecutive launches of the client application. In another embodiment, an attendee can receive the event request in an electronic mail (email). The event request is persisted in an email box of the attendee. The client application then updates 707 a request window on the GUI of the client application, notifies the user of the new request, and ends the process.

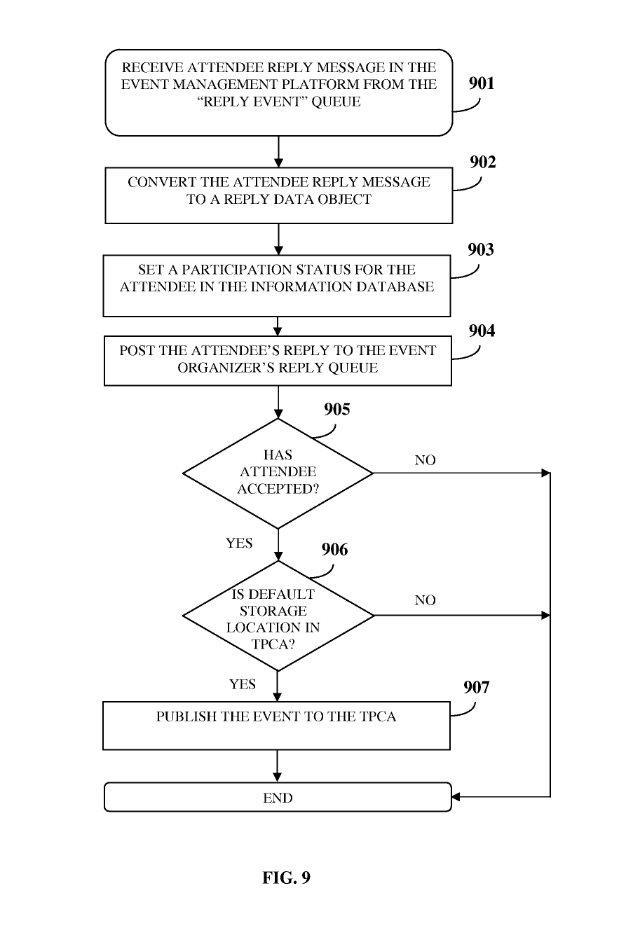

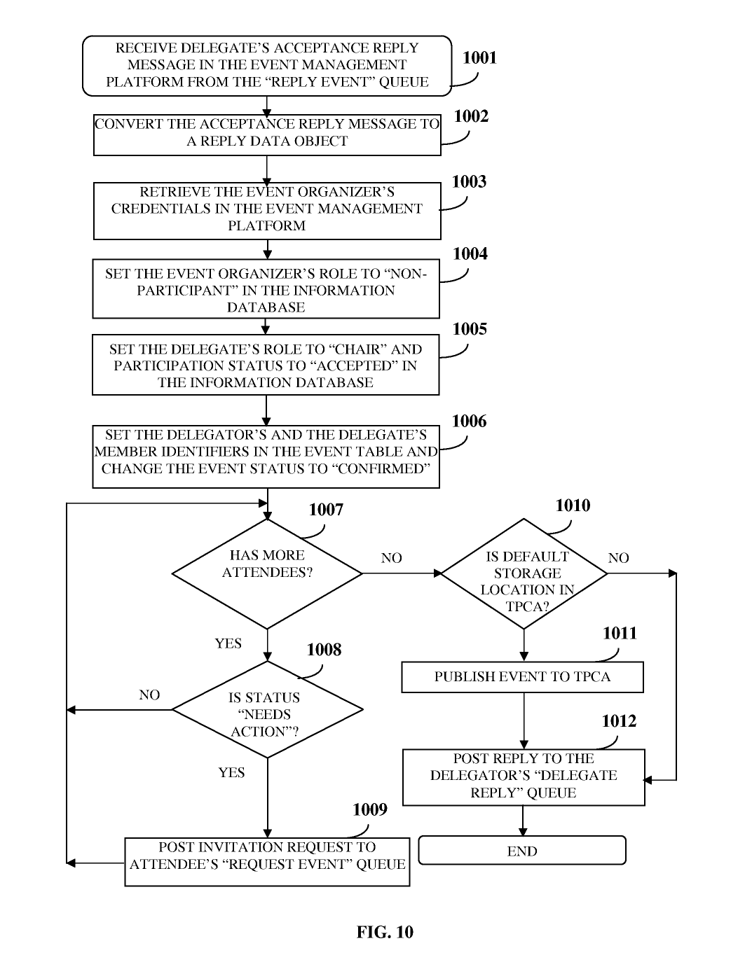

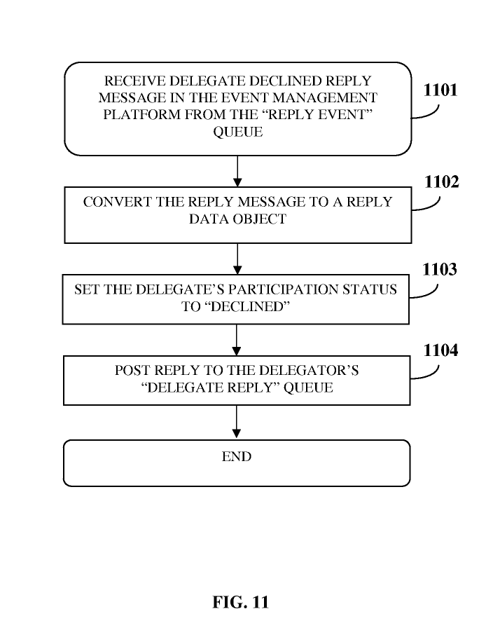

FIG. 8 exemplarily illustrates a flowchart comprising the steps for processing a reply to an event invitation request received by an attendee, by the client application. The event invitation request comprises a request for accepting delegation of the event. The user responds or replies 801 to the event invitation request for storage of the event, in a notification screen of the graphical user interface (GUI) of the client application. The reply message comprises a reply to the event invitation request or a reply to the delegation request. The client application receives the reply message and differentiates between the replies by verifying whether the reply message includes a delegator and a delegate. If there is no delegator or delegate defined in the reply message, the client application determines the reply is a standard reply to the event invitation request. If there is a delegator or a delegate defined in the reply message, the client application determines that the reply message is a reply to a delegation request message. The client application determines 802 whether the attendee has accepted the event invitation request or the delegation request. If the attendee has accepted the event invitation request or the delegation request, the client application adds 803 the event to the local data store residing within the client application. The client application then determines 804 whether the user's default storage location for storing events is in the native local data store (NLDS) associated with the client application. If the user's default storage location is in the NLDS, the client application adds 805 the event to the NLDS and updates the event identifier for the event in the local data store within the client application. The client application then connects 806 to the message database in the event management platform. The client application generates 807 an attendee reply message and transmits 808 the attendee reply message to a “reply event” queue in the message database of the event management platform via the network. The “reply event” queue stores individual notification messages received from each of the users recording the replies of the users to the event invitation requests or the delegation requests. The steps for processing a reply to the event invitation request by the event management platform are disclosed in the detailed description of FIG. 9 and the steps for processing a reply to the delegation request are disclosed in the detailed descriptions of FIG. 10 and FIG. 11. The client application then removes 809 the original request message from the request data store and archives the request data store, that is, stores the request data store to a persistent file or a persistent database.

If the attendee has not accepted the event invitation request or the delegation request, the client application proceeds to connect 806 to the message database in the event management platform for notifying the event management platform on declining of the event invitation request or the delegation request by the attendee and proceeds with steps 807, 808, and 809.

FIG. 9 exemplarily illustrates a flowchart comprising the steps for processing a reply received from an attendee to a request for participation in an event, by the event management platform. The event management platform receives 901 an attendee reply message transmitted by the client application from the “reply event” queue as disclosed in the detailed description of FIG. 8. In an embodiment, the event management platform stores the attendee reply message in the information database of the event management platform. The event management platform converts 902 the attendee reply message to a reply data object. The event management platform sets 903 and stores a participation status for the attendee in the event_attendee table of the information database. The event management platform posts 904 the attendee's reply to a reply queue of an event organizer who scheduled the event for notifying the response of the attendee to the event organizer. The event management platform determines 905 whether the attendee has accepted the event request. If the attendee has not accepted the event request, the event management platform ends the process. If the attendee has accepted the event request, the event management platform determines 906 whether the attendee's default storage location, for example, a particular calendar that stores all the user's events identified by a unique calendar identifier, is in a third party calendar application. If the attendee's default storage location is in a third party calendar application, the event management platform publishes 907 the event to the third party calendar application and stores the event in the data store of the third party calendar application. If the attendee's default storage location is not in a third party calendar application, the event management platform ends the process.

FIG. 10 exemplarily illustrates a flowchart comprising the steps for processing an acceptance reply message to a request for delegation of an event, received from a delegate by the event management platform. The event management platform receives an acceptance reply message from the “reply event” queue indicating that a delegate has accepted a delegation of the event. The event management platform converts 1002 the delegate's acceptance reply message to a reply data object defined by the event management platform. The event management platform retrieves 1003 the event organizer's credentials from the information database of the event management platform. The event management platform sets 1004 the organizer's role to “Non-Participant” in the event_attendee table in the information database. The event management platform sets 1005 the delegate's role, for example, to “Chair” and a participation status to “Accepted” in the event_attendee table of the information database. The event management platform sets 1006 the delegator's and delegate's member identifiers in the event table of the information database and changes the status of the event in the event table to “Confirmed”. The member identifier is a unique identifier provided to a user in a group for identifying the user in events associated with the group. The event management platform determines 1007 whether the event has any more attendees associated with the event. If the event has more attendees, the event management platform determines 1008 whether the current attendee's participation status is set to “Needs Action”. This allows the event management platform to determine whether the attendee has replied to the event request. If the current attendee's participation status is not set to “Needs Action”, the event management platform returns to check 1007 for the next attendee. If the current attendee's participation status is set to “Needs Action”, the event management platform posts 1009 a new event invitation request message, that is, an invitation message as a JavaScript Object Notation (JSON) object, to the attendee's “request event” queue for notifying the client application of the attendee.

An example of a scenario when the attendee's participation status is set to “Needs Action” is when the event management awaits a response from a delegate. The event management platform sets the event status of delegated events to “Tentative”. When the event status of an event is “tentative”, the event management platform has not received a confirmation from the delegate and therefore does not send event requests to other attendees with the exception of the delegate. When the delegate accepts a delegation request, the event management platform transmits the event requests to the other attendees, that is, the invitees. The event management platform then returns to check 1007 for the next attendee. If there no more attendees to be checked, the event management platform determines 1010 whether the attendee's default storage location for storing the events is in a third party calendar application. If the attendee's default storage location for storing the events is in a third party calendar application, the event management platform publishes 1011 the event to the third party calendar application via the network, stores the event in the data store of the third party calendar application, as disclosed in the detailed description of FIGS. 6A-6B, and proceeds to notify the delegator. If the attendee's default storage location for storing the events is not in a third party calendar application, the event management platform directly notifies the delegator. The event management platform notifies the delegator of the acceptance of the delegate for the delegation of the event, for example, by posting 1012 a reply message to the delegator's “delegate reply” queue. The event management platform then ends the process.

FIG. 11 exemplarily illustrates a flowchart comprising the steps for processing a declined reply message to a request for delegation of an event, received from a user, by the event management platform. The event management platform receives 1101a “delegate declined” reply message transmitted by the client application of the user from the “reply event” queue. The event management platform converts 1102 the reply message to a reply data object of the event management platform. The event management platform sets 1103 the delegate's participation status to “Declined” in the event_attendee table of the information database. The event management platform posts 1104 a reply message to a delegator's “delegate reply” queue for notifying the delegator on declination of the request for delegation, by the user.

FIGS. 12A-12B exemplarily illustrate a flowchart comprising the steps for updating an event in a local data store of the client application and a native local data store on a computing device of a user. The user clicks 1201a “Done” button to update the event information for an event on the graphical user interface (GUI) of the client application. The client application converts 1202 the event attributes of the event information to a JavaScript Object Notation (JSON) object. The client application generates and transmits 1203 a hypertext transfer protocol (HTTP) request message to the event management platform to update the event information for the event, with the JSON object enclosed in the HTTP request message. The event management platform transmits a response JSON object with the number of rows affected as a consequence of the updating of the event information in the information database, for example, as {“result”:1} to indicate that one row has been modified. Each row corresponds to an entry in the event table and a corresponding entry in the event_attendee table in the information database of the event management platform. The client application receives the response JSON object and converts 1204 the response to an integer result code. The client application determines 1205 whether the result code is lesser than or equal to 0. If the result code is lesser than or equal to 0, the client application logs 1206 a warning indicating that the event may have been updated already and then proceeds to update the event identifier. If the event code is greater than 0, the client application updates 1207 the event information for the event based on the event identifier in the local data store of the client application.

The client application determines 1208 whether the user's default storage location for storing the events is in the native local data store (NLDS) associated with the client application. If the user's default storage location for storing the events is in the NLDS, the client application updates 1209 the event information for the particular event identifier in the NLDS and then proceeds to determining 1210 whether the event has been delegated to the user. If the user's default storage location for storing the events is not in the NLDS, the client application directly determines 1210 whether the event has been delegated to the user. If the event has been delegated to the user, the client application updates 1211 the delegation request for the event identification key in the request data store of the client application, archives the request data store, that is, stores the request data store to a persistent file or a persistent database, and ends the process. If the event to be updated has not been delegated to the user, the client application ends the process.

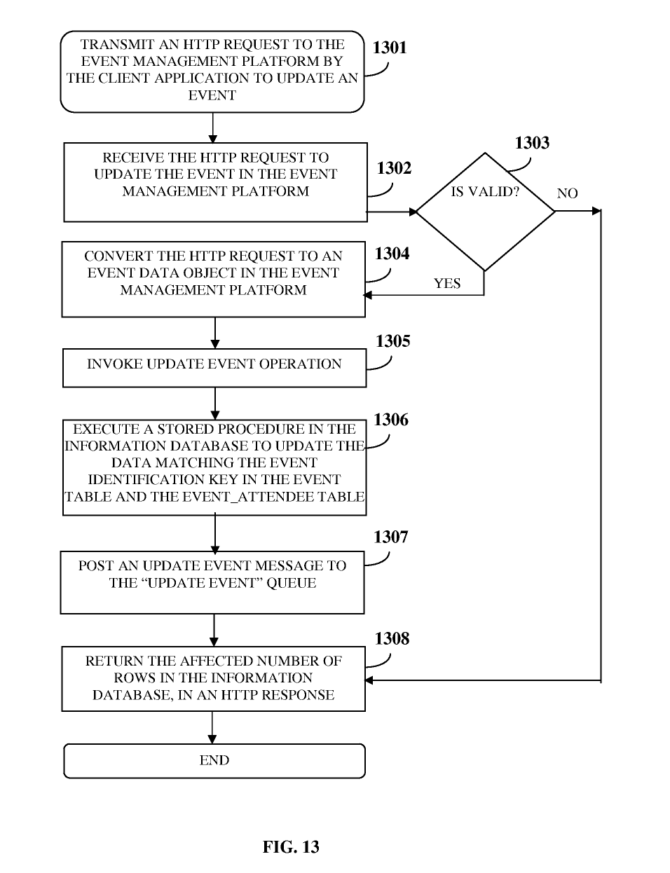

FIG. 13 exemplarily illustrates a flowchart comprising the steps for updating an event by the event management platform. The client application transmits 1301a hypertext transfer protocol (HTTP) request to the event management platform to update an event. The event management platform receives 1302 the HTTP request message with a JavaScript Object Notation (JSON) object in the body of the HTTP request message to update the event from the client application via the network, for example, in a web services application programming interface (API). The event management platform checks 1303 the validity of the request message. If the request message is not valid, the event management platform returns the affected number of rows in the information database as zero in an HTTP response. If the request message is valid, the event management platform converts 1304 the JSON object in the body of the HTTP request message to the format of an event data object defined by the event management platform. The event management platform invokes 1305 an update event operation and executes 1306 a procedure stored in the information database to update the data, that is, the event information in the event table and the event_attendee table in the information database in the rows that match the event identification key. The event management platform posts 1307 an update event text message as a JSON data object to an “update event” queue in the message database, which comprises the old and updated JSON objects, for updating the event, for example, in the third party calendar applications. The event management platform returns 1308 the affected number of rows in the information database of the event management platform in an HTTP response message to the client application via the network and ends the process.

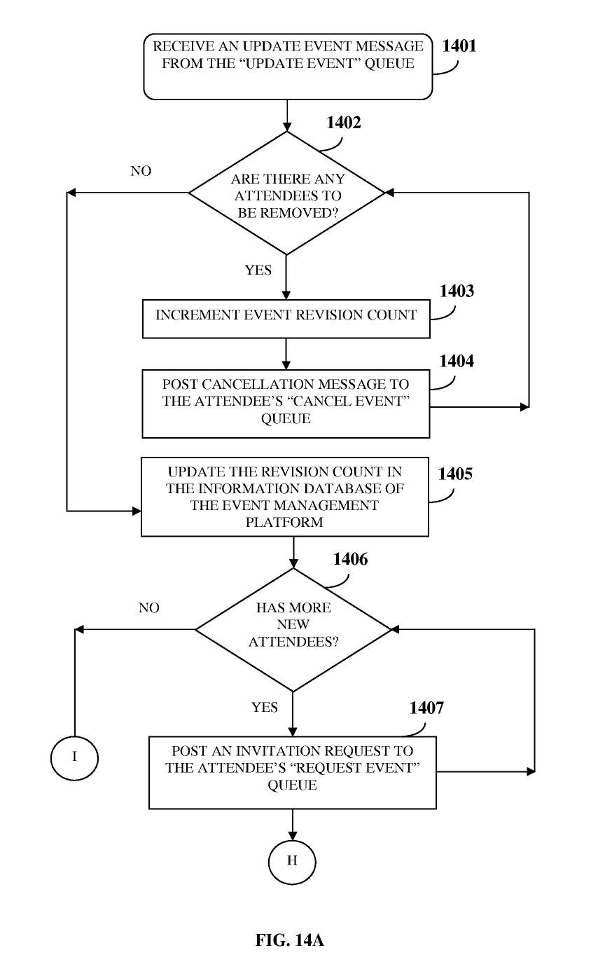

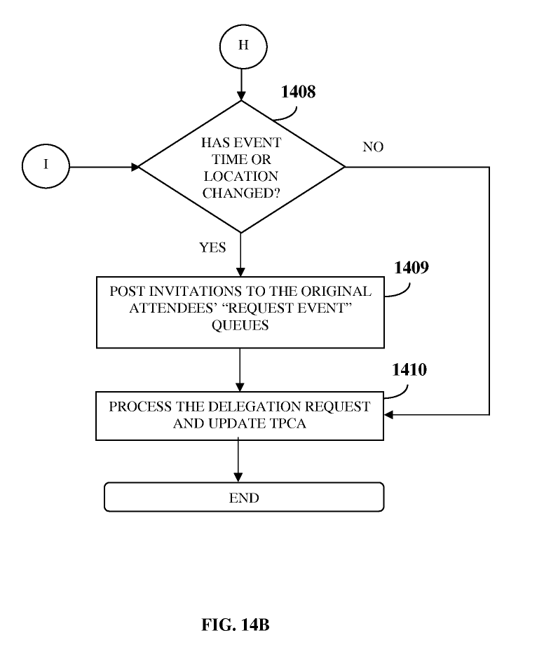

FIGS. 14A-14B exemplarily illustrate a flowchart comprising the steps for automatically updating an event in each of the third party calendar applications of a user by the event management platform. The event management platform receives 1401 an update event text message from the “update event” queue and converts the old and new JavaScript Object Notation (JSON) objects to corresponding old and new event data objects defined by the event management platform. The “update event” queue in the event management platform stores the events that need to be updated by the event management platform across the third party calendar applications of each of the users in the group. The event management platform determines 1402 from the event information whether there are any attendees who are not listed in the updated event information and consequently need to be removed from the information database. That is, the event management platform checks whether a particular attendee associated previously with the event has also been listed in the new event data object. If the current attendee is to be removed from the event, the event management platform increments 1403 the event revision count and posts 1404 a cancellation message to the attendee's “cancel event” queue and continues with the next attendee to check whether the next attendee is to be removed. If there are no more attendees to be removed, the event management platform updates 1405 the revision count in the information database of the event management platform.

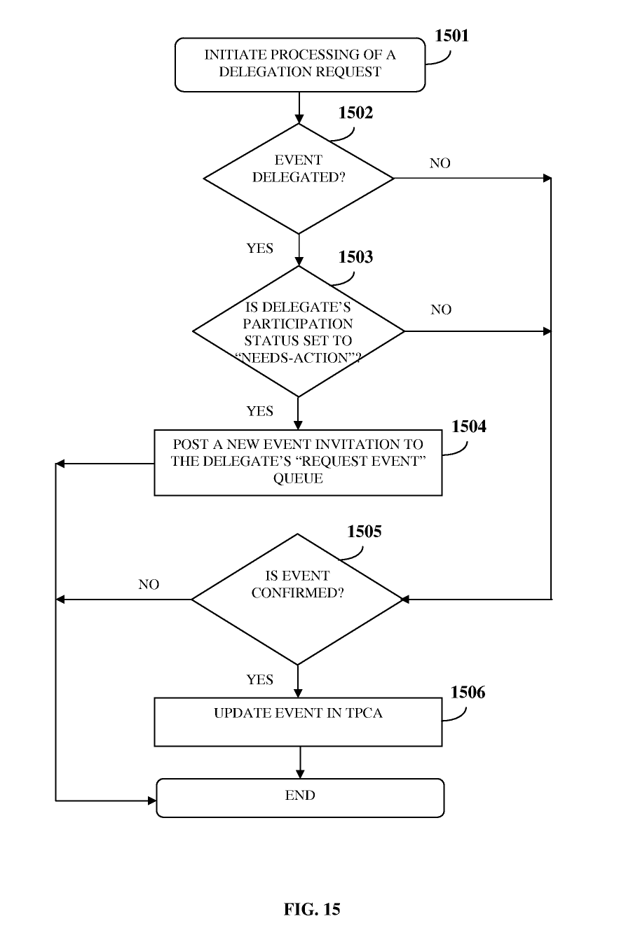

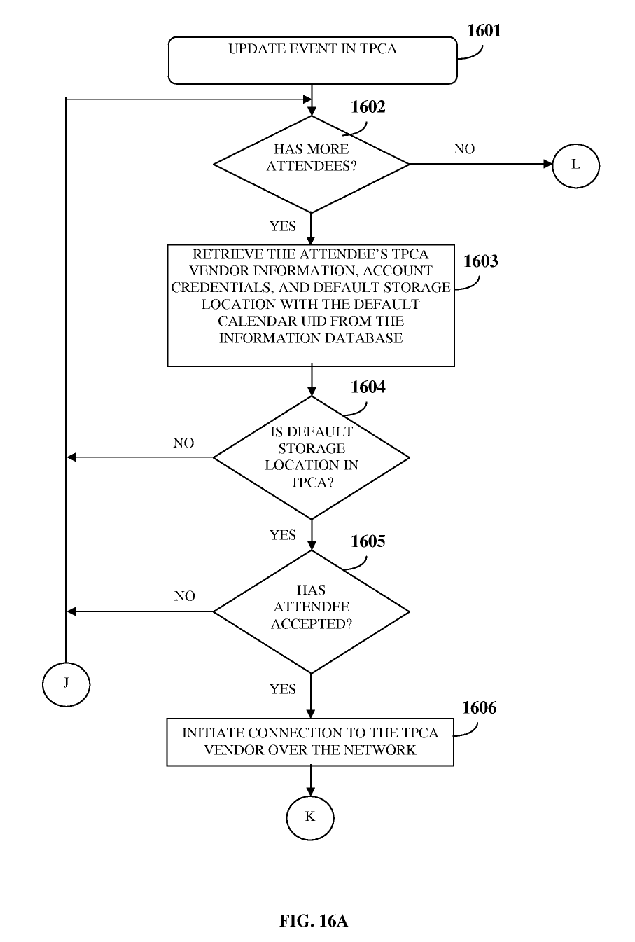

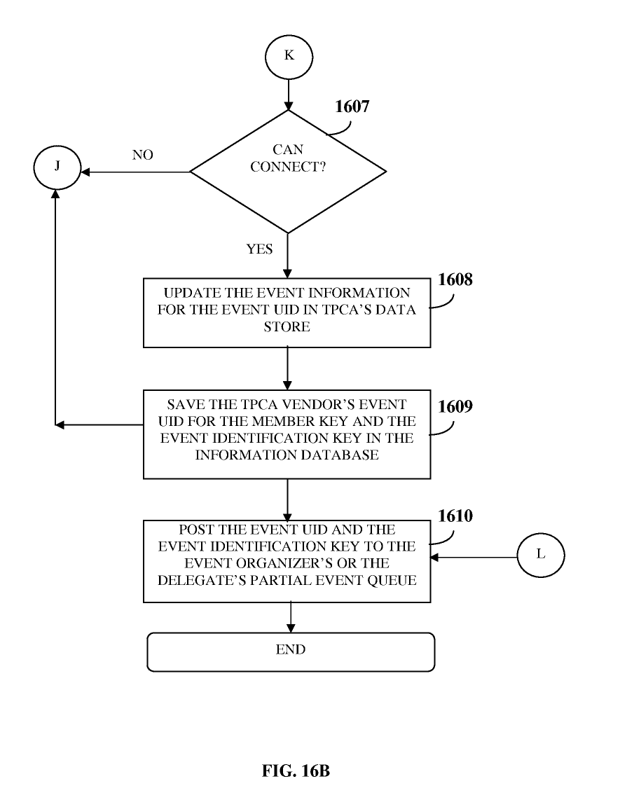

The event management platform determines 1406 whether there are any more attendees to be added to the information database by checking whether an attendee listed in the new event data object corresponding to the updated event information was also a part of the old event data object. If there are any more attendees to be added, the event management platform posts 1407 a new event request message, that is, an invitation request as a JSON object to the attendee's “request event” queue and continues with the next attendee to check whether the next attendee is to be added. If there are no more attendees to be added to the information database of the event management platform, the event management platform determines 1408 whether a time or a location of the event has changed, by comparing the start time, the end time, and the location in the old event data object with the new event data object. If the time or the location of the event has changed, the event management platform posts 1409 invitations or update request messages as separate invitation requests to the original attendees' “request event” queues and then proceeds to process delegation requests for delegation of the event. If the time or the location of the event has not changed, the event management platform directly processes 1410 the delegation requests for delegating the updated event to the particular attendee and automatically updates the events in the associated third party calendar applications of each of the attendees using the updated event information as disclosed in the detailed description of FIG. 15 and FIGS. 16A-16B.

FIG. 15 exemplarily illustrates a flowchart comprising the steps for processing a request for delegation during updating of an event in a third party calendar application. The event management platform initiates processing 1501 of a delegation request for delegation of an event. The event management platform determines 1502 whether an event was delegated to a particular user, herein referred to as a “delegate”. If the event was delegated to a delegate, the event management platform determines 1503 whether the delegate's participation status is set to “Needs Action”. If the delegate's participation status is set to “Needs Action”, the event management platform posts 1504 a new event request message, that is, an invitation message to the delegate's “request event” queue and ends the process. If the delegate's participation status is not set to “Needs Action” indicating that the delegate has replied to the event or if the event was not delegated to a delegate, the event management platform determines 1505 whether the event is confirmed by checking the status of the event in the information database of the event management platform. If the event has not been confirmed, the event management platform ends the process. If the event has been confirmed, the event management platform automatically updates 1506 the event in the third party calendar application (TPCA) as disclosed in the detailed description of FIGS. 16A-16B.

FIGS. 16A-16B exemplarily illustrate automatic updating of an event by the event management platform in each of the third party calendar applications of one or more users in a group. In order to automatically update 1601 the event in the third party calendar application, the event management platform determines 1602 whether the event has more attendees associated with the event. If the event has any more attendees, the event management platform retrieves 1603 each of the attendees' third party calendar application (TPCA) vendor information, account credentials, and details on the default storage location for storing events, for example, a default calendar unique identifier (UID) identifying a particular default calendar, from the information database of the event management platform. The event management platform determines 1604 whether the user's default storage location for storing events is in a third party calendar application. If the attendee's default storage location is not in the third party calendar application, the event management platform proceeds to the next attendee. If the attendee's default storage location is in the third party calendar application, the event management platform determines 1605 whether the attendee has accepted the update event request message for updating the event. If the attendee has not accepted the update event request message for updating the event, the event management platform proceeds to the next attendee. If the attendee has accepted the event update request message, the event management platform initiates 1606 connection to the third party calendar application over the network using the attendee's account credentials. The event management platform determines 1607 whether a connection can be established to the third party calendar application using the attendee's account credentials. If the connection cannot be established for the particular attendee, the event management platform resumes check 1602 for more attendees. If the connection can be established, the event management platform automatically updates 1608 the event information for the event identifier in the data store of the third party calendar application. The event management platform saves 1609 the unique event identifier associated with the vendor of the third party calendar application for the member key and the event identification key in the information database of the event management platform and proceeds to the next attendee. If there are no more attendees associated with the event, the event management platform posts 1610 partial event details, for example, the event identifier and the event identification key as a JavaScript Object Notation (JSON) object to the event organizer's or the delegate's “partial event” queue. The event management platform then ends the process.

FIG. 17 exemplarily illustrates a flowchart comprising the steps for retrieving events for a user within a date range by the client application in communication with the event management platform via the network. The client application on the user's computing device transmits 1701a hypertext transfer protocol (HTTP) request message to the event management platform to retrieve all events within a date range defined by a start date and an end date for a user, with a JavaScript Object Notation (JSON) object query in the body of the HTTP request message. The event management platform transmits an HTTP response as a JSON object array of events, that is, an array of JSON objects with each JSON object representing a particular event, to the client application via the network. The client application prepares a “user events” array for storing the events received within the date range from the event management platform. The client application converts 1702 the HTTP response to the “user events” array. As used herein, the term “user event” refers to an event associated with a user, herein referred to as “first user”, who is currently logged into the client application. The user events comprise events that have been organized by the first user, events delegated to the first user, or events for which the first user has been invited. The client application retrieves 1703 the user events within the defined date range for each calendar in the native local data store (NLDS) associated with the client application on the computing device as disclosed in the detailed description of FIG. 18. The client application then converts the events retrieved from the native local data store to the format of the events retrieved from the event management platform, for example, in the format of the event data objects defined by the event management platform, for display and transmission to the event management platform. The client application ensures that the events retrieved from the native local data store are compatible with the format of the event data objects maintained in the event management platform. The client application adds 1704 the converted events retrieved from the native local data store to the “user events” array. The client application sorts 1705 the user event array based on predetermined sorting criteria, for example, according to an event start date. The client application adds 1706 the “user events” array to the local data store within the client application. The client application then ends the process.

FIG. 18 exemplarily illustrates a flowchart comprising the steps for retrieving user events within the native local data store by the client application. The client application retrieves 1801 the user events represented by event data objects for each calendar in the native local data store (NLDS) within the date range defined by the user. The client application first retrieves 1802 an array of users events, herein referred to as a “user events” array comprising events associated with the user of the client application, from the information database of the event management platform. The user events are in the form of event data objects defined by the event management platform. The client application then creates 1803 an empty array for storing events from the native local data store that have been converted to user events. The client application saves 1804 the events retrieved from the native local data store in an array, referred to as the “native local data store” array. The client application then sequentially extracts events from the “native local data store” array for processing and determines 1805 whether there are any more events in the “native local data store” array. If there are more events in the “native local data store” array, the client application determines 1806 whether the current event from the “native local data store” array is in the “user events” array. If the current event from the “native local data store” array is not in the “user events” array, the client application converts 1807 the event in the native local data store to a format of the user event in the client application, for example, as an event data object in the client application. The client application collects the event attributes constituting the event, for example, the title, start time and end time of the event, event status, etc., and converts the collected event attributes to an event data object consistent with the format of the event data object of the event management platform. The client application adds 1808 this event to an array of converted native local data store events and returns to the next event in the “native local data store” array. If there are no more events in the “native local data store” array, the client application returns 1809 the converted native local data store events array for further processing and ends the process.

FIGS. 19A-19B exemplarily illustrate a flowchart comprising the steps for retrieving group events from the event management platform by the client application via the network. As used herein, the term “group events” refers to events associated with the other users of a group, herein referred to as “second users”, of which the user currently logged into the client application and referred to as a “first user” is a member. The group events comprise events that have been organized by any of the second users, or delegated to any of the second users, or for which the second users have been invited. Therefore, in an example, a user event is also a group event when the first user is part of an event organized by one or more second users. Furthermore, a user owns a particular event if the user has organized the event or has accepted a request for delegation of the event. The client application transmits 1901a hypertext transfer protocol (HTTP) request message to the event management platform via the network to retrieve events for the user's group and the user within a date range from the event management platform. The client application receives an HTTP response from the event management platform via the network and converts 1902 the HTTP response to a joint user and group events array in the client application, herein referred to as a “joint events” array. The client application creates 1903 separate empty arrays for the user events herein referred to as the “user events” array and for the group events, herein referred to as the “group events” array. The client application selects each event from the “joint events” array for processing and determines 1904 whether there are any more joint events. If there are more events in the “joint events” array, the client application determines 1905 whether the event is a user event. If the event is a user event, the client application adds 1907 the event to the “user events” array and proceeds to the next event in the “joint events” array. If the event is not a user event, that is, if the event is a group event, the client application adds 1906 the event to the “group events” array and proceeds to the next event in the “joint events” array.

If there are no more joint events, the client application retrieves 1908 the user events from each calendar in the native local data store that are within the defined date range. The client application determines whether any of the user events in the native local data store has already been added to the “user events” array, to avoid duplication. The client application adds 1909 the events of the native local data store that are not duplicated and that have been converted to the format of the user events, to the “user events” array. The client application then retrieves 1910 free-busy events for the users in the user's group within the date range as disclosed in the detailed description of FIGS. 20A-20B. The free-busy events comprise all the events where a user is busy. The free-busy events are retrieved from a busy_time table in the information database of the event management platform. In an embodiment, the client application retrieves private events for the users in the user's group within the date range from the busy_time table. The private event is stored in the native local data store but is notified to the event management platform with only the user's member identifier and the start time and end time of the event. The private events and the free-busy events are defined for busy time periods only. The client application adds 1911 the free-busy events of the other users to the “group events” array. In an example, when the start time and the end time for a private event of a user in a group coincides with the start time and end time for a group event, the client application is configured to display both the private event and the group event or to selectively display either the private event or the group event. The client application sorts 1912 the “user events” array and the “group events” array based on predetermined sorting criteria, for example, according to the start date. The client application adds 1913 the “user events” array and the “group events” array to the local data store for viewing of all events associated with the group by the user. The client application then ends the process.

FIGS. 20A-20B exemplarily illustrate a flowchart comprising the steps for retrieving the private events of a group of users within a predetermined date range. In order to retrieve 2001 the private events for a group within a predetermined date range, the client application transmits 2002 a hypertext transfer protocol (HTTP) request message to the event management platform via the network. The client application converts 2003 the HTTP response received from the event management platform to a dictionary of busy time periods for each member in the group, with the member identifier (ID) as the key and an array of time periods as the value. The member ID for identifying individual members of the user's group and the array of time periods are generated by the event management platform. The client application creates 2004 an empty array of free-busy events for the users in the group. The client application determines 2005 whether there are any more members in the dictionary. Each member is referenced by the member ID. If there are more members in the dictionary, the client application determines 2006 whether there are any more busy time periods for the current member. If there are no more busy time periods, the client application proceeds to the next member in the dictionary. If there are more busy time periods, the client application converts 2008 each busy time period to a private event with the title “Private”. The client application adds 2009 the private event to the array of free-busy events for the group and proceeds to the next member in the dictionary. If there are no more members in the dictionary, the client application returns 2007 the array of free-busy events for the group. The client application formats the private events for displaying the busy time periods of each of the individual members on the graphical user interface of the client application, to the user. The client application then ends the process.

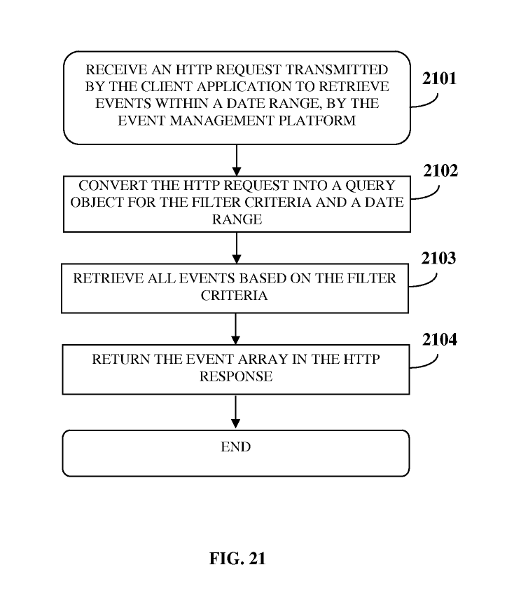

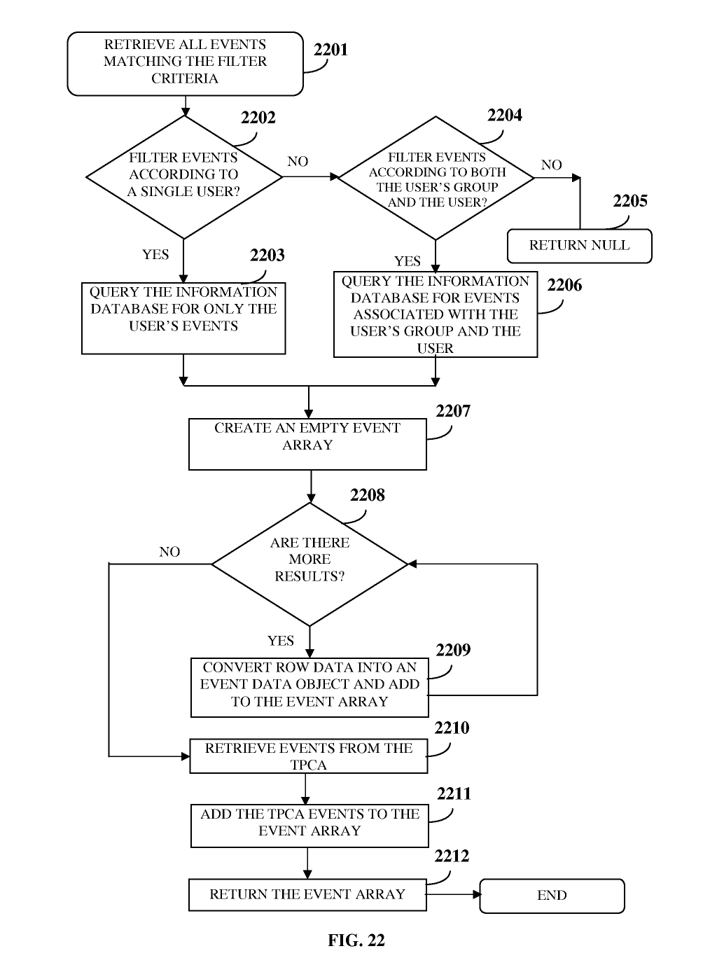

FIG. 21 exemplarily illustrates a flowchart comprising the steps for retrieving events based on filter criteria, for example, a particular date range from the event management platform. As disclosed in the detailed description of FIGS. 19A-19B, the client application transmits a hypertext transfer protocol (HTTP) request message to retrieve events within a particular date range to the event management platform. The event management platform receives 2101 the HTTP request, for example, via a web services API and converts 2102 the HTTP request message into a query object, where the query is defined for filter criteria for retrieving events based on a particular requirement, and a date range. The filter criteria define the scope of retrieval of events from the information database of the event management platform. An example of the filter criteria is the number of users associated with the event. That is, the event management platform determines whether the events are to be filtered according to a particular user associated with the event or a group of users associated with the event. The event management platform retrieves 2103 all events matching the query based on the filter criteria as disclosed in the detailed description of FIG. 22. The event management platform collects all the events matching the query in an array and returns 2104 the event array as a JavaScript Object Notation (JSON) object in a HTTP response message to the client application.

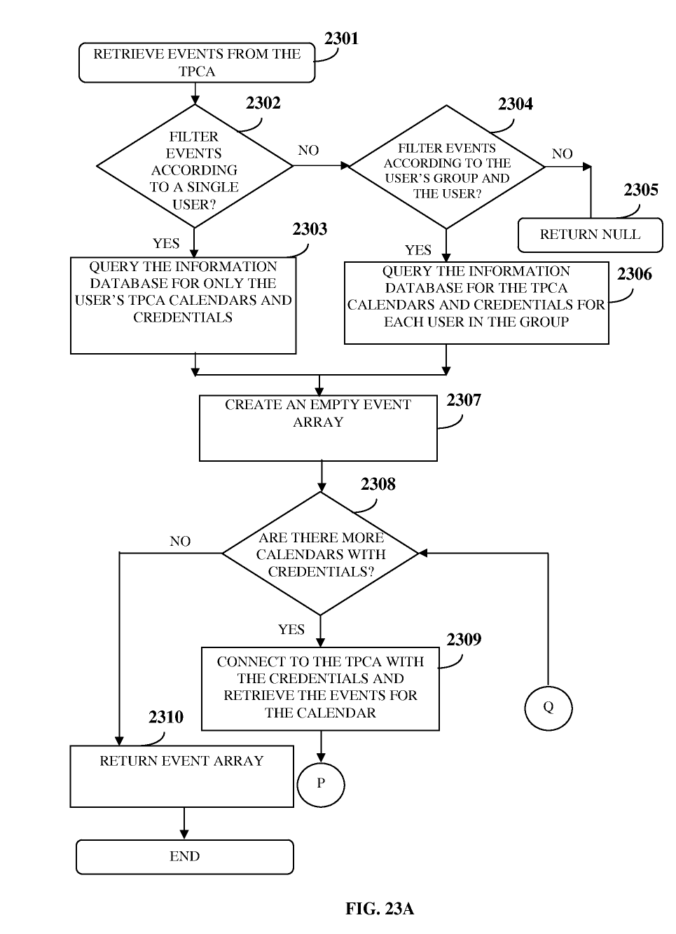

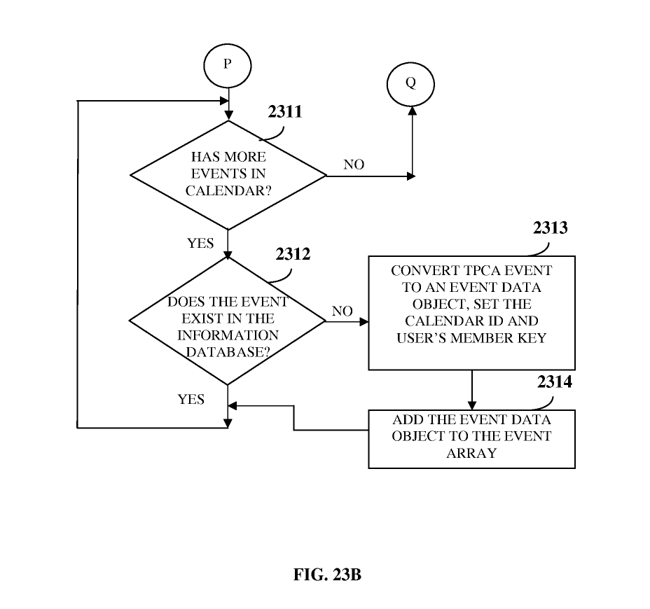

FIG. 22 exemplarily illustrates a flowchart comprising the steps for retrieving events matching filter criteria defined by a user. In order to retrieve 2201 all the events matching the filter criteria, the event management platform determines 2202 from the filter criteria whether the events need to be filtered according to a single user registered with the event management platform. If the event management platform needs to retrieve events for only a single user, the event management platform queries 2203 the information database of the event management platform for only the user's events. If the event management platform determines that the events need to be retrieved for not only a single user, the event management platform confirms 2204 that the events need to be filtered according to both the user's group and the individual user. If the events are not to be filtered according to both the user's group and the individual user, the event management platform returns 2205 null indicating an invalid condition. If the events are to be filtered according to both the user's group and the individual user, the event management platform queries 2206 the information database for events that are associated with the user's group and the user. The event management platform then creates 2207 an empty event array to store all the events collected from the results of the query. The event management platform determines 2208 whether there are any more query results. If there are more query results, for each of the events fetched from the query results, the event management platform converts 2209 the row data comprising the event attributes associated with the event identification key, in the event table and event_attendee table, into an event data object of the event management platform, adds the event data object to the event array, and then proceeds to check for the next query result. If there are no more query results returned by the information database of the event management platform, the event management platform retrieves 2210 events for the query from the data stores of the third party calendar applications as disclosed in the detailed description of FIGS. 23A-23B. The event management platform adds 2211 the converted events of the third party calendar applications to the event array. The event management platform returns 2212 the complete event array which is used for generating the hypertext transfer protocol (HTTP) response message for the client application.

FIGS. 23A-23B exemplarily illustrate a flowchart comprising the steps for retrieving events from the third party calendar applications by the event management platform. In order to retrieve 2301 events from the third party calendar applications, the event management platform determines 2302 whether the events need to be filtered according to a single user of the event management platform. If the events need to be filtered according to a single user, the event management platform queries 2303 the information database of the event management platform for only the calendar identifiers and account credentials of the particular user's third party calendar applications. If the events do not need to be filtered according to a single user, the event management platform determines 2304 whether the events need to be filtered according to both the user's group and the user. If the events need to be filtered according to both the user's group and the user, the event management platform proceeds to query 2306 the information database for the calendar identifiers and account credentials for the third party calendar applications of each user in the group, inclusive of the user; otherwise, the event management platform returns 2305 a null message. The event management platform then creates 2307 an empty event array to store the converted third party calendar application events. The event management platform sequentially selects each of the particular calendar identifiers indicating the storage locations, that is, the calendars where the events for the user are stored. The event management platform determines 2308, based on the mapping between the calendar identifiers and the third party calendar application vendor information, whether there are any more calendars storing the events of the users, that are associated with the data stores of the third party calendar application, that is, which have third party calendar application credentials. If there are no more calendars associated with the third party calendar applications, the event management platform returns 2310 the event array. If there are more calendars associated with third party calendar applications, the event management platform connects 2309 to the third party calendar applications over the network using the account credentials and retrieves the events for the current calendar identifier.

The event management platform determines 2311 whether there are any more events in the calendar identified by the particular calendar identifier. If there are any more events, the event management platform determines 2312 whether the event already exists in the information database of the event management platform by searching the event array. If the event already exists in the information database of the event management platform, the event management platform skips the addition of the event retrieved from the third party calendar application to avoid duplication, and returns to determine 2311 the next event. If the event does not exist in the information database, the event management platform converts 2313 the event information of the event retrieved from the third party calendar application to an event data object, and sets the calendar identifier and the user's member key in the event data object. The event management platform adds 2314 the event data object to the event array and returns to the next event to be checked. If there are no more calendars with credentials, the event management platform returns 2310 the event array of the converted events of the third party calendar application. The event management platform then ends the process.

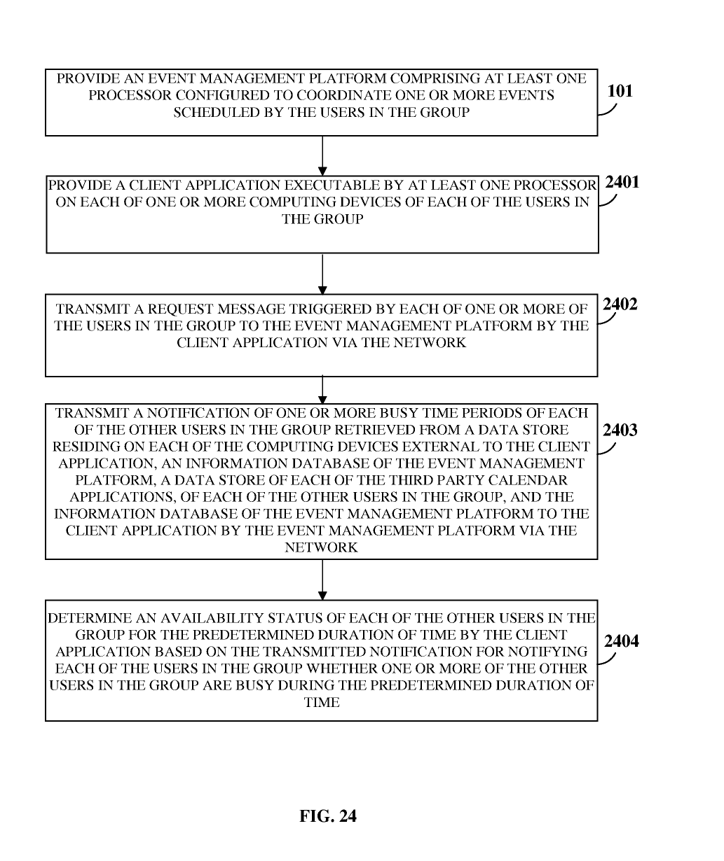

FIG. 24 exemplarily illustrates a computer implemented method for notifying availability of each of multiple users in a group. The computer implemented method disclosed herein provides 101 the event management platform as disclosed in the detailed description of FIG. 1. The computer implemented method disclosed herein provides 2401 the client application executable by at least one processor on each of one or more computing devices of each of the users in the group. The client application communicates with the event management platform via a network. The client application of each of the users in the group transmits 2402 a request message triggered by each of one or more the users in the group to the event management platform via the network. The request message defines a predetermined duration of time to determine availability of each of the other users in the group. For example, the request message defines a start date and a start time, and an end date and an end time, within which the events of the other users in the group are retrieved.

The event management platform transmits 2403 a notification of one or more busy time periods of each of the other users in the group retrieved from a data store residing on each of the one computing devices external to the client application, that is, the native local data store of each of the other users in the group, a data store of each of the third party calendar applications of each of the other users in the group associated with the events, and/or the information database of the event management platform, to the client application of each of the users in the group via the network. Each of the busy time periods is a time period between a start time and an end time of each of the events associated with each of the users in the group.

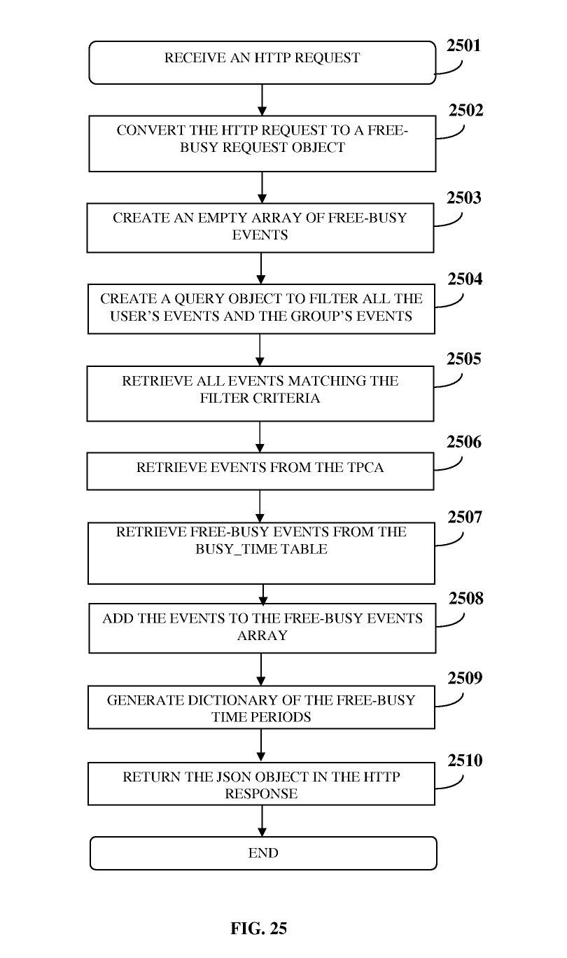

The client application of each of the users in the group determines 2404 an availability status of each of the other users in the group for the predetermined duration of time based on the transmitted notification of the busy time periods, for notifying each of the users in the group whether one or more of the other users in the group are busy during the predetermined duration of time. Therefore, the users of the client application are aware when the other users in the group are busy based on the availability of the events associated with each of the users in multiple native local data stores, data stores of third party calendar applications, and the information database of the event management platform. The retrieval of the events for notifying the availability of the users in the group is disclosed in the detailed description of FIG. 25.

The computer implemented method disclosed herein combines multiple calendars from multiple calendar vendors for multiple users in a group via the event management platform. That is, the event management platform provides a unified platform for an integrated calendaring system. Consider an example, where a user has multiple calendars, as part of the iCal® application of Apple®, Inc., Microsoft® Office Outlook™ Calendar of Microsoft Corporation, and Google Calendar of Google, Inc. Consider another user who uses the iCal® application, the Yahoo!® Calendar of Yahoo, Inc., and Google Calendar of Google, Inc. Both the users can see each other's events and availability from their combined calendars. Furthermore, each user can use multiple calendars mapped to a single calendar vendor in their data stores. Furthermore, users can delegate responsibility to each other for organizing the events.

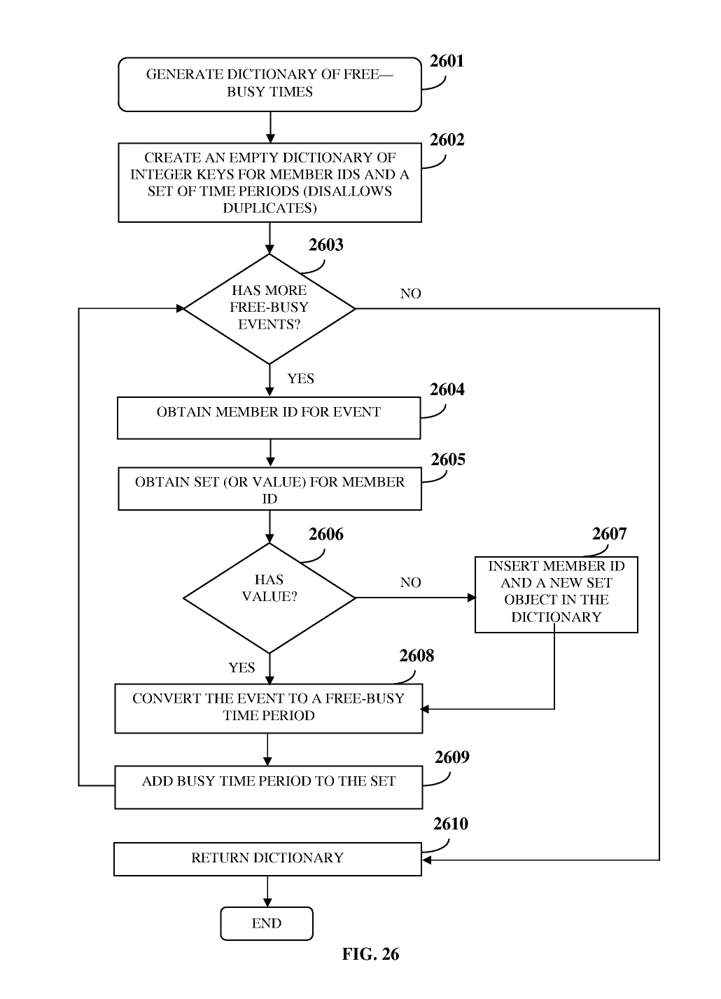

FIG. 25 exemplarily illustrates a flowchart comprising the steps for retrieving free-busy events of the users in a group from the event management platform. The event management platform receives 2501a hypertext transfer protocol (HTTP) request message from the client application for free-busy data for the users of the group. The event management platform converts 2502 the HTTP request to a free-busy request object. The event management platform creates 2503 an empty array for free-busy events, where the free-busy events are associated with all the busy time periods of the users. The busy time periods comprises all the busy times published, for example, from their native local data stores, the busy_time table in the information database, events in the information database, events in their respective third party calendar applications, etc. The event management platform creates 2504 a query object to filter the user's events and the events in the user's group from the information database as disclosed in the detailed description of FIG. 22. The event management platform retrieves 2505 all the events matching the filter criteria. The event management platform retrieves 2506 the events from the data stores of the third party calendar applications, as disclosed in the detailed description of FIGS. 23A-23B. The event management platform retrieves 2507 the free-busy events from the busy_time table of the information database. In an embodiment, the event management platform generates private events for the group by retrieving the busy time periods of each of the users stored in the busy_time table of the information database, and converting these busy time periods in the row data into private events for each user. The busy_time table is a database entity in the information database of the event management platform that stores the busy time periods of each of the individual members of the group. The event management platform adds 2508 all the events retrieved as part of the steps 2505, 2506, and 2507 to the free-busy events array. The event management platform passes the free-busy events array as input to generate 2509 a dictionary of free-busy time periods for each user, herein referred to as a “member” of the group, as disclosed in the detailed description of FIG. 26. The event management platform creates a free-busy reply JavaScript Object Notation (JSON) object from the dictionary, and returns 2510 the free-busy reply JSON object in the HTTP response to be transmitted to the client application via the network. The transmission of only the free-busy time periods instead of the complete event information in this example improves the performance of the unified virtual group calendar system by reducing the bandwidth required for transmission.

FIG. 26 exemplarily illustrates a flowchart comprising the steps for generating a dictionary of free-busy times of each of the users in the group by the event management platform. In order to generate 2601a dictionary of free-busy times for each member in the group, the event management platform first creates 2602 an empty dictionary of integer keys for the member IDs and a set of time periods for each member. The set of time periods is in the form of a data structure that disallows duplicates. The event management platform determines 2603 whether there are any more free-busy events in the free-busy events array. If there are more free-busy events in the free-busy events array, the event management platform obtains 2604 the member ID for the current event. The event management platform then obtains 2605 the data structure comprising the set of time periods for the particular member ID. The event management platform determines 2606 whether the set of time periods has a value, that is, not equal to null. If the set of time periods is equal to null, the event management platform inserts 2607 the member ID and new set object comprising the set of time periods in the dictionary and proceeds to the next step. If the set of time periods is not equal to null, the event management platform converts 2608 the event retrieved from the free-busy events array to a busy time period identified by a start time and an end time. The event management platform adds 2609 this busy time period to the set of time periods associated with the particular member ID and continues to check the next event in the free-busy events array. If there are no more events in the free-busy events array, the event management platform returns 2610 the dictionary.

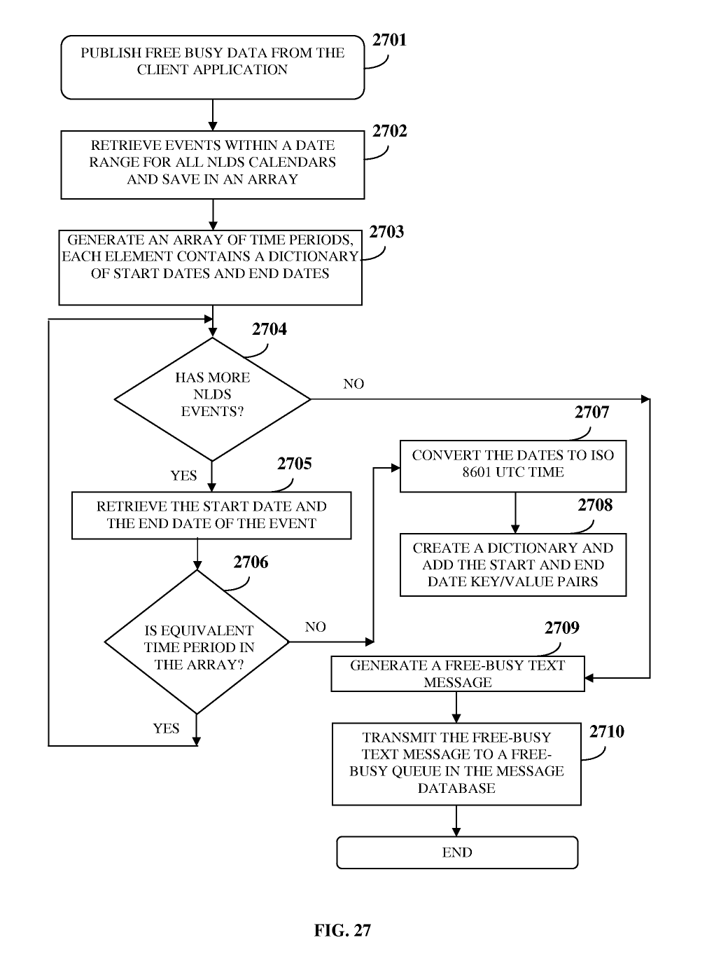

FIG. 27 exemplarily illustrates a flowchart comprising the steps for publishing free-busy data by the client application. The client application publishes 2701 free-busy data based on inputs acquired from the user via a graphical user interface (GUI) of the client application. The free-busy data corresponds to the user's busy time-periods in the native local data store (NLDS) associated with the client application. The client application retrieves 2702 all events within a predetermined date range from all the calendars in the native local data store and saves the retrieved events in an array. The client application generates 2703 an array of time periods where each element of the array contains a dictionary of start dates and end dates. The client application determines 2704 whether there are more events in the native local data store. If there are any more events in the native local data store, the client application retrieves 2705 each event in the native local data store and obtains the start date and end date of the event.

The client application determines 2706 whether an equivalent time period exists in the array, that is, a time period corresponding to an event in the native local data store, defined by a start time and end time matching an event in the array. If there is an equivalent time period in the array, the client application continues to check for the next event in the native local data store. If there is no equivalent time period in the array, the event management platform converts 2707 the start date and end date to a format defined by the international organization for standardization (ISO) 8601 Coordinated Universal Time (UTC). The client application then creates 2708 a dictionary, adds the start date and end date key/value pairs, and proceeds to checking the next event in the native local data store. The key is, for example, the label “start date”, and the value is, for example, the actual value of the start date. For example, consider the following pseudocode: start=<ISO 8601 time>, end=<ISO 8601 time>. In the JavaScript Object Notation (JSON) object that describes the dictionary, this translates to a key-value mapping as:

{

“start”: “20120414T12:00:00”,
“end”: “201204/14T13:00:00”

}

If there are no more NLDS events, the client application then generates 2709 a “free-busy” text message comprising the user's member ID and the associated dictionaries for each of the users, and transmits 2710 the free-busy text message to the free-busy queue in the message database of the event management platform.

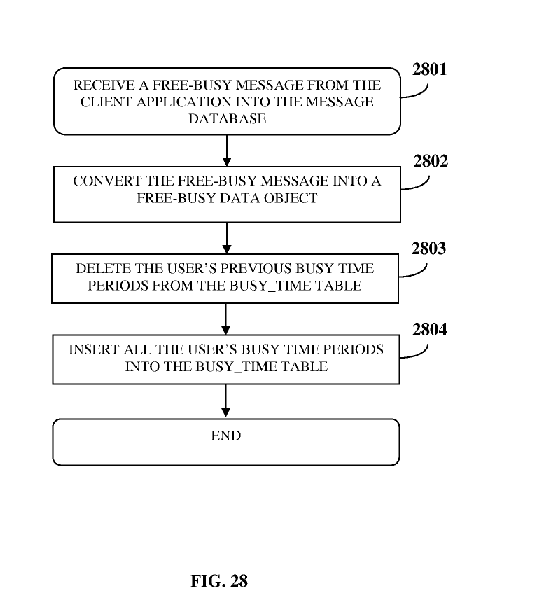

FIG. 28 exemplarily illustrates a flowchart comprising the steps for storing free-busy data in the event management platform. The event management platform receives 2801a free-busy message into the message database from the client application. The event management platform converts 2802 the free-busy text message to a free-busy object. The event management platform uses the member ID of the user to delete 2803 the user's previous busy time periods from the busy_time table of the information database. The event management platform inserts 2804 all the user's busy time periods into the busy_time table.

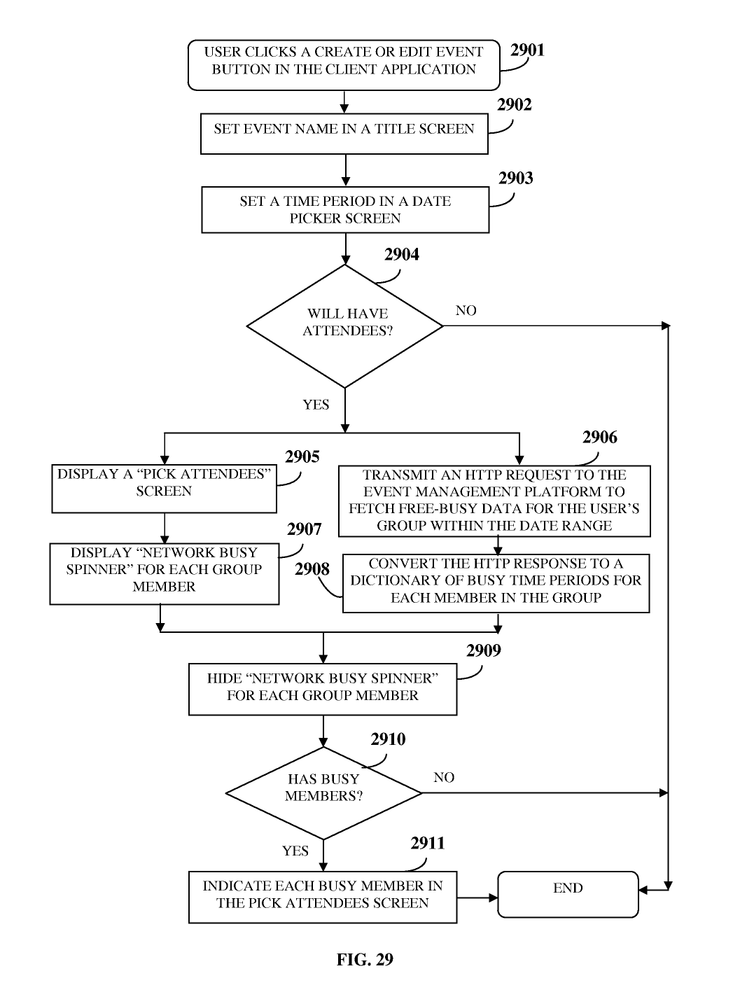

FIG. 29 exemplarily illustrates a flowchart comprising the steps for displaying the availability of a user in a group during creation of an event or updating of an event in the client application. A user clicks 2901a create or edit event button on the graphical user interface of the client application. The graphical user interface (GUI) of the client application provides a “title screen” for the user to set 2902 the event name. The GUI then provides a “date picker” screen that enables the user to set 2903 the time period for the event, that is, the start time and end time of the event. The GUI then prompts the user to notify 2904 whether the event has attendees. If the event has no attendees, the client application ends the process. If the event has attendees, the client application displays 2905 a “Pick Attendees” screen as exemplarily illustrated in FIG. 30A. The client application displays 2907 the “network busy” spinner for each member of the group as exemplarily illustrated in FIG. 30A. Furthermore, in time synchronization with the display of the “Pick Attendees” screen, the client application transmits 2906 a hypertext transfer protocol (HTTP) request message to the event management platform to fetch the free-busy data for the members of the user's group within date range, that is, the start time and end time of the event. The client application converts 2908 the HTTP response from the event management platform to a dictionary of busy time periods for each member in the group. The client application then hides 2909 the “network busy” spinner for each group member. The client application determines 2910 whether any of the group members are busy. If none of the group members are busy, the client application ends the process. If at least one of the group members is busy, the client application indicates 2911 each busy member in the “Pick Attendees” screen as exemplarily illustrated in FIG. 30B.

FIGS. 30A-30B exemplarily illustrate screenshots of a graphical user interface (GUI) provided by the client application on a computing device of a user for displaying the availability of the users in a group for an event. Consider an example of a user who wants to create a group event for which the user needs to know the availability of the other group members, “Jane Doe”, “Jill Doe”, and “Jack Doe” for the event. As exemplarily illustrated in FIG. 30A, the user clicks on the DONE button provided in the “Pick Attendees” screen to initiate the retrieval of the free-busy data for each of the group members. The client application invokes a “network busy” spinner to indicate to the user that the retrieval of free-busy data is ongoing. FIG. 30B exemplarily illustrates a screenshot of the GUI indicating to the user that Jane Doe is busy. The “network busy spinner” is hidden for all the users on completion of the retrieval of the free-busy data from the event management platform by the client application via the network.

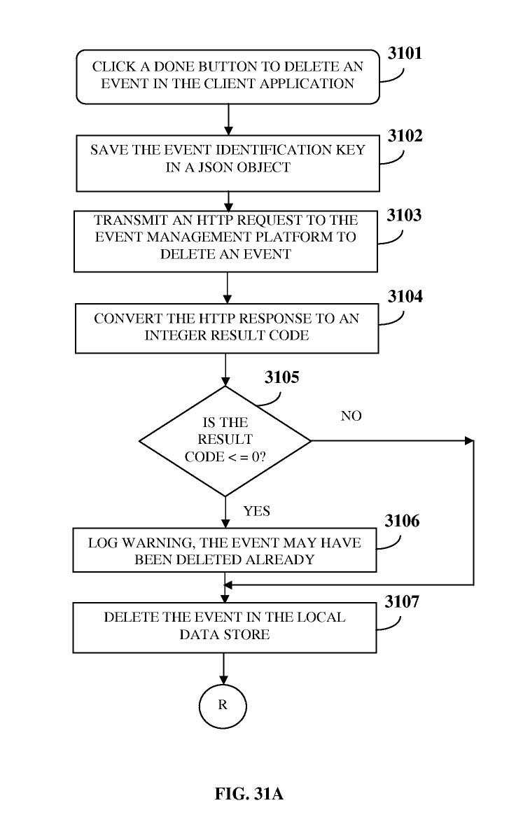

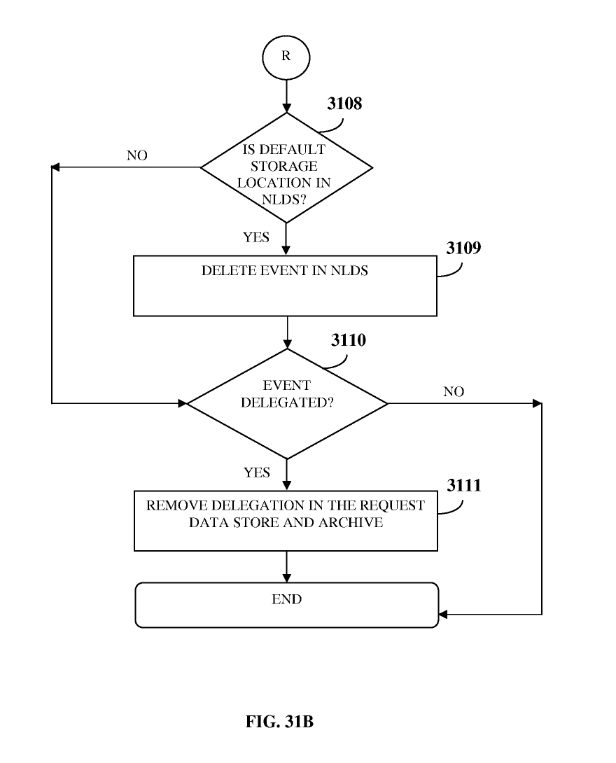

FIGS. 31A-31B exemplarily illustrate a flowchart comprising the steps for triggering deletion of an event by the client application. A user clicks 3101 on the “done” button to delete an event in the graphical user interface (GUI) provided by the client application. The client application saves 3102 the event identification key in a JavaScript Object Notation (JSON) object, for example, as {“eventKey”:1}. The client application transmits 3103 a hypertext transfer protocol (HTTP) request message to the event management platform via the network to delete an event, with the JSON object in the body of the HTTP request message. The client application receives an HTTP response message enclosing a JSON object with the number of rows affected in the information database, for example, {“result”:1} from the event management platform via the network. The client application converts 3104 the HTTP response to an integer result code. The client application determines 3105 whether the result code is lesser than or equal to 0. If the result code is lesser than or equal to 0, the client application logs 3106 a warning that the event may have been deleted already and then proceeds to delete 3107 the event in the local data store of the client application. If the result code is greater than 0, the client application directly deletes 3107 the event in the local data store. The client application then determines 3108 whether the user's default storage location, for example, a default calendar for storing the events is in the native local data store (NLDS). If the user's default storage location is in the native local data store, the client application deletes 3109 the event matching the event identifier in the native local data store and proceeds to determine 3110 whether the event was delegated to the user. If the user's default storage location for storing events is not in the native local data store, the client application proceeds to determine 3110 whether the event was delegated to the user. If the event was delegated to the user, the client application removes 3111 the delegation request corresponding to the event identification key from the request data store and archives the request data store, that is, stores the request data store to a persistent file or a persistent database. If the event is not delegated, the client application ends the process.

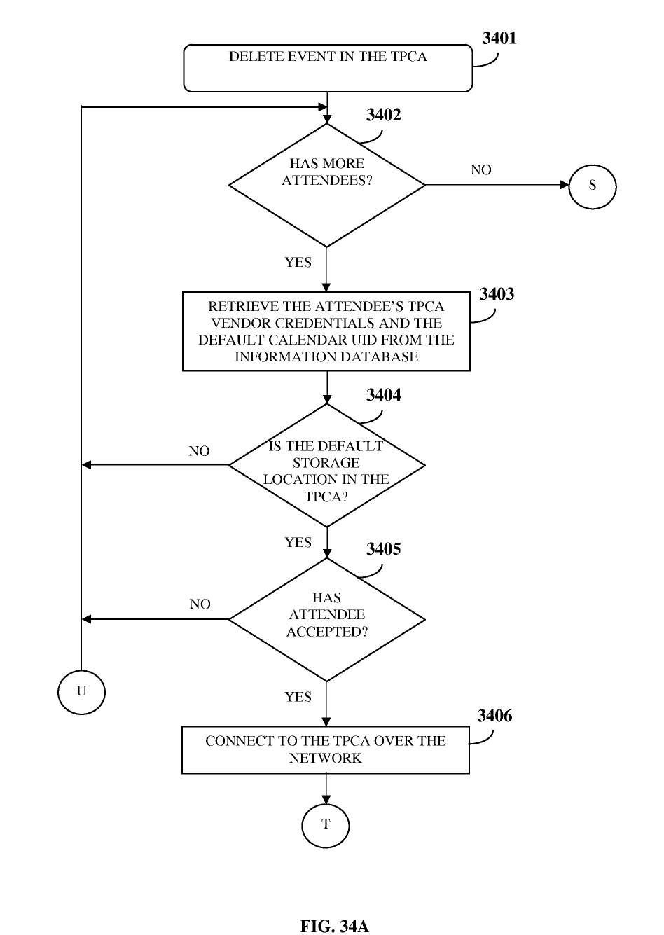

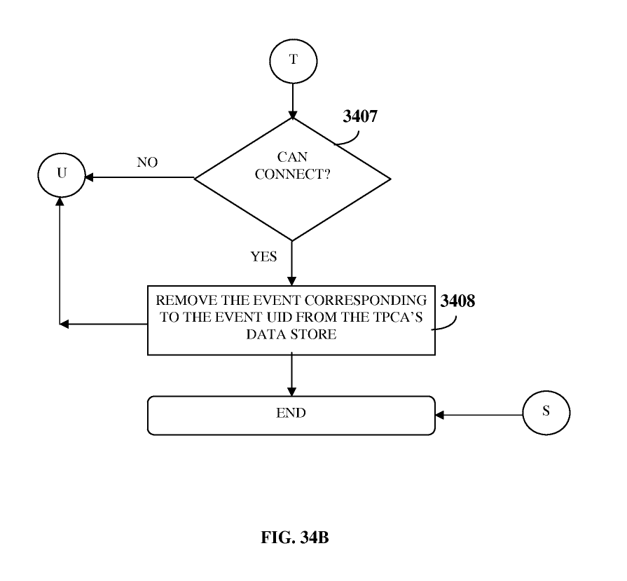

FIG. 32 exemplarily illustrates a flowchart comprising the steps for deleting an event by the event management platform. The client application transmits 3201a hypertext transfer protocol (HTTP) request message to the event management platform via the network to delete an event identified by the event identification key in the JavaScript Object Notation (JSON) object in the body of the HTTP request message. The HTTP request message comprises an event deletion request message. The event management platform receives 3202 the HTTP request message, for example, via the web services API of the event management platform. The event management platform checks 3203 the validity of the HTTP request message for deletion of the event. If the request message is not valid, the event management platform generates 3208 an HTTP response and returns the affected number of rows in the information database as zero in an HTTP response. If the request message is valid, the event management platform converts 3204 the JSON object in the body of the HTTP request message to an event data object whose format is defined by the event management platform. The event management platform invokes 3205 an internal “delete event” operation and executes 3206 a stored procedure in the information database of the event management platform to delete the data associated with the event identification key in the event table and the event_attendee table in the information database of the event management platform. The event management platform posts 3207 an event deletion JSON object text message as a notification message to a “delete event” queue in the event management platform, for automatically updating the deletion of the event in the third party calendar applications of each of the users in the group who were associated with the deleted event, as disclosed in the detailed description of FIGS. 34A-34B. The event management platform generates 3208 an HTTP response message returning the number of rows in the information database that have been affected by the deletion of the event and notifies the user who initiated the deletion of the event. The event management platform then ends the process.

FIG. 33 exemplarily illustrates a flowchart comprising the steps for triggering deletion of an event in a third party calendar application by the event management platform. On receiving a “remove event” message formatted as a JavaScript Object Notation (JSON) object from the “delete event” queue, the event management platform converts 3301 the JSON object in the “remove event” message to an event data object of the event management platform. The event management platform determines 3302 whether the event has any more users associated with the event, where the users are referred to as “attendees”. If the event has any more attendees, for each of the attendees, the event management platform posts 3303 a cancellation message to the particular attendee's “cancel event” queue and checks 3304 whether the event has been confirmed. If the event has no more attendees, the event management platform checks 3304 whether the event has been confirmed. If the deletion of the event is confirmed, the event management platform deletes 3305 the event in third party calendar application (TPCA), as disclosed in the detailed description of FIGS. 34A-34B, and ends the process. If the deletion of the event is not confirmed, the event management platform ends the process.

FIGS. 34A-34B exemplarily illustrate a flowchart comprising the steps for deleting an event in a third party calendar application by the event management platform. In order to delete 3401 an event in the third party calendar applications of each of the attendees of the event, the event management platform determines 3402 whether the event has any more attendees. If the event has any more attendees, the event management platform retrieves 3403 the attendee's third party calendar application (TPCA) vendor credentials and the default storage location indicated, for example, by the default calendar unique identifier (UID) of the calendar where the events are stored, from the information database. The event management platform determines 3404 whether the default storage location indicated by the calendar identifier is for a third party calendar application. If the attendee's default calendar identifier is not for a third party calendar application, the event management platform returns to check 3402 for the other attendees associated with the event. If the default calendar identifier is for a third party calendar application, the event management platform determines 3405 whether the attendee has accepted deletion of the event. If the attendee has accepted, the event management platform attempts to connect 3406 to the particular third party calendar application over the network using the account credentials of the attendee. The event management platform determines 3407 whether the connection is established. If the connection is established, the event management platform removes 3408 the event corresponding to the unique event identifier from the data store of the third party calendar application and returns to the next attendee. If there are no more attendees to process, the event management platform ends the process.

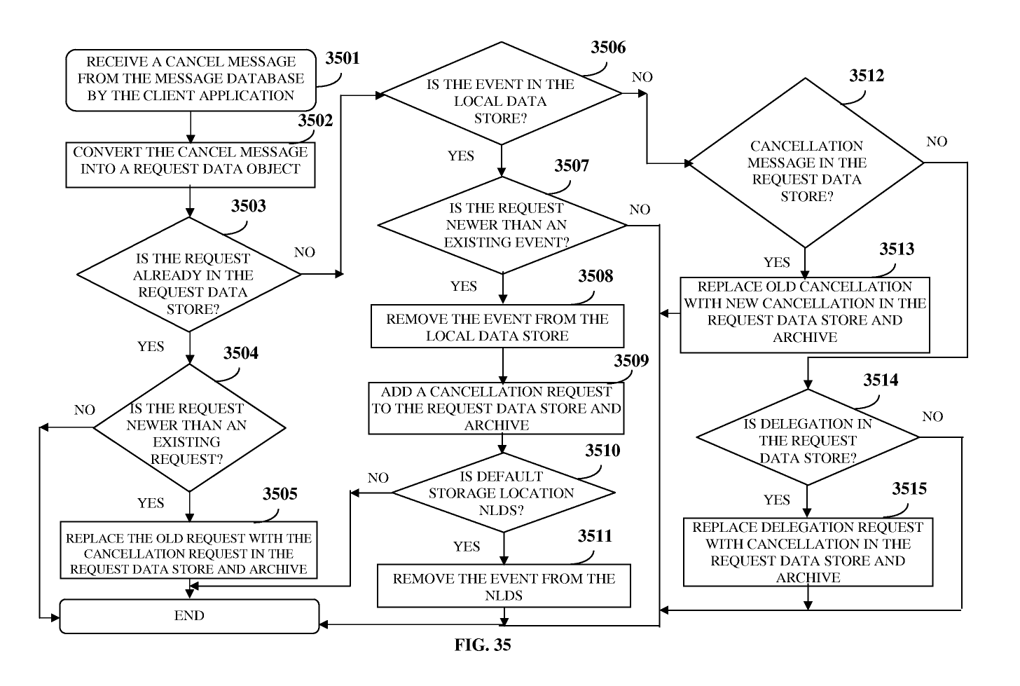

FIG. 35 exemplarily illustrates a flowchart comprising the steps for processing a request for cancellation of an event in the client application. The client application receives 3501a cancel message from the “cancel event” queue in the message database of the event management platform. The cancel message is in the form of a JavaScript Object Notation (JSON) object. The client application converts 3502 the JSON cancel message into a request data object. The client application determines 3503 whether the new request is already in the request data store of the client application. If the new request is already in the request data store, the client application determines 3504 whether the new request is newer than an existing event request in the request data store, for example, by comparing the timestamps. If the new request is newer than an existing request in the request data store, the client application replaces 3505 the old request with a cancellation request in the request data store and archives the request data store, that is, stores the request data store to a persistent file or a persistent database. If the new request is older than an existing request in the request data store, the client application ends the process.

If the new request is not already in the request data store, the client application determines 3506 whether the event is in the local data store of the client application, for example, by determining the event identification key is the same as the event identification key of an existing event in the local data store. If the event identification key is the same as the event identification key of an existing event in the local data store, the client application determines 3507 whether the request for deletion of the event is newer than an existing event in the local data store, for example, by comparing the time stamps of the request for deletion of the event and the existing event in the local data store. If the request for deletion of the event is older than an existing event in the local data store, the client application ends the process. If the request for deletion of the event is newer than an existing event in the local data store, the client application removes 3508 the event from the local data store. The client application then adds 3509 a cancellation request for cancellation of the event to the request data store in the client application and archives the request data store, that is, stores the request data store to a persistent file or a persistent database. The client then checks 3510 whether the default storage location for storing events is in the native local data store (NLDS). If the default storage location for storing events is in the native local data store, the client application removes 3511 the event from the native local data store. If the default storage location for storing events is not in the local data store, the client application ends the process.

If the event identification key is not the same as the event identification key of an existing event in the local data store, the client application determines 3512 whether there is a cancellation message in the request data store. If there is a cancellation message in the request data store, the client application replaces 3513 the old cancellation message with the new cancellation in the request data store and archives the request data store, that is, stores the request data store to a persistent file or a persistent database, and ends the process. If there is no cancellation message in the request data store, the client application determines 3514 whether there is a request for delegation already in the request data store. If there is a request for delegation, the client application replaces 3515 the delegation request with the cancellation request in the request data store, archives the request data store, that is, stores the request data store to a persistent file or a persistent database, and ends the process. If there is no request for delegation, the client application ends the process.

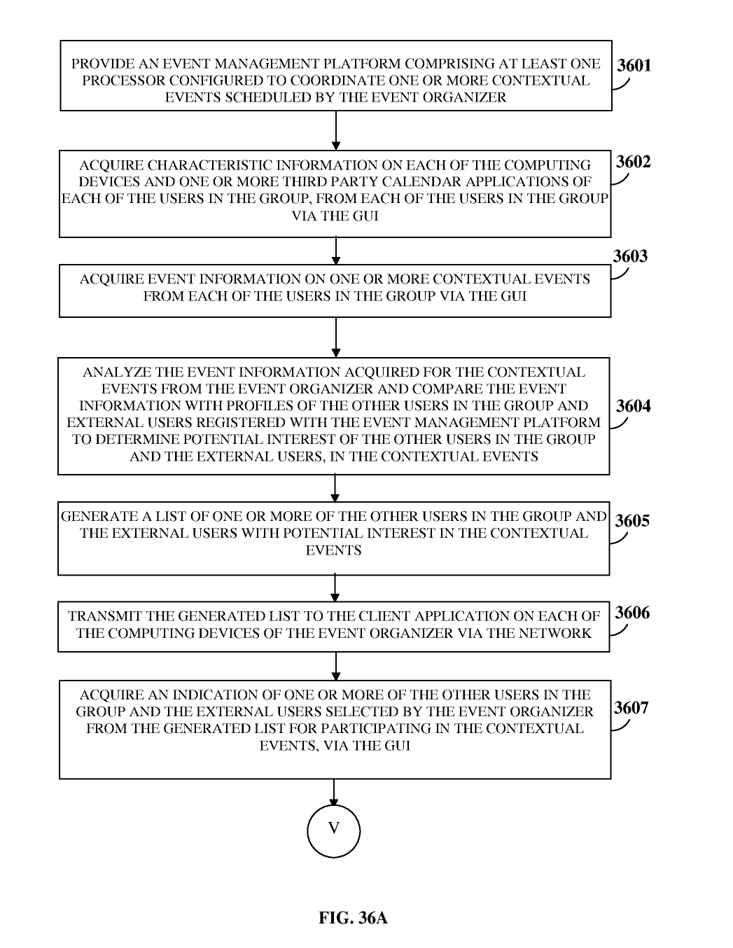

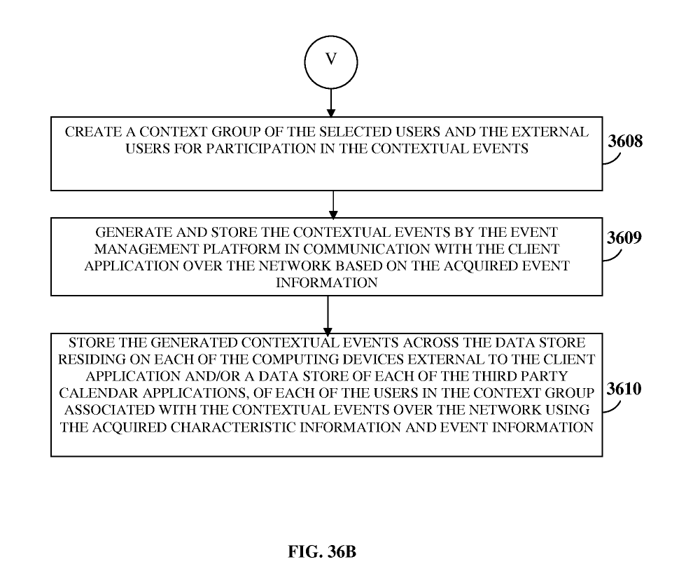

FIGS. 36A-36B exemplarily illustrate a computer implemented method for managing one or more contextual events scheduled by an event organizer in a group. As used herein, the term “contextual event” refers to a non-private event associated with a theme or a context. For example, a contextual event is a technical seminar or a conference, a shared viewing session, etc. The event organizer is a user who schedules an event. As disclosed in the detailed description of FIG. 1, the computer implemented method disclosed herein provides 3601 the event management platform comprising at least one processor configured to coordinate contextual events scheduled by the event organizer among the users in the group. The event management platform acquires 3602 characteristic information on each of the computing devices and one or more third party calendar applications of each of the users in the group, from each of the users in the group, via the graphical user interface (GUI) of the event management platform. The event management platform also acquires 3603 event information on the contextual events from each of the users in the group, via the GUI of the event management platform.

In an embodiment, the event management platform analyzes 3604 the event information acquired for one or more contextual events from the event organizer. The event management platform compares the event information with profiles of other users in the group and external users registered with the event management platform to determine potential interest of the other users in the group and the external users, in the contextual events. As used herein, the term “external user” refers to a user who has registered with the event management platform but who is not a part of the group of users defined by the user who has scheduled a particular event.

Consider an example where the event management platform has received event information on a contextual event, for example, a conference on cloud computing. The event management platform crawls the web to extract terms commonly associated with cloud computing. The event management platform performs a keyword search on the profile information, for example, the interest areas reported by the users registered with the event management platform for the terms “cloud computing”, “grid computing”, “software as a service”, etc. The event management platform compares the interest areas of the user, the location of the user, etc., with the event name, location, etc., defined by the event organizer in the event information. The event management platform further verifies whether past events attended by the user comprise events associated with cloud computing. The event management platform may be configured with multiple filter criteria to determine a possible user potentially interested in the contextual event. The event management platform generates 3605 a list of one or more of other users in the group and external users with potential interest in the contextual events. The event management platform transmits 3606 the generated list to the client application on each of the computing devices of the event organizer via the network. The event management platform acquires 3607 an indication of one or more other users in the group and external users selected by the event organizer from the generated list for participating in the contextual events, via the GUI of the event management platform. The event management platform waits for approval from the event organizer for including the users in the generated list in the contextual event.

The event management platform creates 3608 a context group of the selected users in the group and the selected external users for participation in the contextual events. For example, the event management platform creates a cloud computing group comprising the users in the group inclusive of the event organizer, and the external users selected by the event organizer. The event management platform, in communication with the client application over the network, generates 3609 and stores the contextual events based on the acquired event information. The event management platform stores 3610 the generated contextual events across the native local data store and/or the data store of each of the third party calendar application of each of the users in the context group associated with the contextual events, using the acquired characteristic information and event information. The stored contextual events are accessible to each of the users in the context group associated with the contextual events over the network, for performing one or more actions on the stored contextual events.

In an application of the computer implemented method disclosed herein, consider a user in an organization who employs the computer implemented method and system disclosed herein for managing official events. A user A wants to initiate the generation of an event, for example, an official meeting involving two other users B and C. User A employs a computing device, for example, a mobile phone that hosts a client application. The default storage location for storing events initiated by user A is a native local data store on the mobile phone. User B uses a computing device, for example, a desktop computer that does not host the client application, but hosts a third party calendar application, for example, Microsoft® Office Outlook™ Calendar of Microsoft Corporation. The default storage location for storing events associated with user B is a data store in the third party calendar application. User C employs a desktop computer that hosts the client application. The default storage location for storing events initiated by user C is a native local data store on the desktop computer. The client application of user A provides a graphical user interface through which user A enters the characteristic information, for example, the account identity and password of a third party calendar application, for example, Google Calendar, of Google, Inc., the members of a group comprising user B and user C, etc. The client application of user A transmits the characteristic information to the event management platform via the network for registering user A with the event management platform. User B directly registers with the event management platform, by establishing a connection with the event management platform via the network, for example, the internet, and entering the characteristic information via the GUI of the event management platform. User C registers with the event management platform by entering the characteristic information into the GUI of the client application. User A then enters the event information, for example, the date and time of an event, the location of the event, and the duration of the event, the number of attendees into the client application via the GUI. The client application of user A transmits the event information as a hypertext transfer protocol (HTTP) event request message to the event management platform, as disclosed in the detailed description of FIGS. 3A-3B, via the network for initiating the generation of the event.

As disclosed in the detailed description of FIG. 4, the event management platform checks the validity of the received event request message. For example, the event management platform checks the validity of the timing information of the event, confirms that user B and user C are registered with the event management platform, etc. If the received event request message is valid, the event management platform generates an event, stores the event information in the information database and notifies the client application of user A of the generation of the event, along with the event identification key as disclosed in the detailed description of FIG. 4. If the received event request message is not valid, the event management platform transmits a notification message to the client application of user A stating that the generation of the event was unsuccessful. In this example, the received event request message is valid and the client application of user A is notified that the generation of the event in the event management platform was successful. The event management platform then generates an event request message for transmission to user B and user C. For example, the event management platform transmits an electronic mail to user B and an HTTP message to the client application of user C. User B transmits an acceptance message to the event management platform through a reply email. The client application of user C processes the event request message, as disclosed in the detailed description of FIG. 7, and notifies user C. On receiving an acceptance message from user C, the client application of user C transmits another HTTP message indicating acceptance of the event to the event management platform as disclosed in the detailed description of FIG. 8.

On receiving a confirmation from user B and user C, the event management platform determines that the default storage location for user B is the Microsoft® Office Outlook™ Calendar of Microsoft Corporation, and the default storage location of user C is the native local data store on the desktop computer of user C. The event management platform validates the account credentials of the third party calendar application of user B and stores the event in the data store of the third party calendar application, as disclosed in the detailed description of FIG. 5 and FIGS. 6A-6B. The event management platform notifies the client application of user C for storing the event in the native local data store on the desktop computer of user C.

User A then determines that due to a prior commitment, user A is unable to attend the event at the particular time when the event was scheduled. Therefore, user A decides to delegate the event to another registered user D. User D has a client application on a tablet computing device and a native local data store on the tablet computing device for storing all the events associated with user D. In order to delegate the event and confirm the availability of the all the attendees including user D for the event, user A initiates a request to the event management platform, via the client application, to retrieve the events of the users scheduled on the particular date on which the meeting, that is, the event initiated by user A, has been scheduled. The client application of user A requests the user events and group events of user B, user C, and user D, as disclosed in the detailed description of FIGS. 19A-19B, and the private events of the users as disclosed in the detailed description of FIGS. 20A-20B. The event management platform retrieves all the events of user B, user C, and user D as disclosed in the detailed description of FIG. 21, FIG. 22, and FIGS. 23A-23B.

Consider an example where user D has notified the event management platform of the busy time periods of user D to the event management platform as disclosed in the detailed description of FIG. 27. The notification message comprises the start time and end time of all the events of user D, that are stored in the native local data store associated with the client application of user D and have not been generated by the event management platform. The event management platform converts the busy time periods into private events for the user D as disclosed in the detailed description of FIG. 20. The event management platform retrieves the user events and group events of user D from the information database as disclosed in the detailed descriptions of FIG. 21, FIG. 22 and FIGS. 23A-23B, and collects the retrieved events along with the private events. The event management platform then transmits the retrieved events of user D to the client application of user A. The event management platform retrieves all the user events, group events, and private events of user B from the information database of the event management platform. The event management platform then retrieves the events scheduled for the particular date from the data store of the third party calendar application of user B, as disclosed in the detailed description of FIG. 23A-23B. The event management platform checks for a possible duplication of the events retrieved from the information database and the third party calendar application of user B as disclosed in the detailed description of FIG. 23A-23B. The event management platform transmits the events retrieved for user B to the client application of user A. The event management platform then retrieves the events of user C from the information database of the event management platform, as disclosed in the detailed descriptions of FIG. 21 and FIG. 22, and transmits the retrieved events of user C to the client application of user A.

The client application of user A then retrieves the events of user A stored in the native local data store of user A, as disclosed in the detailed description of FIG. 17 and FIG. 18. The client application of user A displays the events user B, user C, and user D, along with the events of user A on the GUI of the client application, indicating the busy time periods of each of the users involved in the event, as disclosed in the detailed description of FIG. 29. On determining that user D is busy on the scheduled date and at the scheduled time, user A updates the date and time of the event to match the availability of user D. The client application of user A then transmits a request message for updating the event to the event management platform as disclosed in the detailed description of FIGS. 12A-12B. The request for updating the event further defines a request for delegation of the event to user D. The event management platform transmits the request for updating the event to the client application of user C as disclosed in the detailed description of FIG. 13. The event management platform transmits a request for delegation of the event to the client application of user D. The event management platform transmits an email notification message to user B stating the updating of the date and time of the event. The client application of user C updates the event in the native local data store as disclosed in the detailed description of FIGS. 12A-12B. The client application of user D processes the request for delegation as disclosed in the detailed description of FIG. 15. The client application of user D then notifies the event management platform of the reply of user D to the request for delegation. The event management platform processes the reply to the request for delegation as disclosed in the detailed description of FIG. 10. The event management platform then checks whether the default storage location for storing the events for each of the users, user B, user C, and user D, is in a third party calendar application. If the default storage location for storing the events of a user is in a third party calendar application, the event management platform updates the event in the third party calendar application as disclosed in the detailed description of FIGS. 16A-16B. If the default storage location for storing the events of a user is not in a third party calendar application, the event management platform does not update the event in the third party calendar application since the event management platform determines that the client application of the user has already updated the event in the native local data store.

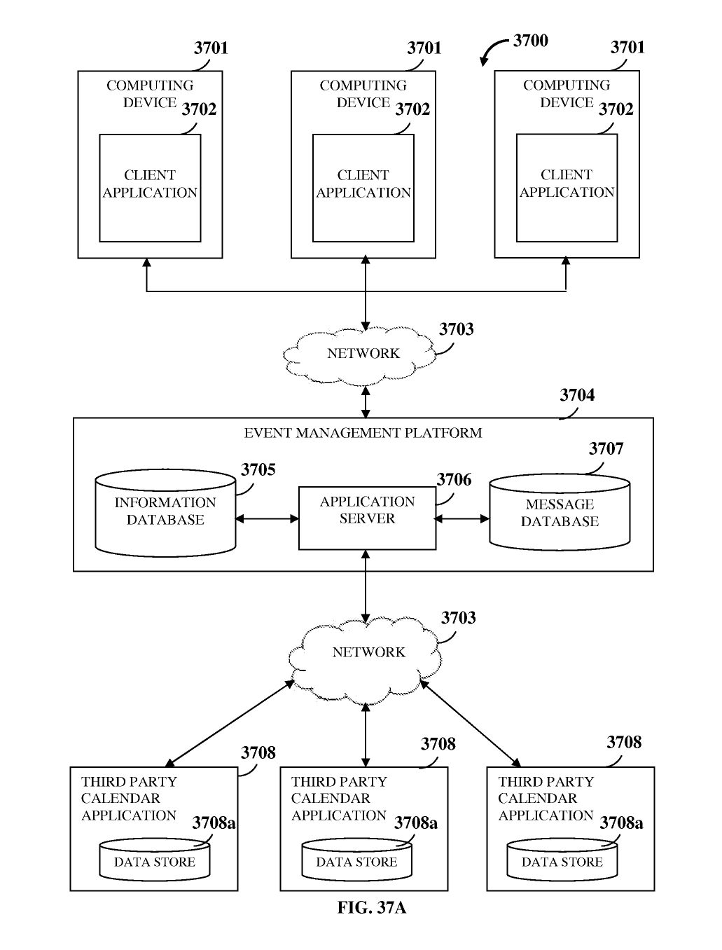

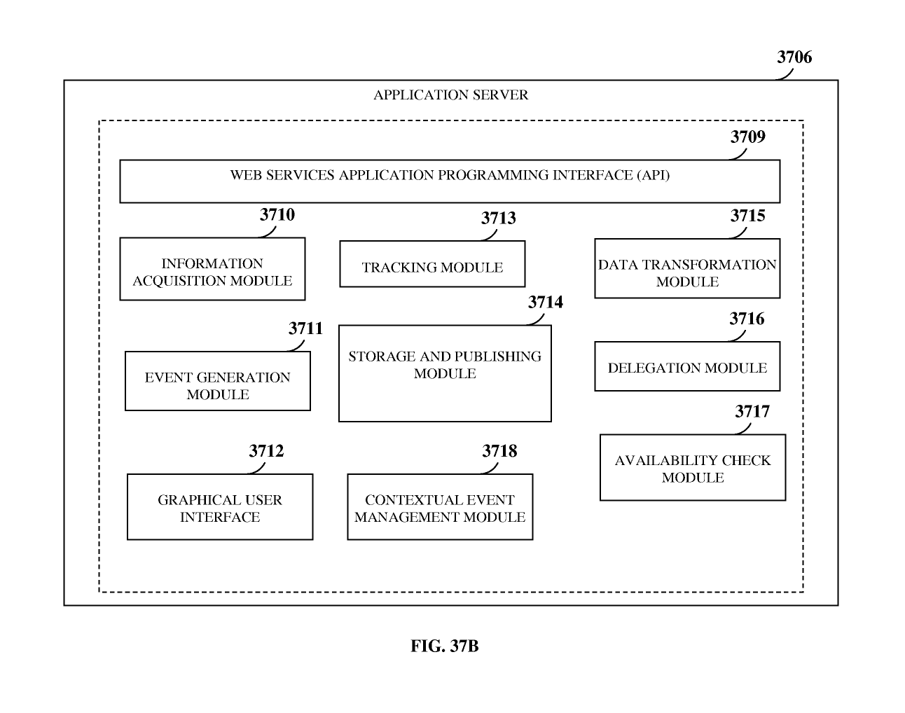

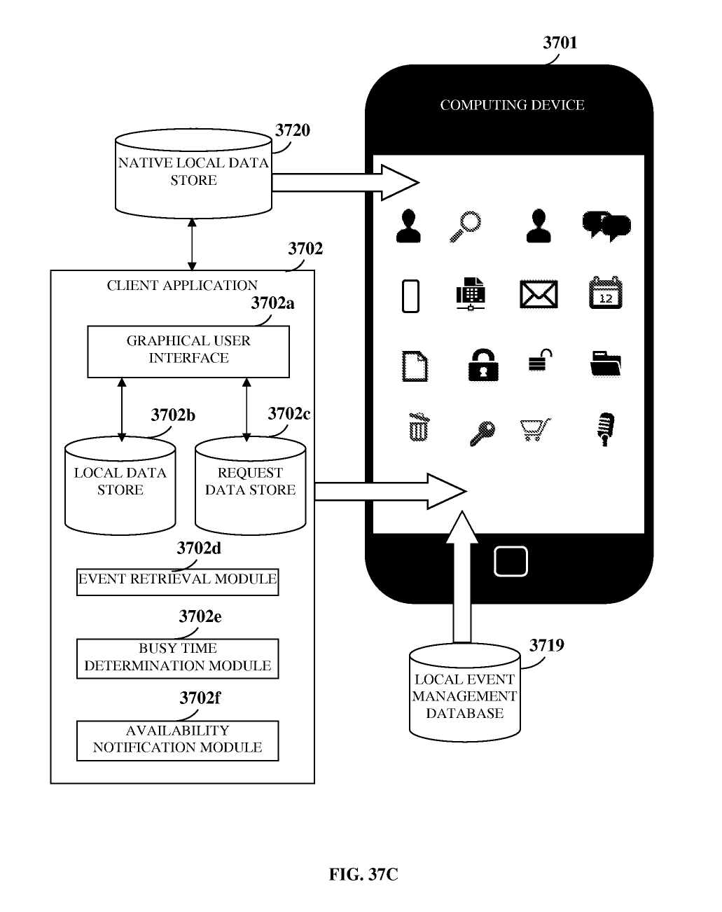

FIGS. 37A-37C exemplarily illustrate components of a computer implemented system 3700 for managing one or more events scheduled by multiple users in a group. The computer implemented system 3700 is herein referred to as a “unified virtual group calendar system”. The unified virtual group calendar system 3700 disclosed herein comprises a client application 3702 on each of one or more computing devices 3701 of the users, executable by at least one processor as exemplarily illustrated in FIG. 37A. The unified virtual group calendar system 3700 disclosed herein further comprises an event management platform 3704 comprising at least one processor configured to execute the modules 3710, 3711, 3712, 3713, 3714, 3715, 3716, 3717, 3718, etc., of the event management platform 3704. The client application 3702 on each of the computing devices 3701 of each of the users in the group is in communication with the event management platform 3704 via a network 3703. Furthermore, the event management platform 3704 is also in communication with one or more third party calendar applications 3708 over the network 3703. In an embodiment, the third party calendar application 3708 is, for example, accessible publicly over the internet, privately in an intranet, a local area network, a private network, etc. In an embodiment, an application programming interface to the third party calendar application 3708 is accessed using different protocols with programming language dependent libraries, for example, in Java® of Oracle Corporation, Objective C, C++, etc., instead of language independent protocols such as web services. The third party calendar application 3708 comprises a data store 3708a for storing events of each of the users in the group.

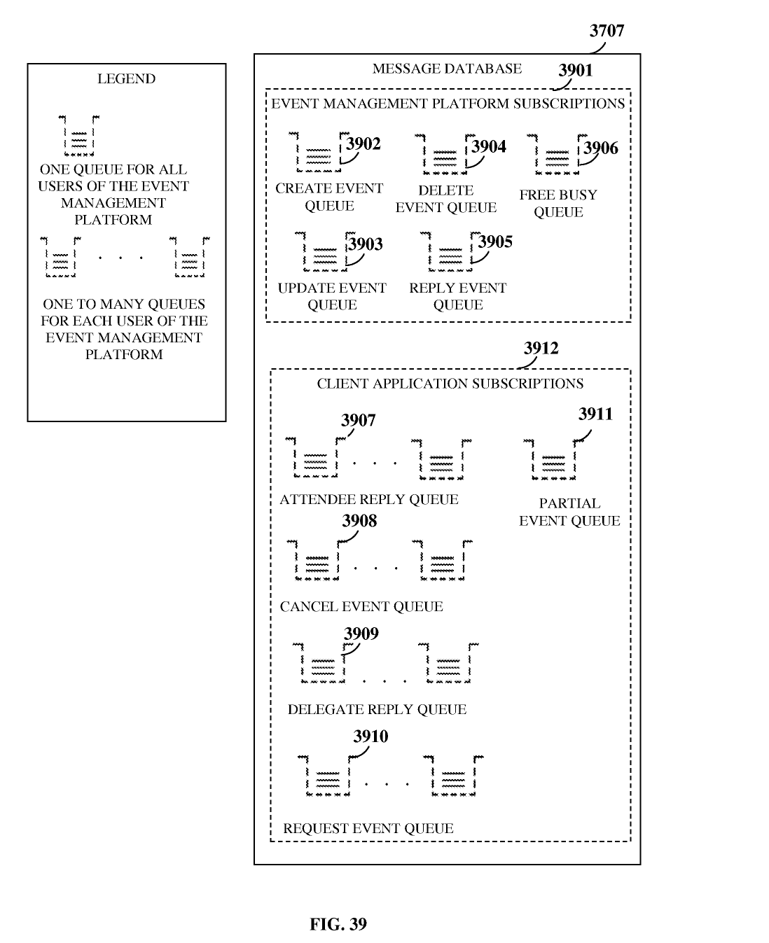

The event management platform 3704 enables creation, updating, and deletion of one or more events scheduled by the users in the group and copies of the events. The event management platform 3704 comprises an information database 3705, an application server 3706, and a message database 3707 as exemplarily illustrated in FIG. 37A. The information database 3705 stores information on third party calendar applications 3708, calendar events, users, groups, etc. The information database 3705 is, for example, a relational database management system (RDMS) that can be installed and executed on the event management platform 3704. The information database 3705 arranges the event information, event request information, etc., according to an organizational structure disclosed in the detailed description of FIGS. 38A-38B. The message database 3707 comprises a set of queues, disclosed in the detailed description of FIG. 39, that enable transmission and reception of notification messages between the client application 3702 and the event management platform 3704. In an embodiment, the message database 3707 of the event management platform 3704 is, for example, a messaging middleware server. The message database 3707 provides “subscriptions” for users to receive or transmit notification messages.

The application server 3706 of the event management platform 3704 is, for example, a Java® application server of Oracle Corporation, a Microsoft .NET application server of Microsoft Corporation, Apache based server bundles integrated with Perl, Python, hypertext preprocessor (PHP), Ruby, etc. The application server 3706 comprises a web services application programming interface (API) 3709, an information acquisition module 3710, an event generation module 3711, a graphical user interface (GUI) 3712, a tracking module 3713, a storage and publishing module 3714, a data transformation module 3715, a delegation module 3716, an availability check module 3717, and a contextual event management module 3718 as exemplarily illustrated in FIG. 37B. The web services application programming interface (API) 3709 enables communication with the client application 3702, for example, transmission and reception of data objects enclosed in hypertext transfer protocol (HTTP) messages, etc.

The information acquisition module 3710 acquires characteristic information on each of the computing devices 3701 and each of the third party calendar applications 3708 of each of the users in the group, from each of the users in the group via the GUI 3712. Furthermore, the information acquisition module 3710 acquires event information on the events from each of the users in the group via the GUI 3712. The GUI 3712 is, for example, a webpage that displays a screen for the user to enter the characteristic information and the event information. The information acquisition module 3710 acquires a default storage location for storing the events from each of the users in the group via the GUI 3712. The default storage location is, for example, a data store 3720 residing on each of the computing devices 3701 external to the client application 3702, that is, a native local data store 3720 exemplarily illustrated in FIG. 37C, a data store 3708a of each of the third party calendar applications 3708, of each of the users in the group associated with the events, etc. The events stored in the default storage location are accessible by the event management platform 3704 via the network 3703 for retrieval, transmission, and manipulation. The information acquisition module 3710 stores the user information and group information that is a part of the event information and the characteristic information in the information database 3705.

The event generation module 3711, in communication with the client application 3702 over the network 3703, generates one or more events based on the acquired event information. The event generation module 3711 stores the generated events in the information database 3705. The event generation module 3711, in communication with the client application 3702 over the network 3703, validates a request associated with the generation of each of the events received from the client application 3702. The event generation module 3711 generates an event identification key for each of the events for uniquely identifying each of the events, on successful validation of the request. The event generation module 3711 transmits the generated event identification key to the client application 3702 and/or each of the third party calendar application 3708 over the network 3703 for the storage of each of the events in a local data store 3702b on the client application 3702 exemplarily illustrated in FIG. 37C, the native local data store 3720 external to the client application 3702, and/or the data store 3708a of each of the third party calendar applications 3708. The event identification key is mapped to a unique event identifier generated by the native local data store 3720 residing on each of the computing devices 3701 external to the client application 3702 and the data store 3708a of each of the third party calendar applications 3708, for the storage of the generated events in the native local data store 3720 and/or the data store 3708a of each of the third party calendar applications 3708.

The data transformation module 3715 performs data type transformation, for example, converting data types of the event attributes received as part of the event information to a required data type. Furthermore, the data transformation module 3715 converts JavaScript Object Notation (JSON) objects to event data objects or converts the event data objects to JSON objects, etc.

The storage and publishing module 3714 stores the generated events across the native local data store 3720 and/or the data store 3708a of each of the third party calendar applications 3708 of each of the users in the group associated with the events over the network 3703 using the acquired characteristic information and the event information. The storage and publishing module 3714 in communication with the event generation module 3711 transmits an event invitation for each of the events triggered by one of the users in the group to other users in the group via the network 3703. The storage and publishing module 3714 transmits a copy of the generated events to the default storage location of each of the other users in the group via the network 3703 on receiving an acceptance message for the events from each of the other users in the group.

The stored events are accessible to each of the users in the group associated with the events over the network 3703 for performing one or more actions on the stored events, for example, viewing the stored events, deleting the stored events, updating the event information for updating the stored events scheduled by each of the users in the group. The storage and publishing module 3714 determines absence of the events generated for one of the users in the group, for example, in the local data store 3702b of the client application 3702 of each of the other users in the group, the native local data store 3720 of each of the other users in the group, and/or the data store 3708a of each of the third party calendar applications 3708 of each of the other users in the group over the network 3703. Furthermore, the storage and publishing module 3714 stores the events generated for one of the users in the group across the local data store 3702b of the client application 3702, the native local data store 3720 external to the client application 3702, and/or the data stores 3708a of the third party calendar applications 3708 of the other users in the group over the network 3703, based on the determination of the absence and a receipt of an acceptance message for the events from each of the other users in the group.

In an embodiment, the storage and publishing module 3714 stores the events of a user in both the native local data store 3720 and the data store 3708a of each of the third party calendar applications 3708 of the user based on an input received from the user. Therefore, although the default storage location is set to the native local data store 3720 or the data store 3708a of the third party calendar application 3708, the storage and publishing module 3714 stores the event in both the native local data store 3720 and the data store 3708a of the third party calendar application 3708 if the user requests for simultaneous storage of the events in both the storage locations. Furthermore, the storage and publishing module 3714 stores copies of the event in one or many calendars in each of the native local data store 3720 and the data stores 3708a of each of the third party calendar applications 3708. The storage and publishing module 3714 is configured to perform the functions of publishing events to the third party calendar applications 3708, generating notification messages, transmitting and receiving notification messages to/from the message database 3707, etc.

The tracking module 3713, in communication with the client application 3702 over the network 3703, tracks the actions performed on the stored events by one or more users in the group. The tracking module 3713 determines whether a result of each of the actions performed on the stored events by one of the users in the group is updated in the local data store 3702b of the client application 3702, the native local data store 3720 external to the client application 3702, and/or the data store 3708a of each of the third party calendar applications 3708 of each of the other users in the group via the network 3703.

The storage and publishing module 3714 automatically updates the stored events across the native local data store 3720 residing external to the client application 3702 on each of the computing devices 3701 and/or the data store 3708a of each of the third party calendar applications 3708, of each of the users in the group associated with the events, over the network 3703 using the acquired characteristic information and event information. The storage and publishing module 3714 is configured to integrate with third party calendar applications 3708 via the network 3703 so that the event management platform 3704 can interoperate with one or more third party calendar vendors. The storage and publishing module 3714 automatically updates the result of each of the actions performed on the stored events by one of the users in the group in the data store 3708a of each of the third party calendar applications 3708 of each of the other users in the group via the network 3703. The storage and publishing module 3714 transmits a notification to the client application 3702 of each of the other users in the group for updating of the result of each of the actions performed on the stored events by one of the users in the group, in the local data store 3702b of the client application 3702 and/or the native local data store 3720 external to the client application 3702, of each of the other users in the group, based on the determination of the updating of the result of each of the actions and a receipt of an acceptance message for result of each of the actions by each of the other users in the group.

Furthermore, the storage and publishing module 3714 of the event management platform 3704 deletes the generated events and transmits a notification to the client application 3702 on each of the computing devices 3701 of each of the other users in the group for performing deletion of the copy of the generated events from the default storage location of each of the other users in the group via the network 3703, on receiving a cancellation message from each of the other users in the group. Furthermore, in an embodiment, the delegation module 3716, in communication with the client application 3702 over the network 3703, determines delegation of the events from one of the users in the group to another one of the users in the group, for performing the actions on the stored events.

In an embodiment, the storage and publishing module 3714 selectively publishes the events retrieved from the local data store 3702b of the client application 3702, the information database 3705 of the event management platform 3704, the native local data store 3720, and the data store 3708a of each of the third party calendar applications 3708 to the users in the group via the network 3703 based on selection criteria. The storage and publishing module 3714 publishes the generated events stored in the native local data store 3720 to the other users in the group via the network 3703.

The contextual event management module 3718 of the event management platform 3704 analyzes event information on one or more contextual events acquired from an event organizer among the users in the group by the information acquisition module 3710 via the GUI 3712. The contextual event management module 3718 compares the event information with profiles of the other users in the group and external users registered with the event management platform 3704 to determine potential interest of the other users in the group and the external users in the contextual events. The contextual event management module 3718 generates a list of other users in the group and the external users with potential interest in the contextual events and transmits the generated list to the client application 3702 on each of the computing devices 3701 of the event organizer via the network 3703. The contextual event management module 3718 acquires an indication of one or more of the other users in the group and the external users selected by the event organizer from the generated list for participating in the contextual events, via the GUI 3712. The contextual event management module 3718 creates a context group of the selected users in the group and the external users for participation in the contextual events. The event generation module 3711 generates and stores the contextual events, in communication with the client application 3702 over the network 3703, based on the acquired event information. The storage and publishing module 3714 stores the generated contextual events across the native local data store 3720 and/or the data store 3708a of each of the third party calendar applications 3708, of each of the users in the context group associated with the contextual events, over the network 3703 using the acquired characteristic information and the event information. The stored contextual events are accessible to each of the users in the context group associated with the generated events over the network 3703 for performing one or more actions on the stored contextual events.

In an embodiment, the client application 3702 is embedded as a plug-in application in websites or web services. In another embodiment, the client application 3702 is a web application accessed over the network 3703. The client application 3702 may be developed in programming languages, for example, Java® of Oracle Corporation, Javascript® of Oracle Corporation, hyper text markup language (HTML), Adobe Flash® of Adobe Systems, Inc., hypertext preprocessor (PHP), JavaServer pages (JSP), etc. In another embodiment, the client application 3702 deployed on a computing device 3701 is a computer application running on different operating systems, for example, Microsoft Windows® of Microsoft Corporation, Mac OS of Apple, Inc., Linux, mobile operating systems, for example, iOS of Apple, Inc., the Android™ operating system of Google, Inc., BlackBerry® of Research In Motion, Ltd., etc.

The client application 3702 comprises a graphical user interface (GUI) 3702a, a local data store 3702b, a request data store 3702c, an event retrieval module 3702d, a busy time determination module 3702e, and an availability notification module 3702f as exemplarily illustrated in FIG. 37C. The local data store 3702b that resides within the client application 3702 stores the generated events on each of the computing devices 3701 of each of the users in the group. The local data store 3702b stores events currently being processed by the client application 3702. In an embodiment, the unified virtual group calendar system 3700 disclosed herein further comprises a local event management database 3719 on each of the computing devices 3701 of each of the users in the group for storing the generated events for the user to ensure uninterrupted performance of the actions on the stored events independent of the network 3703 in the client application 3702. The request data store 3702c stores all requests received by the client application 3702 of a user, for example, event invitations for storing generated events, delegation requests for delegating an event to the user of the client application 3702, cancellation requests for canceling an initiated event, etc. The unified virtual group calendar system 3700 disclosed herein further comprises a native local data store 3720 of calendar services provided on the computing device 3701.

The event retrieval module 3702d of the client application 3702 communicates with the event management platform 3704 over the network 3703, and is executable by at least one processor for retrieving the stored events associated with each of the other users in the group, stored across the native local data 3720 external to the client application 3702 and/or the data store 3708a of each of the third party calendar applications 3708 of each of the other users in the group over the network 3703, via the information database 3705 of the event management platform 3704. The event retrieval module 3702d sorts the retrieved events based on predetermined sorting criteria defined by a user. In an embodiment, the storage and publishing module 3714 determines events retrieved across the native local data store 3720 and/or the data store 3708a of each of the third party calendar applications 3708, that are duplicated and transmits a single copy of the events from among the duplicated events to the client application 3702 of the user in the group via the network 3703.

The busy time determination module 3702e of the client application 3702 on each of the computing devices 3701 of each of the users in the group, executable by at least one processor determines one or more busy time periods of each of the users in the group using the private event information of each of the events stored in the native local data store 3720 and transmits a notification of the determined busy time periods to the event management platform 3704 via the network 3703. The event generation module 3711 of the event management platform 3704, in communication with the client application 3702 over the network 3703, generates one or more private events for each of the users in the group based on the determined busy time periods received from the client application 3702 of each of the users in the group via the network 3703. The event generation module 3711 of the event management platform 3704 transmits a notification on the generated private events of each of the users in the group to the client application 3702 of each of the other users in the group, for accessing the generated private events of each of the users in the group by the other users in the group.

In an embodiment, the availability check module 3717 of the event management platform 3704, in communication with the client application 3702 over the network 3703, analyzes an availability status of each of the users in the group using the event information and transmits a notification to the client application 3702 of each of the other users in the group via the network 3703 for tracking availability of each of the users in the group for the events scheduled by each of the users in the group.

The availability notification module 3702f of the client application 3702 is executable by at least one processor. The availability notification module 3702f transmits a request message triggered by each of one or more users in the group to the event management platform 3704 via the network 3703, where the request message defines a predetermined duration of time to determine availability of each of the other users in the group. The availability notification module 3702f receives a notification of one or more busy time periods of each of the other users in the group retrieved from the native local data store 3720, a data store 3708a of each of the third party calendar applications 3708 of each of the other users in the group associated with the events, and the information database 3705 of the event management platform 3704 by the event management platform 3704 via the network 3703. The availability notification module 3702f then determines the availability status of each of the other users in the group for the predetermined duration of time based on the received notification of the busy time periods for notifying each of one or more users in the group whether one or more of the other users in the group are busy during the predetermined duration of time.

FIGS. 38A-38B exemplarily illustrates an entity relationship diagram indicating the relationships between the individual database entities storing event information in the information database 3705 of the event management platform 3704 exemplarily illustrated in FIG. 37A. Each database entity stores particular attributes of the event information and maps to a particular database table. The primary key, foreign key, etc., for each of the database entities, and the relationship between the database entities are exemplarily illustrated in FIGS. 38A-38B. The database entities comprise a “calendar” table 3801, a “calendar_vendor_account” table 3803, a “vendor” table 3805, an “event” table 3804, an “event_attendee” table 3802, a “member” table 3806, a “group_member” table 3807, a “group” table 3809, and a “busy_time” table 3808.

The “calendar” table 3801 stores information about the users' electronic calendars. The “calendar” table 3801 comprises a calendar identifier that is a primary key for the “calendar” table 3801, a calendar vendor account identifier that defines the account identification information of a particular calendar vendor, the name of a particular calendar, a description of the calendar, etc. The “calendar_vendor_account” table 3803 stores the individual users' account credentials, for example, a user name and a password for a particular calendar account for each of the third party calendar applications 3708. Furthermore, the “calendar_vendor_account” table 3803 comprises a vendor identifier (ID), a member identifier (ID) identifying the member associated with the particular account, etc.

The “vendor” table 3805 comprises attributes defining the identification information for the vendors of the third party calendar applications 3708. For example, the “vendor” table 3805 comprises the vendor identifier (ID) defined by a numerical value uniquely identifying a vendor of a third party calendar application 3708, the name of the vendor, etc. The “event” table 3804 comprises attributes of the event information on the events associated with the individual users. For example, the event table 3804 comprises, the event ID disclosed in the detailed description of FIGS. 3A-3B, the event status ID that defines the event status as “confirmed” when the event has been confirmed, as “tentative” when the event has been delegated, and “cancelled” when the event has been deleted, the start date and time, the end date and time, and the location of the event, the member identifiers of the organizer, delegator, and delegate that uniquely identifies the members of the group, etc. The “event_attendee” table 3802 stores information that tracks the attendance of a particular user for a particular event. For example, the event_attendee table 3802 comprises the event ID, the member ID, the attendee role, for example, whether the attendee is a participant, a non-participant, a chair member, etc., the rsvp expectation ID, that is, a request to a user to confirm whether a particular user is planning to attend the event, etc.

The “member” table 3806 stores information on the users who have registered with the event management platform 3704. The member table 3806 comprises the member ID of the user, the contact details of the member, for example, an electronic mail (email) identity and a password, a mobile phone number, a home phone number, etc. The “group_member” table 3807 stores information on the group relationships of users registered with the event management platform 3704. For example, the group_member table 3807 comprises a group identifier (group_id) for identifying a group of associated registered users, a member identifier (member_id) to identify a particular member of the group, a group role identifier (group_role_id) to identify the role of the member in the group, etc. The “group” table 3809 stores information for each group of users collaborating on one or more events. For example, the group table 3809 comprises the group identifier, a group_name, the billing addresses of each of the groups, etc.

The “busy_time” table 3808 stores the busy time periods defining free/busy information for private events that are maintained in the data stores, for example, 3702b and 3720 external to the event management platform 3704, for each user. The busy_time table 3808 comprises, for example, a member ID to identify a particular member in the group, timestamps indicating the start time and end time of a private event for which the user identified by the member ID is busy, etc.

FIG. 39 exemplarily illustrates an operational structure of the message database 3707 of the event management platform 3704 exemplarily illustrated in FIG. 37A. The message database 3707 comprises subscriptions 3901 and 3912 of the event management platform 3704 and the client application 3702, which comprise a set of queues for storing notification messages that direct the storing or updating of events in the third party calendar applications 3708 of each of the users. These queues are classified based on the actions performed on the events by the users associated with the events. Furthermore, each of the queues stores notification messages for multiple users. The queues in the event management platform subscriptions 3901 comprise, for example, a create event queue 3902, an update event queue 3903, a delete event queue 3904, a reply event queue 3905, and a free-busy queue 3906. The create event queue 3902 is a queue of events to be stored by the event management platform 3704, for example, in the data stores 3708a of the third party calendar applications 3708 of each of the users in the group. The update event queue 3903 is a queue of events that are to be updated by the event management platform 3704, for example, in the data stores 3708a of the third party calendar applications 3708 of each of the users in the group. The delete event queue 3904 is a queue of events that are to be deleted by the event management platform 3704, for example, in the data stores 3708a of the third party calendar applications 3708 of each of the users in the group. The reply event queue 3905 is a queue of event reply notification messages received from the users associated with the events tracked by the event management platform 3704, based on which the event management platform 3704 stores or updates an event in the data store 3708a of each of the third party calendar application 3708 of the particular attendee. The free-busy queue 3906 is a queue of busy time periods of each of the attendees of the events.

The message database 3707 further comprises individual queues per user for storing notification messages to be transmitted or received exclusively to/from the client application 3702 of the user. A user who attends an event is herein referred to as an attendee. The individual queues in the client application subscriptions 3912 comprise a set of attendee reply queues 3907, a set of cancel event queues 3908, a set of delegate reply queues 3909, a set of request event queues 3910, and a partial event queue 3911. The attendee reply queues 3907 store the replies of the attendees of the events for multiple event organizers or delegators of the events. That is, each attendee reply queue 3907 stores all the replies received by a particular event organizer from the attendees for an event.

The cancel event queues 3908 store the notification messages for event cancellations for each of the attendees of the events. That is, each cancel event queue 3908 stores all notification messages describing the cancellation of events with which a particular attendee is associated. The delegate reply queues 3909 store the replies to requests for delegation received from the delegate, with each of the delegate reply queues 3909 storing all the reply messages received from a particular delegate. The request event queues 3910 store the notification messages for the new event requests, that is, the invitations to each of the events associated with the attendees, with each of the request event queues 3910 storing all the invitation messages for a particular attendee. In an embodiment, each of the attendee reply queue 3907, the cancel event queue 3908, the delegate reply queues 3909, and the request event queue 3910 is implemented as a single queue for collectively storing the notification messages of all the users. The event management platform 3704 inserts a key/value attribute representing the username of the user in the notification messages to enable the client applications 3702 of the individual users to filter the notification messages according to the username. The partial event queues 3911 stores notifications that update the client applications 3702 of the attendees with the status of an event with reference to the communication between the event management platform 3704 and the third party calendar applications 3708, with the notification messages filtered according to a particular user. The partial event queue 3911 is a single queue. When a notification on an event is posted to the partial event queue 3911 by the event management platform 3704, the event management platform 3704 inserts a key/value attribute representing the username for the user, for example, user=janedoe@example.com in the notification message. The client application 3702 uses the unique username to filter messages received from the partial event queue 3911. In an embodiment, the same key/value username attribute may be used for the queues, for example, 3907, 3908, 3909, and 3910, instead of maintaining a unique username for each user.

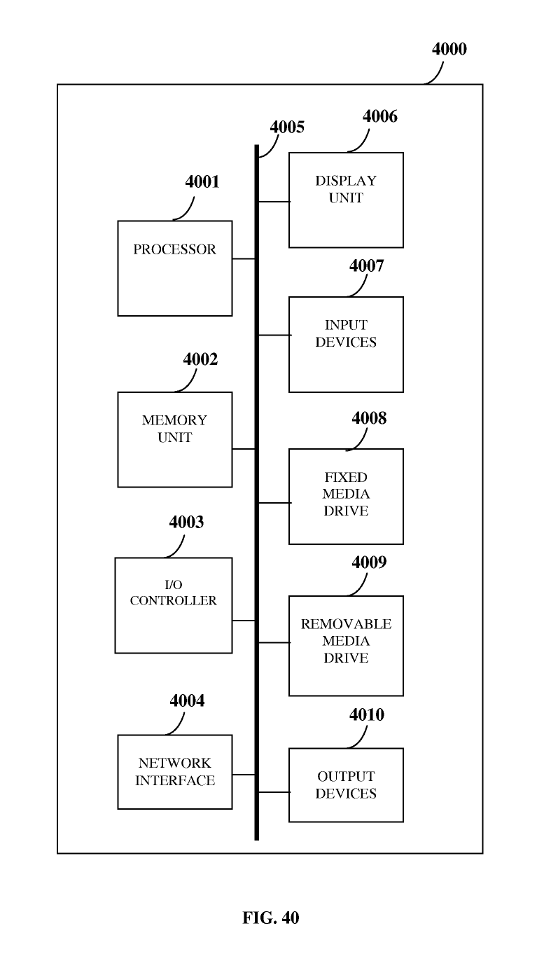

FIG. 40 exemplarily illustrates the architecture of a computer system 4000 employed by each of the client application 3702 and the event management platform 3704 for managing one or more events scheduled by multiple users in a group. The event management platform 3704 and the user's computing device 3701 that hosts the client application 3702 exemplarily illustrated in FIGS. 37A-37C employ the architecture of the computer system 4000 exemplarily illustrated in FIG. 40.

The event management platform 3704 communicates with the client application 3702 on the user's computing device 3701 via a network 3703. The network 3703 is, for example, the internet, a local area network, a wide area network, a wireless network, a telecommunication network, etc. The computer system 4000 comprises, for example, a processor 4001, a memory unit 4002 for storing programs and data, an input/output (I/O) controller 4003, a network interface 4004, a data bus 4005, a display unit 4006, input devices 4007, a fixed media drive 4008, a removable media drive 4009 for receiving removable media, output devices 4010, etc.

The processor 4001 is an electronic circuit that executes computer programs. The memory unit 4002 is used for storing programs, applications, and data. For example, the information acquisition module 3710, the event generation module 3711, the tracking module 3713, the storage and publishing module 3714, the data transformation module 3715, the delegation module 3716, the availability check module 3717, the contextual event management module 3718, etc., of the event management platform 3704, are stored in the memory unit 4002 of the computer system 4000 of the event management platform 3704. The event retrieval module 3702d, the busy time determination module 3702e, and the availability notification module 3702f, etc., are stored in the memory unit 4002 of the computer system 4000 of the computing device 3701. The memory unit 4002 is, for example, a random access memory (RAM) or another type of dynamic storage device that stores information and instructions for execution by the processor 4001. The memory unit 4002 also stores temporary variables and other intermediate information used during execution of the instructions by the processor 4001. The computer system 4000 further comprises a read only memory (ROM) or another type of static storage device that stores static information and instructions for the processor 4001.

The network interface 4004 enables connection of the computer system 4000 to the network 3703. For example, the user's computing device 3701 and the event management platform 3704 connect to the network 3703 via their respective network interfaces 4004. The network interface 4004 comprises, for example, an infrared (IR) interface, an interface implementing Wi-Fi® of the Wireless Ethernet Compatibility Alliance, Inc., a universal serial bus (USB) interface, a local area network (LAN) interface, a wide area network (WAN) interface, etc. The I/O controller 4003 controls the input actions and the output actions performed by each of the client application 3702 and the event management platform 3704. The data bus 4005 permits communications between the modules, for example, 3710, 3711, 3712, 3713, 3714, 3715, 3716, 3717, 3718, etc., of the event management platform 3704 and between the modules, for example, 3702d, 3702e, 3702f, etc., of the client application 3702 on the computing device 3701.

The display unit 4006 of the computing device 3701 hosting the client application 3702 displays via a graphical user interface (GUI) 3702a, information, for example, the events retrieved from across the client application 3702, the event management platform 3704, and the third party calendar applications 3708 associated with the users in the group. The display unit 4006 of the client application 3702 displays the busy time periods of each of the users associated with an event, the availability of one or more resources, etc. In another example, the display unit 4006 of the computing device 3701 displays a notification window provided by the client application 3702 for notifying an event request received by the user to participate in an event or accept delegation of an event. In an embodiment, the display unit 4006 of the event management platform 3704, via a GUI 3712, displays a registration screen for the user to enter characteristic information and event information directly into the event management platform 3704.

The input devices 4007 are used for inputting data into the computer system 4000. For example, a user uses the input devices 4007 to enter the characteristic information, the event information, etc. The user uses the input devices 4007 to perform one or more actions on the stored events, for example, updating an event, deleting an event, etc. The input devices 4007 are, for example, a keyboard such as an alphanumeric keyboard, a joystick, a pointing device such as a computer mouse, a touch pad, a light pen, etc. The output devices 4010 output the results of operations performed by the computing device 3701 and the event management platform 3704. For example, the client application 3702 on the computing device 3701 notifies the user, through an output device 4010 such as the display screen of the user's computing device 3701, of a new event request message, a reply to a transmitted delegation request message, etc.

Computer applications and programs are used for operating the computer system 4000. The programs are loaded onto the fixed media drive 4008 and into the memory unit 4002 of the computer system 4000 via the removable media drive 4009. In an embodiment, the computer applications and programs may be loaded directly via the network 3703. Computer applications and programs are executed by double clicking a related icon displayed on the display unit 4006 using one of the input devices 4007.

The computer system 4000 employs an operating system for performing multiple tasks. The operating system is responsible for management and coordination of activities and sharing of resources of the computer system 4000. The operating system further manages security of the computer system 4000, peripheral devices connected to the computer system 4000, and network connections. The operating system employed on the computer system 4000 recognizes, for example, inputs provided by the user using one of the input devices 4007, the output display, files, and directories stored locally on the fixed media drive 4008, for example, a hard drive. The operating system on the computer system 4000 executes different programs using the processor 4001.

The processor 4001 retrieves the instructions for executing the modules, for example, 3710, 3711, 3712, 3713, 3714, 3715, 3716, 3717, 3718, etc., of the event management platform 3704 from the memory unit 4002. The processor 4001 also retrieves the instructions for executing the modules, for example, 3702d, 3702e, 3702f, etc, of the client application 3702, from the memory unit 4002. A program counter determines the location of the instructions in the memory unit 4002. The program counter stores a number that identifies the current position in the program of each the modules, for example, 3710, 3711, 3712, 3713, 3714, 3715, 3716, 3717, 3718, etc., of the event management platform 3704, and the modules, for example, 3702d, 3702e, 3702f, etc., of the client application 3702.

The instructions fetched by the processor 4001 from the memory unit 4002 after being processed are decoded. The instructions are placed in an instruction register in the processor 4001. After processing and decoding, the processor 4001 executes the instructions. For example, the information acquisition module 3710 of the event management platform 3704 defines instructions for acquiring characteristic information on each of the computing devices 3701 and each of the third party calendar applications 3708 of each of the users in the group, from each of the users in the group via the GUI 3712. The information acquisition module 3710 also defines instructions for acquiring event information on the events from each of the users in the group via the GUI 3712. The information acquisition module 3710 also defines instructions for acquiring a default storage location for storing the events from each of the users in the group via the GUI 3712. The event generation module 3711 defines instructions for generating one or more events in communication with the client application 3702 over the network 3703, based on the acquired event information. The event generation module 3711 defines instructions for storing the generated events in the information database 3705. The event generation module 3711 defines instructions for validating a request associated with the generation of each of the events received from the client application 3702, generating an event identification key for each of the events for uniquely identifying each of the events on successful validation of the request, and transmitting the generated event identification key to the client application 3702 and/or each of the third party calendar applications 3708 over the network 3703 for the storage of each of the events in the local data store 3702b on the client application 3702, the native local data store 3720 external to the client application 3702, and/or the data store 3708a of each of the third party calendar applications 3708. The event identification key is mapped to a unique event identifier generated by the native local data store 3720 and the data store 3708a of each of the third party calendar applications 3708, for storage of the events in the native local data store 3720 and the data store 3708a of each of the third party calendar applications 3708 respectively.

The storage and publishing module 3714 defines instructions for storing the generated events across the native local data store 3720 and/or the data store 3708a of each of the third party calendar applications 3708, of each of the users in the group associated with the events over the network 3703 using the acquired characteristic information and event information. The storage and publishing module 3714 defines instructions for transmitting an event invitation for each of the events triggered by one of the users in the group to other users in the group via the network 3703. The storage and publishing module 3714 defines instructions for transmitting a copy of the generated events to a default storage location of each of the other users in the group via the network 3703 on receiving an acceptance message for the events from each of the other users in the group. The storage and publishing module 3714 defines instructions for determining the absence of the events for one of the users in the group, in the local data store 3702b of the client application 3702 of each of the other users in the group, the native local data store 3720 of each of the other users in the group, and/or the data store 3708a of each of the third party calendar applications 3708 of each of the other users in the group over the network 3703. The storage and publishing module 3714 defines instructions for storing the events generated for one of the users in the group across the local data store 3702b of the client application 3702, the native local data store 3720 external to the client application 3702, and/or the data store 3708a of each of the third party calendar applications 3708 of each of the other users over the network 3703, based on determination of the absence and a receipt of an acceptance message for the events from each of the other users in the group.

The tracking module 3713 defines instructions for tracking the actions performed on the stored events by the users in the group, in communication with the client application 3702 over the network 3703. The tracking module 3713 defines instructions for determining whether a result of each of the actions performed on the stored events by one of the users in the group is updated in the local data store 3702b of the client application 3702, the native local data store 3720 external to the client application 3702, and/or the data store 3708a of each of the third party calendar applications 3708 of each of the other users in the group via the network 3703.

Furthermore, the storage and publishing module 3714 defines instructions for automatically updating the stored events across the native local data store 3720 and/or the data store 3708a of each of the third party calendar applications 3708, of each of the users in the group associated with the events using the acquired characteristic information and event information. The storage and publishing module 3714 defines instructions for automatically updating the result of each of the actions performed on the stored events by one of the users in the group in the data store 3708a of each of the third party calendar applications 3708 of each of the other users in the group, and transmitting a notification to the client application 3702 of each of the users in the group, via the network 3703, for updating the result of each of the actions performed on the stored events by one of the users in the group, in the local data store 3702b of the client application 3702 and/or the native local data store 3720 external to the client application 3702, of each of the other users in the group, based on the determination of the updating of the result of each of the actions and a receipt of an acceptance message for the result of each of the actions by each of the other users in the group.

Furthermore, the storage and publishing module 3714 defines instructions for deleting the generated events and transmitting a notification to the client application 3702 on each of the computing devices 3701 of each of the other users in the group for performing deletion of the copy of the generated events from the default storage location of each of the other users in the group via the network 3703, on receiving a cancellation message from each of the other users in the group.

In an embodiment, the storage and publishing module 3714 defines instructions for selectively publishing the events retrieved from the local data store 3702b of the client application 3702, the information database 3705 of the event management platform 3704, the native local data store 3720, and the data store 3708a of each of the third party calendar applications 3708 to the users in the group via the network 3703 based on selection criteria. The storage and publishing module 3714 defines instructions for publishing the generated events stored in the native local data store 3720 to the other users in the group via the network 3703. The delegation module 3716 defines instructions for determining delegation of the events from one of the users in the group to another one of the users in the group for performing the actions on the stored events.

The contextual event management module 3718 defines instructions for analyzing event information on one or more contextual events acquired from an event organizer among the users in a group. The contextual event management module 3718 defines instructions for comparing the event information with profiles of the other users in the group and external users registered with the event management platform 3704 to determine potential interest of the other users in the group and the external users, in the contextual events. The contextual event management module 3718 defines instructions for generating a list of one or more of other users in the group and the external users with the potential interest in the contextual events and transmitting the generated list to the client application 3702 on each of the computing devices 3701 of the event organizer via the network 3703. The contextual event management module 3718 defines instructions for acquiring an indication of one or more of the other users in the group and the external users selected by the event organizer from the generated list for participating in the contextual events, via the GUI 3712. The contextual event management module 3718 defines instructions for creating a context group of the selected users in the group and the external users for participation in the contextual events. The event generation module 3711 defines instructions for generating and storing the contextual events, in communication with the client application 3702 over the network 3703 based on the acquired event information. The storage and publishing module 3714 defines instructions for storing the generated contextual events across the native local data store 3720 and/or the data store 3708a of each of the third party calendar applications 3708 of each of the users in the context group associated with the contextual events, over the network 3703 using the acquired characteristic information and event information.

The local event management database 3719 on each of the computing devices 3701 of each of the users in the group defines instructions for storing the generated events for the user to ensure uninterrupted performance of the actions on the stored events independent of the network 3703 in the client application 3702.

The event retrieval module 3702d of the client application 3702 defines instructions for retrieving the events associated with each of the other users in the group, stored across the native local data store 3720 external to the client application 3702 and/or the data store 3708a of each of the third party calendar applications 3708 of each of the other users in the group over the network 3703 via the information database 3705 of the event management platform 3704. The event retrieval module 3702d of the client application 3702 defines instructions for sorting the retrieved events based on predetermined sorting criteria defined by a user in the group. The storage and publishing module 3714 of the event management platform 3704 defines instructions for determining the events retrieved across the native local data store 3720 and/or the data store 3708a of each of the third party calendar applications 3708, of each of the other users in the group, that are duplicated, and transmitting a single copy of one or more events from among the duplicated events to the client application 3702 of the user in the group via the network 3703.

The busy time determination module 3702e of the client application 3702 defines instructions for determining one or more busy time periods of each of the users in the group using the private event information of each of the events stored in the native local data store 3720 and for transmitting a notification of the busy time periods to the event management platform 3704 via the network 3703. The event generation module 3711 of the event management platform 3704 defines instructions for generating one or more private events for each of the users in the group based the determined busy time periods received from the client application 3702 of each of the users in the group via the network 3703 and transmitting a notification on the generated private events of each of the users in the group to the client application 3702 of each of the other users in the group via the network 3703 for accessing the generated private events of each of the users in the group by the other users in the group. The availability check module 3717 of the event management platform 3704 defines instructions for analyzing an availability status of each of the users in the group using the event information, and transmitting a notification to each of the other users in the group via the network 3703 for tracking availability of each of the users in the group for the events scheduled by each of the users in the group.

The availability notification module 3702f of the client application 3702 defines instructions for transmitting a request message triggered by each of one or more of the users in the group to the event management platform 3704 via the network 3703, where the request message defines a predetermined duration of time to determine availability of each of other of the users in the group. The availability notification module 3702f defines instructions for receiving a notification of one or more busy time periods of each of the other users in the group retrieved from the native local data store 3720 residing on each of the computing devices 3701 external to the client application 3702, the data store 3708a of each of the third party calendar applications 3708 of each of the other users in the group associated with the events, and the information database 3705 of the event management platform 3704 via the network 3703. The availability notification module 3702f defines instructions for determining the availability status of each of the other users in the group for the predetermined duration of time based on the received notification of the busy time periods for notifying each of the users in the group whether one or more of the other users are busy during the predetermined duration of time.

The processor 4001 of the computer system 4000 employed by the event management platform 3704 retrieves the instructions defined by the information acquisition module 3710, the event generation module 3711, the tracking module 3713, the storage and publishing module 3714, the data transformation module 3715, the delegation module 3716, the availability check module 3717, and the contextual event management module 3718, and executes the instructions. The processor 4001 of the computer system 4000 employed by the client application 3702 retrieves the instructions defined by the event retrieval module 3702d, the busy time determination module 3702e, the availability notification module 3702f, and executes the instructions.

At the time of execution, the instructions stored in the instruction register are examined to determine the operations to be performed. The processor 4001 then performs the specified operations. The operations comprise arithmetic operations and logic operations. The operating system performs multiple routines for performing a number of tasks required to assign the input devices 4007, the output devices 4010, and memory for execution of the modules, for example, 3710, 3711, 3712, 3713, 3714, 3715, 3716, 3717, 3718, etc., of the event management platform 3704, and the modules, for example, 3702d, 3702e, 3702f, etc., of the client application 3702. The tasks performed by the operating system comprise, for example, assigning memory to the modules, for example, 3710, 3711, 3712, 3713, 3714, 3715, 3716, 3717, 3718, etc., of the event management platform 3704, and to the modules, 3702d, 3702e, 3702f, etc., of the computing device 3701, and data used by the event management platform 3704 and the client application 3702, moving data between the memory unit 4002 and disk units, and handling input/output operations. The operating system performs the tasks on request by the operations and after performing the tasks, the operating system transfers the execution control back to the processor 4001. The processor 4001 continues the execution to obtain one or more outputs. The outputs of the execution of the modules, for example, 3710, 3711, 3712, 3713, 3714, 3715, 3716, 3717, 3718, etc., of the event management platform 3704, and 3702d, 3702e, 3702f, etc., of the client application 3702 are displayed to the user on the display unit 4006.

Disclosed herein is also a computer program product comprising a non-transitory computer readable storage medium that stores computer program codes comprising instructions executable by at least one processor 4001. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 4001, except for a transitory, propagating signal.

The computer program product disclosed herein comprises multiple computer program codes for managing one or more events scheduled by one or more users in a group. For example, the computer program product disclosed herein comprises a first computer program code for acquiring characteristic information on each of the computing devices 3701 and one or more third party calendar applications 3708 of each of multiple users in the group, and event information on the events scheduled by each of the users in the group, from each of the users in the group via the GUI 3712 of the event management platform 3704; a second computer program code for generating and storing one or more events in communication with the client application 3702 over the network 3703 based on the acquired event information; a third computer program code for storing the generated events across the native local data store 3720 residing on each of the computing devices 3701 external to the client application 3702 and/or the data store 3708a of each of the third party calendar applications 3708, of each of the users in the group associated with the events over the network 3703 using the acquired characteristic information and event information, where the stored events are accessible to each of the users in the group, over the network 3703, for performing one or more actions on the stored events; a fourth computer program code for tracking the actions performed on the stored events by one or more of the users in the group, in communication with the client application 3702 over the network 3703; and a fifth computer program code for automatically updating the stored events across the native local data store 3720 external to the client application 3702 and/or the data store 3708a of each of the third party calendar applications 3708 of each of the users in the group associated with the events over the network 3703 using the acquired characteristic information and event information.

The computer program product disclosed herein further comprises a sixth computer program code for analyzing an availability status of each of the users in the group using the event information, in communication with the client application 3702 of each of the users via the network 3703; and a seventh computer program code for transmitting a notification to the client application 3702 of each of the other users in the group via the network 3703 for tracking availability of each of the users in the group for the events scheduled by each of the users in the group.

The computer program product disclosed herein further comprises an eighth computer program code for analyzing the event information on one or more contextual events acquired from an event organizer among the users in the group, and comparing the event information with profiles of other users in the group and external users registered with the event management platform 3704 to determine potential interest of the other users in the group and the external users in the contextual events; a ninth computer program code for generating a list of one or more of the other users in the group and the external users with the potential interest in the contextual events; a tenth computer program code for transmitting the generated list to the client application 3702 on each of the computing devices 3701 of the event organizer via the network 3703; an eleventh computer program code for acquiring an indication of one or more of the other users in the group and the external users selected by the event organizer from the generated list for participating in the contextual events via the GUI 3712; a twelfth computer program code for creating a context group of the selected users in the group and the external users for participation in the contextual events; and a thirteenth computer program code for generating and managing the contextual events, in communication with the client application 3702 over the network 3703. The computer program product disclosed herein further comprises additional computer program codes for performing additional steps that may be required and contemplated for managing one or more events scheduled by one or more users in the group.

The computer program codes comprising the computer executable instructions are embodied on the non-transitory computer readable storage medium. The processor 4001 of the computer system 4000 retrieves these computer executable instructions and executes them. When the computer executable instructions are executed by the processor 4001, the computer executable instructions cause the processor 4001 to perform the steps of the computer implemented method for managing one or more events scheduled by one or more users in the group. In an embodiment, a single piece of computer program code comprising computer executable instructions performs one or more steps of the computer implemented method disclosed herein for managing one or more events scheduled by one or more users.

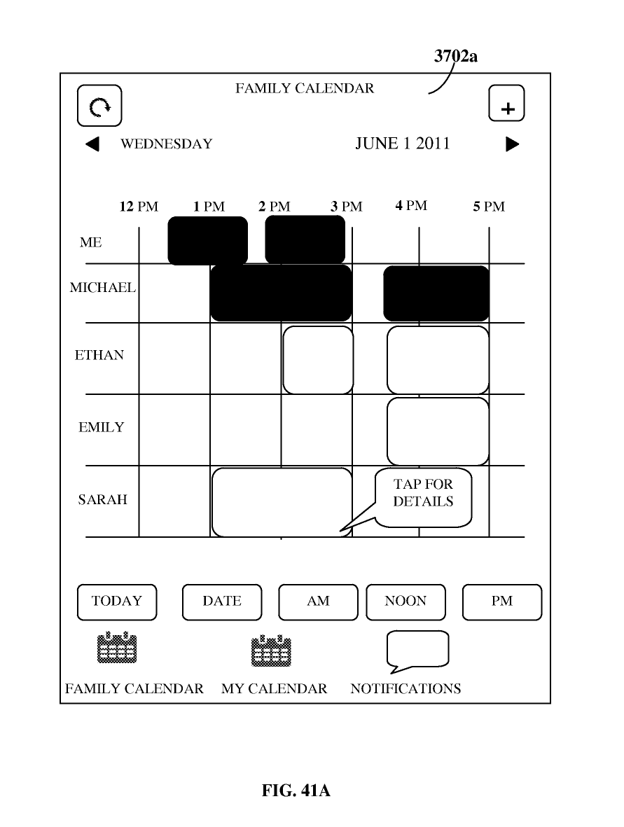

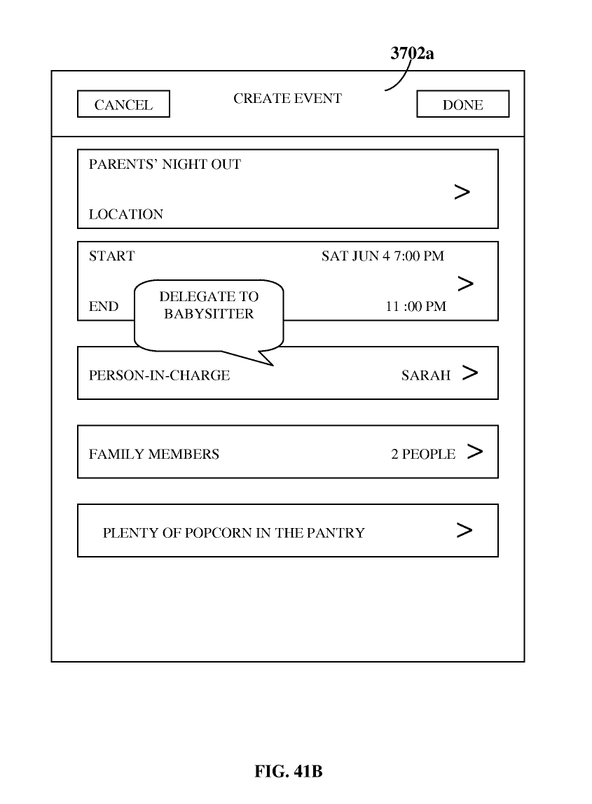

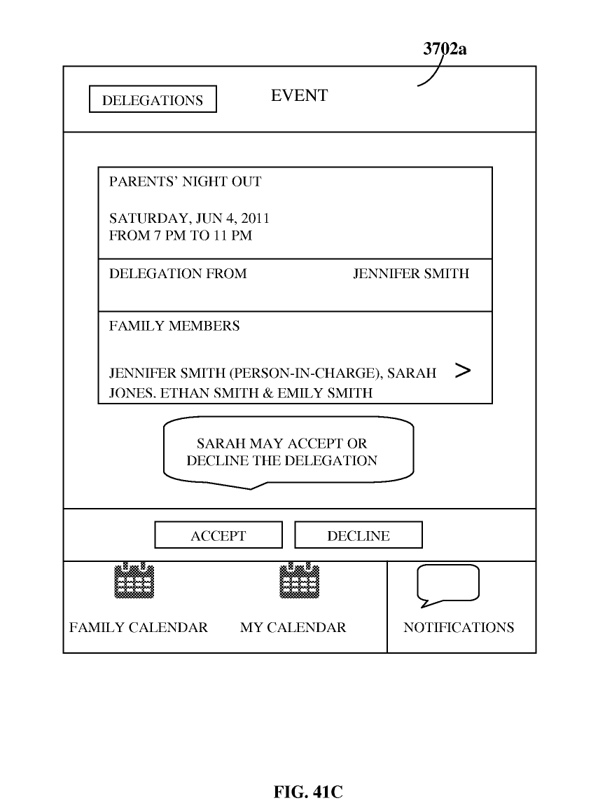

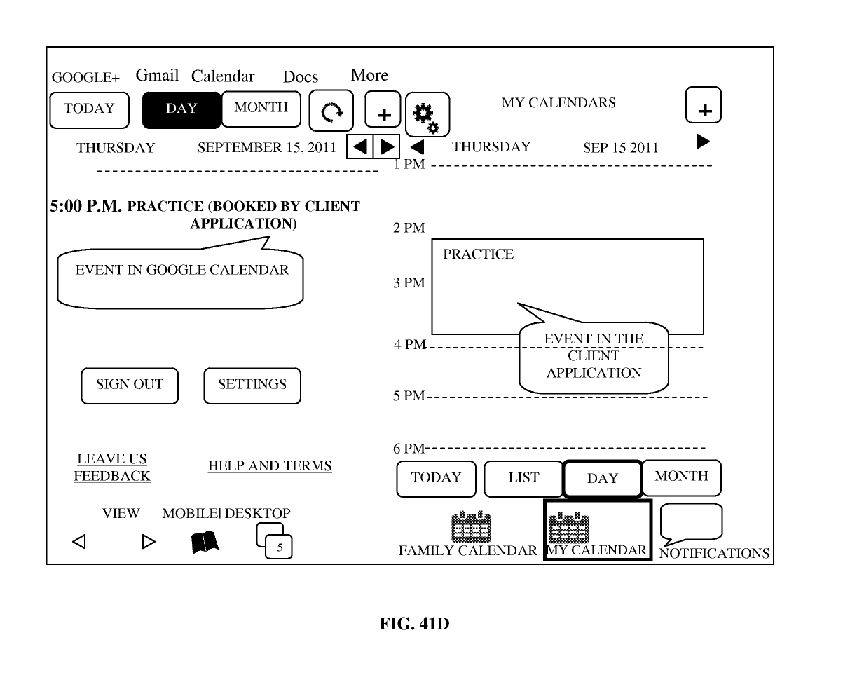

FIGS. 41A-41D exemplarily illustrate screenshots of a graphical user interface displaying events according to the computer implemented method disclosed herein. FIG. 41A exemplarily illustrates a screenshot of the GUI 3702a of the client application 3702, showing the availability of a group of users for an event. The group in this example is a family group comprising family members and a baby sitter. The events of all the family members are displayed on the GUI 3702a exemplarily illustrated in FIG. 41A. As exemplarily illustrated in FIG. 41A, the availability of the individual members of the group for a particular time of the day can be determined by a user by “tapping” the members' availability status on the GUI 3702a. FIG. 41B exemplarily illustrates a screenshot of the GUI 3702a of the client application 3702, showing the delegation of an event by a user of the group to another user. In this example, one of the parents in the family group delegates the event, for example, “watching over children” to the babysitter Sarah who is also a member of the family group. FIG. 41C exemplarily illustrates a screenshot of the GUI 3702a of the client application 3702 of the user who has received a notification request for accepting or declining the delegation of a particular event. For example, the babysitter Sarah who was delegated the event “Watching over children” can accept or decline the request for delegation of the event on the GUI 3702a. Since children are less likely to be in possession of a computing device 3701 such as a smart phone, the events transmitted to the children are automatically accepted. Furthermore, a user receives an electronic mail (email) for every new invitation or when family members reply to events organized by the user. FIG. 41D exemplarily a screenshot, showing the events stored in the local data store 3702b of the client application 3702 displayed in a third party calendar application 3708 of the user. In an example, when a user registers with the event management platform 3704, the event management platform 3704 prompts the user to indicate a preferred calendar of a third party calendar application 3708. FIG. 41D exemplarily illustrates the events synchronized and stored in the calendar in the data store 3708a of Google Calendar of Google, Inc.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the information database 3705, the message database 3707, and the local event management database 3719, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing one or more events scheduled by a plurality of users in a group, comprising:
providing an event management platform comprising at least one processor configured to coordinate said one or more events scheduled by said users in said group, wherein said event management platform is in communication with a client application on each of one or more computing devices of each of said users in said group via a network;
acquiring characteristic information on said each of said one or more computing devices and one or more third party calendar applications of said each of said users in said group, and event information on said one or more events, from said each of said users in said group by said event management platform, via a graphical user interface provided by said event management platform;
generating and storing said one or more events by said event management platform in communication with said client application over said network based on said acquired event information;
storing said generated one or more events across one or more of a data store residing on said each of said one or more computing devices external to said client application, and a data store of each of said one or more third party calendar applications, of said each of said users in said group associated with said one or more events, by said event management platform over said network using said acquired characteristic information and said event information, wherein said stored one or more events are accessible to said each of said users in said group associated with said one or more events over said network for performing one or more actions on said stored one or more events; and
tracking said one or more actions performed on said stored one or more events by one or more of said users in said group by said event management platform in communication with said client application over said network, and automatically updating said stored one or more events across said one or more of said data store residing on said each of said one or more computing devices external to said client application, and said data store of said each of said one or more third party calendar applications, of said each of said users in said group associated with said one or more events by said event management platform over said network using said acquired characteristic information and said event information.

2. The computer implemented method of claim 1, further comprising:
determining one or more busy time periods of said each of said users in said group by said client application on said each of said one or more computing devices of said each of said users in said group using private event information of said one or more events stored in said data store residing on said each of said one or more computing devices external to said client application, wherein each of said one or more busy time periods is a time period between a start time and an end time of each of said one or more events associated with said each of said users in said group; and
transmitting a notification of said determined one or more busy time periods to said event management platform via said network.

3. The computer implemented method of claim 2, further comprising:
generating one or more private events for said each of said users in said group by said event management platform in communication with said client application over said network based on said determined one or more busy time periods of said each of said users in said group received from said client application over said network; and
transmitting a notification of said generated one or more private events of said each of said users in said group to said client application of each of other of said users in said group by said event management platform via said network, for accessing said generated one or more private events of said each of said users in said group by said other of said users in said group.

4. The computer implemented method of claim 1, wherein said one or more actions performed on said stored one or more events by said one or more of said users in said group comprise one or more of viewing said stored one or more events, deleting said stored one or more events, and updating said event information for updating said stored one or more events scheduled by said each of said users in said group.

5. The computer implemented method of claim 1, wherein said generation of said one or more events by said event management platform in communication with said client application over said network comprises:
validating a request associated with said generation of each of said one or more events received from said client application;
generating an event identification key for said each of said one or more events for uniquely identifying said each of said one or more events by said event management platform on successful said validation of said request; and
transmitting said generated event identification key to one or more of said client application and said each of said one or more third party calendar applications over said network for said storage of said each of said one or more events in one or more of a data store of said client application, said data store residing on said each of said one or more computing devices external to said client application, and said data store of said each of said one or more third party calendar applications.

6. The computer implemented method of claim 5, further comprising mapping said generated event identification key to a unique event identifier generated by each of said data store residing on said each of said one or more computing devices external to said client application and said data store of said each of said one or more third party calendar applications for said storage of said generated one or more events in said one or more of said data store residing on said each of said one or more computing devices external to said client application and said data store of said each of said one or more third party calendar applications.

7. The computer implemented method of claim 1, further comprising determining absence of said one or more events generated for one of said users in said group, in one or more of a data store of said client application of each of other of said users in said group, said data store resident on said each of said one or more computing devices external to said client application of said each of said other of said users in said group, and said data store of said each of said one or more third party calendar applications of said each of said other of said users in said group by said event management platform via said network.

8. The computer implemented method of claim 7, wherein said event management platform stores said one or more events generated for said one of said users in said group across said one or more of said data store of said client application, said data store resident on said each of said one or more computing devices external to said client application, and said data store of said each of said one or more third party calendar applications, of said each of said other of said users in said group over said network, based on said determination of said absence and a receipt of an acceptance message for said one or more events from said each of said other of said users in said group.

9. The computer implemented method of claim 1, further comprising determining whether a result of each of said one or more actions performed on said stored one or more events by one of said users in said group is updated in one or more of a data store of said client application, said data store resident on said each of said one or more computing devices external to said client application, and said data store of said each of said one or more third party calendar applications, of each of other of said users in said group by said event management platform via said network.

10. The computer implemented method of claim 9, wherein said event management platform automatically updates said result of said each of said one or more actions performed on said stored one or more events by said one of said users in said group in said data store of said each of said one or more third party calendar applications of said each of said other of said users in said group, and transmits a notification to said client application of said each of said other of said users in said group via said network for said updating of said result of said each of said one or more actions performed on said stored one or more events by said one of said users in said group in said one or more of said data store of said client application and said data store resident on said each of said one or more computing devices external to said client application of said each of said other of said users in said group, based on said determination of said updating of said result of said each of said one or more actions and a receipt of an acceptance message for said result of said each of said one or more actions by said each of said other of said users in said group.

11. The computer implemented method of claim 1, wherein said event information acquired from said each of said users in said group comprises a number of said users in said group associated with each of said one or more events, an identity of each of said users in said group associated with said one or more events, a date of said each of said one or more events, a time for said each of said one or more events, a geographical location for said each of said one or more events, a duration of said each of said one or more events, and a default storage location in one of said data store resident on said each of said one or more computing devices external to said client application, and said data store of said each of said one or more third party calendar applications for storing said one or more events.

12. The computer implemented method of claim 1, wherein said characteristic information acquired from said each of said users in said group comprises one or more of account credentials for each of said one or more third party calendar applications, identification information of said each of said one or more third party calendar applications, electronic addresses of said each of said users in said group, and device identification information of said each of said one or more computing devices of said each of said users in said group.

13. The computer implemented method of claim 1, further comprising determining delegation of said one or more events from one of said users in said group to another one of said users in said group by said event management platform in communication with said client application over said network for performing said one or more actions on said stored one or more events.

14. The computer implemented method of claim 1, further comprising retrieving said one or more events associated with each of other of said users in said group, stored across one or more of said data store resident on said each of said one or more computing devices external to said client application, and said data store of said each of said one or more third party calendar applications, of said each of said other of said users in said group over said network via an information database of said event management platform, by said client application of one of said users in said group in communication with said event management platform over said network, and sorting said retrieved one or more events based on predetermined sorting criteria defined by said one of said users in said group by said client application of said one of said users in said group.

15. The computer implemented method of claim 14, further comprising determining said one or more events retrieved across said one or more of said data store resident on said each of said one or more computing devices external to said client application, and said data store of said each of said one or more third party calendar applications of said each of said other of said users in said group, that are duplicated, by said event management platform, and transmitting a single copy of said one or more events from among said duplicated one or more events to said client application of said one of said users in said group via said network.

16. The computer implemented method of claim 1, further comprising analyzing an availability status of said each of said users in said group using said event information by said event management platform in communication with said client application of said each of said users via said network, and transmitting a notification to said client application of each of other of said users in said group by said event management platform via said network for tracking availability of said each of said users in said group for said one or more events scheduled by said each of said users in said group.

17. The computer implemented method of claim 1, further comprising providing a local event management database on said each of said one or more computing devices of said each of said users in said group for said storage of said generated one or more events to ensure uninterrupted performance of said one or more actions on said stored one or more events independent of said network in said client application.

18. The computer implemented method of claim 1, further comprising selectively publishing said one or more events retrieved from a data store of said client application, an information database of said event management platform, said data store resident on said each of said one or more computing devices external to said client application, and said data store of said each of said one or more third party calendar applications, by said event management platform to said users in said group via said network based on selection criteria.

19. The computer implemented method of claim 1, wherein said client application is one of a software component downloadable on said each of said one or more computing devices of said each of said users in said group, and a web application in communication with said event management platform over said network.

20. The computer implemented method of claim 1, further comprising storing said generated one or more events by said event management platform in a data store of said client application configured as a downloadable software component on said each of said one or more computing devices of said each of said users in said group via said network.

21. The computer implemented method of claim 1, further comprising:
analyzing said event information on one or more contextual events acquired from an event organizer among said users in said group and comparing said event information with profiles of other of said users in said group and external users registered with said event management platform by said event management platform to determine potential interest of said other of said users in said group and said external users in said one or more contextual events;
generating a list of one or more of said other of said users in said group and said external users with said potential interest in said one or more contextual events by said event management platform, wherein said event management platform transmits said generated list to said client application on said each of said one or more computing devices of said event organizer via said network;
acquiring an indication of one or more of said other of said users in said group and said external users selected by said event organizer from said generated list for participating in said one or more contextual events, by said event management platform via said graphical user interface;
creating a context group of said selected one or more of said other of said users in said group and said external users for said participation in said one or more contextual events, by said event management platform; and
generating and managing said one or more contextual events by said event management platform in communication with said client application over said network.

22. A computer implemented method for managing one or more events scheduled by a plurality of users in a group, comprising:
providing an event management platform comprising at least one processor configured to enable creation, updating, and deletion of said one or more events scheduled by said users in said group and copies of said one or more events;
acquiring event information on said one or more events and a default storage location for storing said one or more events from each of said users in said group by said event management platform, via a graphical user interface provided by said event management platform, wherein said default storage location is one of a data store residing on each of one or more computing devices external to a client application on said each of said one or more computing devices of said each of said users in said group associated with said one or more events, and a data store of each of one or more third party calendar applications of said each of said users in said group associated with said one or more events;
generating and storing said one or more events by said event management platform in communication with said client application over said network based on said acquired event information; and
storing said generated one or more events in said default storage location by said event management platform over said network using said acquired event information, wherein said generated one or more events stored in said default storage location is accessible by said event management platform via said network for retrieval, transmission, and manipulation, and wherein said stored one or more events are accessible to said each of said users in said group associated with said one or more events over said network for performing one or more actions on said stored one or more events.

23. The computer implemented method of claim 22, further comprising publishing said generated one or more events stored in said data store residing on said each of said one or more computing devices of said each of said users in said group external to said client application, to other of said users in said group by said event management platform via said network.

24. The computer implemented method of claim 22, further comprising transmitting an event invitation for each of said one or more events triggered by one of said users in said group to other of said users in said group by said event management platform via said network, wherein said event management platform generates said one or more events and transmits a copy of said generated one or more events to said default storage location of each of said other of said users in said group via said network on receiving an acceptance message for said one or more events from said each of said other of said users in said group.

25. The computer implemented method of claim 24, further comprising deleting said generated one or more events by said event management platform and transmitting a notification to said client application on said each of said one or more computing devices of said each of said other of said users in said group for performing deletion of said copy of said generated one or more events from said default storage location of said each of said other of said users in said group via said network, on receiving a cancellation message from said each of said other of said users in said group.

26. A computer implemented method for notifying availability of each of a plurality of users in a group, comprising:
providing an event management platform comprising at least one processor configured to coordinate one or more events scheduled by said users in said group;
providing a client application executable by at least one processor on each of one or more computing devices of each of said users in said group, wherein said client application communicates with said event management platform via a network;
transmitting a request message triggered by each of one or more of said users in said group to said event management platform by said client application of said each of said one or more of said users in said group via said network, wherein said request message defines a predetermined duration of time to determine availability of each of other of said users in said group;
transmitting a notification of one or more busy time periods of said each of said other of said users in said group retrieved from a data store residing on said each of said one or more computing devices external to said client application of said each of said other of said users in said group, a data store of each of one or more third party calendar applications of said each of said other of said users in said group associated with said one or more events, and an information database of said event management platform, to said client application of said each of said one or more of said users in said group by said event management platform via said network, wherein each of said one or more busy time periods is a time period between a start time and an end time of each of said one or more events associated with said each of said users in said group; and
determining an availability status of said each of said other of said users in said group for said predetermined duration of time by said client application of said each of said one or more of said users in said group based on said transmitted notification of said one or more busy time periods for notifying said each of said one or more of said users in said group whether one or more of said other of said users in said group are busy during said predetermined duration of time.

27. A computer implemented method for managing one or more contextual events scheduled by an event organizer among a plurality of users in a group, comprising:
providing an event management platform comprising at least one processor configured to coordinate said one or more contextual events scheduled by said event organizer among said users in said group, wherein said event management platform is in communication with a client application on each of one or more computing devices of each of said users in said group via a network;
acquiring characteristic information on said each of said one or more computing devices and one or more third party calendar applications of said each of said users in said group, and event information on said one or more contextual events, from said each of said users in said group by said event management platform, via a graphical user interface provided by said event management platform;
analyzing said event information acquired for said one or more contextual events from said event organizer and comparing said event information with profiles of other of said users in said group and external users registered with said event management platform by said event management platform to determine potential interest of said other of said users in said group and said external users in said one or more contextual events;
generating a list of one or more of said other of said users in said group and said external users with said potential interest in said one or more contextual events by said event management platform, wherein said event management platform transmits said generated list to said client application on said each of said one or more computing devices of said event organizer via said network;
acquiring an indication of one or more of said other of said users in said group and said external users selected by said event organizer from said generated list for participating in said one or more contextual events, by said event management platform via said graphical user interface;
creating a context group of said selected one or more of said other of said users and said external users for said participation in said one or more contextual events, by said event management platform;
generating and storing said one or more contextual events by said event management platform in communication with said client application over said network based on said acquired event information; and
storing said generated one or more contextual events across one or more of a data store residing on said each of said one or more computing devices external to said client application, and a data store of each of said one or more third party calendar applications, of said each of said users in said context group associated with said one or more contextual events, by said event management platform over said network using said acquired characteristic information and said event information, wherein said stored one or more contextual events are accessible to said each of said users in said context group associated with said one or more contextual events over said network for performing one or more actions on said stored one or more contextual events.

28. A computer implemented system for managing one or more events scheduled by a plurality of users in a group, comprising:
an event management platform in communication with a client application on each of one or more computing devices of each of said users in said group via a network, said event management platform comprising at least one processor configured to execute modules of said event management platform for enabling creation, updating, and deletion of said one or more events scheduled by said users in said group and copies of said one or more events, said modules of said event management platform comprising:
an information acquisition module that acquires characteristic information on said each of said one or more computing devices and one or more third party calendar applications of said each of said users in said group, and event information on said one or more events, from said each of said users in said group via a graphical user interface provided by said event management platform;
an event generation module that generates and stores said one or more events based on said acquired event information, in communication with said client application over said network;
a storage and publishing module that stores said generated one or more events across one or more of a data store residing on said each of said one or more computing devices external to said client application, and a data store of each of said one or more third party calendar applications, of said each of said users in said group associated with said one or more events over said network, using said acquired characteristic information and said event information, wherein said stored one or more events are accessible to said each of said users in said group associated with said one or more events over said network for performing one or more actions on said stored one or more events, and wherein said one or more actions performed on said stored one or more events comprise one or more of viewing said stored one or more events, deleting said stored one or more events, and updating said event information for updating said stored one or more events scheduled by said each of said users in said group;
a tracking module that tracks said one or more actions performed on said stored one or more events by one or more of said users in said group, in communication with said client application over said network; and
said storage and publishing module that automatically updates said stored one or more events across said one or more of said data store residing on said each of said one or more computing devices external to said client application, and said data store of said each of said one or more third party calendar applications, of said each of said users in said group associated with said one or more events over said network using said acquired characteristic information and said event information.

29. The computer implemented system of claim 28, wherein said information acquisition module of said event management platform acquires a default storage location for storing said generated one or more events from said each of said users in said group via said graphical user interface, wherein said default storage location is one of a data store residing on said each of said one or more computing devices external to said client application on said each of said one or more computing devices of said each of said users in said group associated with said one or more events, and a data store of each of one or more third party calendar applications of said each of said users in said group associated with said one or more events, and wherein said generated one or more events stored in said default storage location is accessible by said event management platform via said network for retrieval, transmission, and manipulation.

30. The computer implemented system of claim 28, wherein said client application on said each of said one or more computing devices of said each of said users in said group comprises a busy time determination module executable by at least one processor for determining one or more busy time periods of said each of said users in said group using private event information of said one or more events stored in said data store residing on said each of said one or more computing devices external to said client application, and transmitting a notification of said determined one or more busy time periods to said event management platform via said network, wherein each of said one or more busy time periods is a time period between a start time and an end time of each of said one or more events associated with said each of said users in said group.

31. The computer implemented system of claim 30, wherein said event generation module of said event management platform in communication with said client application over said network performs:
generating one or more private events for said each of said users in said group based on said determined one or more busy time periods received from said client application of said each of said users in said group over said network; and
transmitting a notification on said generated one or more private events of said each of said users in said group to said client application of each of other of said users in said group via said network, for accessing said generated one or more private events of said each of said users in said group by said other of said users in said group.

32. The computer implemented system of claim 28, wherein said event generation module of said event management platform, in communication with said client application over said network, performs:
validating a request associated with said generation of each of said one or more events received from said client application;
generating an event identification key for said each of said one or more events for uniquely identifying said each of said one or more events on successful said validation of said request; and
transmitting said generated event identification key to one or more of said client application and said each of said one or more third party calendar applications over said network for said storage of said each of said one or more events in one or more of a data store of said client application, said data store residing on said each of said one or more computing devices external to said client application, and said data store of said each of said one or more third party calendar applications, wherein said event identification key is mapped to a unique event identifier generated by each of said data store residing on said each of said one or more computing devices external to said client application and said data store of said each of said one or more third party calendar applications for said storage of said generated one or more events in one or more of said data store residing on said each of said one or more computing devices external to said client application and said data store of said each of said one or more third party calendar applications.

33. The computer implemented system of claim 28, wherein said storage and publishing module of said event management platform determines absence of said one or more events generated for one of said users in said group, in one or more of a data store of said client application of each of other of said users in said group, said data store resident on said each of said one or more computing devices external to said client application of said each of said other of said users in said group, and said data store of said each of said one or more third party calendar applications of said each of said other of said users in said group via said network.

34. The computer implemented system of claim 33, wherein said storage and publishing module of said event management platform stores said one or more events generated for said one of said users in said group across said one or more of said data store of said client application, said data store resident on said each of said one or more computing devices external to said client application, and said data store of said each of said one or more third party calendar applications, of said each of said other of said users in said group over said network, based on said determination of said absence and a receipt of an acceptance message for said one or more events from said each of said other of said users in said group.

35. The computer implemented system of claim 28, wherein said tracking module of said event management platform determines whether a result of each of said one or more actions performed on said stored one or more events by one of said users in said group is updated in one or more of a data store of said client application, said data store resident on said each of said one or more computing devices external to said client application, and said data store of said each of said one or more third party calendar applications, of each of other of said users in said group via said network.

36. The computer implemented system of claim 35, wherein said storage and publishing module of said event management platform automatically updates said result of said each of said one or more actions performed on said stored one or more events by said one of said users in said group in said data store of said each of said one or more third party calendar applications of said each of said other of said users in said group, and transmits a notification to said client application of said each of said other of said users in said group via said network for said updating of said result of said each of said one or more actions performed on said stored one or more events by said one of said users in said group in said one or more of said data store of said client application, and said data store resident on said each of said one or more computing devices external to said client application of said each of said other of said users in said group, based on said determination of said updating of said result of said each of said one or more actions and a receipt of an acceptance message for said result of said each of said one or more actions by said each of said other of said users in said group.

37. The computer implemented system of claim 28, wherein said modules of said event management platform further comprise a delegation module in communication with said client application over said network, wherein said delegation module determines delegation of said one or more events from one of said users in said group to another one of said users in said group, for performing said one or more actions on said stored one or more events.

38. The computer implemented system of claim 28, wherein said client application of said each of said users in said group comprises an event retrieval module that communicates with said event management platform over said network, wherein said event retrieval module is executable by at least one processor for retrieving said one or more events associated with each of other of said users in said group, stored across one or more of said data store resident on said each of said one or more computing devices external to said client application, and said data store of said each of said one or more third party calendar applications of said each of said other of said users in said group over said network, via an information database of said event management platform, and sorting said retrieved one or more events based on predetermined sorting criteria defined by one of said users in said group.

39. The computer implemented system of claim 38, wherein said storage and publishing module of said event management platform determines said one or more events retrieved across said one or more of said data store resident on said each of said one or more computing devices external to said client application, and said data store of said each of said one or more third party calendar applications of said each of said other of said users in said group, that are duplicated, and transmits a single copy of said one or more events from among said duplicated one or more events to said client application of said one of said users in said group via said network.

40. The computer implemented system of claim 28, wherein said modules of said event management platform further comprise an availability check module, in communication with said client application via said network, that analyzes an availability status of said each of said users in said group using said event information and transmits a notification to said client application of each of other of said users in said group via said network for tracking availability of said each of said users in said group for said one or more events scheduled by said each of said users in said group.

41. The computer implemented system of claim 28, wherein said client application further comprises an availability notification module executable by at least one processor that performs:
transmitting a request message triggered by each of one or more of said users in said group to said event management platform via said network, wherein said request message defines a predetermined duration of time to determine availability of each of other of said users in said group;
receiving a notification of one or more busy time periods of said each of said other of said users in said group retrieved from a data store residing on said each of said one or more computing devices external to said client application of said each of said other of said users in said group, a data store of said each of said one or more third party calendar applications of said each of said other of said users in said group associated with said one or more events, and an information database of said event management platform, by said event management platform via said network, wherein each of said one or more busy time periods is a time period between a start time and an end time of each of said one or more events associated with said each of said users in said group; and
determining availability status of said each of said other of said users in said group for said predetermined duration of time based on said received notification of said one or more busy time periods for notifying said each of said one or more of said users in said group whether one or more of said other of said users in said group are busy during said predetermined duration of time.

42. The computer implemented system of claim 28, further comprising a local event management database on said each of said one or more computing devices of said each of said users in said group for said storage of said generated one or more events to ensure uninterrupted performance of said one or more actions on said stored one or more events independent of said network in said client application.

43. The computer implemented system of claim 28, wherein said client application further comprises a data store that stores said generated one or more events on said each of said one or more computing devices of said each of said users in said group.

44. The computer implemented system of claim 28, wherein said storage and publishing module of said event management platform performs one or more of:
selectively publishing said one or more events retrieved from a data store of said client application, an information database of said event management platform, said data store resident on said each of said one or more computing devices external to said client application, and said data store of said each of said one or more third party calendar applications to said users in said group via said network based on selection criteria; and
publishing said generated one or more events stored in said data store residing on said each of said one or more computing devices of said each of said users in said group external to said client application, to other of said users in said group via said network.

45. The computer implemented system of claim 28, wherein said storage and publishing module in communication with said event generation module of said event management platform performs:
transmitting an event invitation for each of said one or more events triggered by one of said users in said group to other of said users in said group via said network; and
transmitting a copy of said generated one or more events to a default storage location of each of said other of said users in said group via said network on receiving an acceptance message for said one or more events from said each of said other of said users in said group.

46. The computer implemented system of claim 45, wherein said storage and publishing module of said event management platform deletes said generated one or more events and transmits a notification to said client application on said each of said one or more computing devices of said each of said other of said users in said group for performing deletion of said copy of said generated one or more events from said default storage location of said each of said other of said users in said group via said network, on receiving a cancellation message from said each of said other of said users in said group.

47. The computer implemented system of claim 28, wherein said modules of said event management platform further comprise a contextual event management module that performs:
analyzing said event information on one or more contextual events acquired from an event organizer among said users in a group by said information acquisition module via said graphical user interface;
comparing said event information with profiles of other of said users in said group and external users registered with said event management platform to determine potential interest of said other of said users in said group and said external users in said one or more contextual events;
generating a list of one or more of said other of said users in said group and said external users with said potential interest in said one or more contextual events;
transmitting said generated list to said client application on said each of said one or more computing devices of said event organizer via said network;
acquiring an indication of one or more of said other of said users in said group and said external users selected by said event organizer from said generated list for participating in said one or more contextual events, via said graphical user interface; and
creating a context group of said selected one or more of said other of said users and said external users for said participation in said one or more contextual events.

48. The computer implemented system of claim 47, wherein said event generation module of said event management platform generates and stores said one or more contextual events, in communication with said client application over said network, based on said acquired event information, and wherein said storage and publishing module of said event management platform stores said generated one or more contextual events across said one or more of said data store residing on said each of said one or more computing devices external to said client application, and said data store of said each of said one or more third party calendar applications, of said each of said users in said context group associated with said one or more contextual events over said network using said acquired characteristic information and said event information, wherein said stored one or more contextual events are accessible to said each of said users in said context group associated with said one or more contextual events over said network for performing said one or more actions on said stored one or more contextual events.

49. A computer program product comprising a non-transitory computer readable storage medium, said non-transitory computer readable storage medium storing computer program codes comprising instructions executable by at least one processor, said computer program codes comprising:
a first computer program code for acquiring characteristic information on each of one or more computing devices and one or more third party calendar applications of each of a plurality of users in a group, and event information on one or more events scheduled by said each of said users in said group, from said each of said users in said group via a graphical user interface provided by an event management platform, wherein said event management platform is in communication with a client application on said each of said one or more computing devices of said each of said users in said group via a network;
a second computer program code for generating and storing one or more events in communication with said client application over said network based on said acquired event information;
a third computer program code for storing said generated one or more events across one or more of a data store residing on said each of said one or more computing devices external to said client application, and a data store of each of said one or more third party calendar applications, of said each of said users in said group associated with said one or more events over said network using said acquired characteristic information and said event information, wherein said stored one or more events are accessible to said each of said users in said group associated with said one or more events over said network for performing one or more actions on said stored one or more events;
a fourth computer program code for tracking said one or more actions performed on said stored one or more events by one or more of said users in said group, in communication with said client application over said network; and
a fifth computer program code for automatically updating said stored one or more events across said one or more of said data store residing on said each of said one or more computing devices external to said client application, and said data store of said each of said one or more third party calendar applications, of said each of said users in said group associated with said one or more events over said network using said acquired characteristic information and said event information.

50. The computer program product of claim 49, wherein said computer program codes further comprise:
a sixth computer program code for analyzing an availability status of said each of said users in said group using said event information, in communication with said client application of said each of said users via said network; and
a seventh computer program code for transmitting a notification to said client application of each of other of said users in said group via said network for tracking availability of said each of said users in said group for said one or more events scheduled by said each of said users in said group.

51. The computer program product of claim 49, wherein said computer program codes further comprise:
an eighth computer program code for analyzing said event information on one or more contextual events acquired from an event organizer among said users in said group and comparing said event information with profiles of other of said users in said group and external users registered with said event management platform to determine potential interest of said other of said users in said group and said external users in said one or more contextual events;
a ninth computer program code for generating a list of one or more of said other of said users in said group and said external users with said potential interest in said one or more contextual events;
a tenth computer program code for transmitting said generated list to said client application on said each of said one or more computing devices of said event organizer via said network;
an eleventh computer program code for acquiring an indication of one or more of said other of said users in said group and said external users selected by said event organizer from said generated list for participating in said one or more contextual events via said graphical user interface;
a twelfth computer program code for creating a context group of said selected one or more of said other of said users and said external users for said participation in said one or more contextual events; and
a thirteenth computer program code for generating and managing said one or more contextual events, in communication with said client application over said network.
